(19) United States
(12) Patent Application Publication
(10) Pub. No.: US 2026/0215452 A1
(43) Pub. Date: Jul. 30, 2026

(54) ARTIFICIAL PROTEIN COMPOSITIONS

(71) Applicant: Formo Foods GmbH, Berlin (DE)

(72) Inventors: Sandra Catharina WILDE, Berlin (DE); Thomas SCHUBERT, Berlin (DE); Monika BRUCKNER-GUEHMANN, Berlin (DE); Sowmya Krishna KUMAR, Berlin (DE); Laurens Jans ANTUMA, Wageningen WG (NL); Julia Katharina KEPPLER, Wageningen WG (NL); Remko Marcel BOOM, Wageningen WG (NL)

(21) Appl. No.: 19/141,842

(22) PCT Filed: Dec. 22, 2023
(86) PCT No.: PCT/IB2023/063166

§ 371 Date: Jun. 20, 2025

(30) Foreign Application Priority Data
Dec. 23, 2022 (AU) 2022904009
Dec. 30, 2022 (GB) 2219838.6
Jul. 24, 2023 (AU) 2023902353
Jul. 24, 2023 (GB) 2311300.4

(51) Int. Cl. A23C 19/082; A23J 3/10

(52) U.S. Cl. CPC A23C 19/082; A23J 3/10

(57) ABSTRACT

Micellar solutions of artificial casein micelles comprising isolated non-human β-casein and isolated non-human κ-casein, and substantially free of αₛ-caseins, including methods of making same, methods of coagulating same, and compositions comprising same; processes for the preparation of curd compositions from κ-casein (whether phosphorylated, dephosphorylated or non-phosphorylated), with or without β-casein (whether phosphorylated, dephosphorylated or non-phosphorylated), useful for the manufacture of downstream derived products such as cheeses having functional properties comparable to those of equivalent products produced from milk; casein and non-animal derived protein emulsions, curds compositions and cheese products and methods for producing same; and a process for treating non-micellar casein to form a pasta filata-style cheese product, such as a mozzarella-style cheese product, comprising treatment of dephosphorylated casein or caseinate with a transglutaminase, combining with an oil or fat to form an emulsion which can be used to form cheese product, for example using acid induced or chymosin-induced coagulation, and processing using standard cheese processing steps to produce different styles of cheese product.

### TECHNICAL FIELD

The technology described herein resides in the field of protein-based food products and dairy substitutes. More specifically, the technology relates to artificial protein compositions comprising protein components derived from milk, or protein components that are identical to those derived from milk. Provided herein are processes for producing emulsions, micelles, coagulates and curds compositions from phosphorylated, dephosphorylated or non-phosphorylated caseins, and food products derived therefrom.

### BACKGROUND ART

The following discussion of the background art is intended to facilitate an understanding of the present invention only. The discussion is not an acknowledgement or admission that any of the material referred to is or was part of the common general knowledge as at the priority date of the application.

As of 5 Jul. 2022, the global dairy market was valued at approximately 830 billion U.S. dollars, and it was predicted to grow to about 1130 billion U.S. dollars by 2026. Bovine milk holds the most significant share of this market, whilst plant-derived dairy alternatives, lactose-intolerant milk, milk products that are reduced in carbohydrates and enriched in proteins, and other modified milk products such as A1 β-casein free milk (A2 milk) are increasingly prominent in an increasingly informed market of diet-conscious consumers.

Mammalian-derived milk is a highly complex liquid composition comprising, aside from water, thousands of different compounds, from lipids, triglycerides, carbohydrates, saccharides, peptides, inorganic salts and other molecular entities. Although many consider mammalian-derived milk, including bovine milk, to be an ideal nutrition source, various alternatives to mammalian-derived milk are now successfully on the market, including plant- or nut-based milks, such as soy, almond, or coconut milk, and are accepted by consumers for reasons related to mammalian-derived milk's allergenicity, lactose intolerance of certain components, personal preference, or the perception of adverse environmental impacts arising from the dairy industry.

For example, the majority of mammalian-derived milk is sourced from ruminant animals including cows, buffalos, yaks, goats and sheep, as well as pseudo-ruminants such as camels, alpacas and llamas. Cattle-rearing and ruminant livestock agriculture in general produces more global warming greenhouse gases, as measured in carbon dioxide (CO₂) equivalents, than transportation, according to a recent UN assessment. Ruminants are estimated to account for 10% of total greenhouse gas emissions in Australia. Ruminants produce methane (CH₄) as a by-product of digestion via anaerobic microbial feed fermentation in the rumen and, to a lesser extent, the large intestine. This process is referred to as methanogenesis.

Methane absorbs solar infrared radiation efficiently, and it has a global warming potential 25 times that of CO₂. The ruminal microbial population is made up of bacteria, protozoa, fungi, and bacteriophages, all of which work together to digest ingested organic matter and produce CO₂, H₂, volatile fatty acids, and formates. These end-products are used by methanogenic archaea in the rumen, which produces CH₄. Although the generation of CH₄ lowers the partial pressure of H₂, this has the potential to cause problems as it also limits the amount of energy and carbon available for the synthesis of volatile fatty acids, which are critical for ruminant nutrition and could otherwise restrict rumen fermentation. The majority of CH₄ generated by ruminants is exhaled or discharged via the mouth, resulting in a waste of up to 12% of gross caloric intake in the ruminant diet. In addition, producing a single glass of dairy milk from cows consumes up to nine times more land, and significantly more water, than any of the plant-derived milk alternatives.

Attempts to address these environmental issues with plant-derived milks including soy, almond, or coconut milk, for example, fall short in both flavour and utility. In addition, a major portion of dairy milk's industrial and cultural value originates from its use in derivative goods such as cheese, yoghurt, cream, or butter. While dairy substitute plant-derived milks address some environmental and health problems (and provide sufficient flavour for a minor portion of the consumer population), when exposed to the same procedures as dairy milk, they virtually always fail to generate such derivative goods.

There is a need then, for an alternative dairy substitute or composition with desirable flavour and performance characteristics, such as a composition that replicates dairy flavours, whilst minimising foodborne pathogens, and that potentially has a lower environmental impact in production, while retaining the ability to be used for derivative or downstream applications of dairy milk and providing a nutritional profile similar to that of, or comparable to, mammalian-derived milk. There is a need also, for improved processes for the production of derivative goods such as curds compositions and cheeses, from artificial protein micelle solutions that mimic the behaviour of dairy milk or mammalian-derived milk.

The protein content of bovine milk required for most derivative products such as cheese is primarily comprised of four distinct caseins: αₛ₁-casein, αₛ₂-casein, β-casein and κ-casein. Cheese is the third most unsustainable animal product in the world (in terms of greenhouse gas emissions per kg of product), yet plant-based alternatives released onto the market in the previous decade have not decreased demand of dairy cheese. On the contrary, consumption of mozzarella cheese in the United States and other developing countries is increasing year after year. Due to a lack of casein proteins, current cheese replacements do not match the functionality (including melt behaviour and browning behaviour when cooked or grilled), texture, nutrition, and taste of dairy cheese. Meanwhile, human allergies to milk products are most often caused by the αₛ₁-casein protein present in dairy milk.

In milk the casein proteins exist in a colloidal particle known as the “casein micelle”. The term “casein micelle” describes colloidal calcium phosphate-calcium caseinate particles in milk. The casein micelle is an assembly of four different casein proteins: αₛ₁-casein, αₛ₂-casein, β-casein and κ-casein which are present in a molar ratio of about 4:1:4:1. In the casein micelle, the κ-casein is predominantly located at the surface of the micelle and forms a “coat” or outer layer in the micelle, with the other remaining caseins being located in a more hydrophobic micellar core. Thus, the κ-casein is responsible for maintaining the other caseins in solution. Colloidal calcium phosphate stabilizes the casein micellar structure.

Cheese is produced in a process whereby dairy milk, containing a suspension of casein micelles comprising αₛ₁-casein, αₛ₂-casein, β-casein and κ-casein is subjected to coagulation and treatment with rennet enzymes to form a curd, the whey is separated and then the curd is aged to form cheeses of various types. Achieving a desirable texture, hardness, elasticity and other functional properties such as melt behaviour in the cheese and desirable browning behaviour when cooked or grilled, is highly dependent on micelle size and mineral content of the micelles in the suspension of casein micelles used to generate the curd. In general terms, if the micelles are not large enough, they tend not to form sufficiently firm curds when subjected to coagulation and rennetisation, resulting in undesirable texture, hardness, elasticity and other functional properties in the downstream products arising from coagulation and rennetisation. Furthermore, when the micelles are not large enough, they tend to be unable to entrap sufficient salts within their micellar structure to impart good flavour to the downstream products arising from coagulation and rennetisation.

Milk-derived caseinates are produced by precipitating micellar casein at their isoelectric point followed by neutralisation to solubilise the single caseins again. However, re-solubilisation does not lead to the re-formation of casein micelles and the casein proteins remain in solution as caseinates. Such non-micellar casein can be used to form processed and analogue cheese by mixing and cooking the ingredients to form a homogenous solid texture. An “analogue cheese” is a cost-effective cheese-like product in which milk proteins and/or milk fat are replaced by proteins and fat which are not native to milk, for example caseinates and/or vegetable oils. Generally, an “analogue cheese” is produced by blending individual constituents, including non-dairy fats or proteins. Addition of chymosin to the caseinate solution does not lead to the formation of a gel (although the κ-casein is still hydrolysed, there are no micelles to aggregate together).

As an increasing awareness has developed over dairy alternatives, a certain portion of non-micellar casein can be replaced with plant protein to mozzarella cheese without compromising the protein content. However, attaining desirable functionality including emulsification, stretchability and meltability of the cheese with plant protein is a challenge. This will lead to a low acceptance and liking by the consumer.

There is a need for the provision of a composition comprising non-micellar casein and a plant protein suitable to produce a product resembling the organoleptic properties of a cheese product such as mozzarella cheese.

Chymosin, also as rennin, is a proteolytic enzyme which hydrolyses κ-casein between amino acid nos. 105 and 106 leading to removal of a hydrophilic C-terminal fragment (“glycomacropeptide”) from the κ-casein. When chymosin is added to micellar casein, the κ-casein is still hydrolysed and the truncated κ-casein, called para-κ-casein, formed by removal of the glycomacropeptide remains associated with the casein micelle. However, once cleaved by chymosin, the para-κ-casein has insufficient residual stability to fully stabilise the micelle and, as a consequence of the κ-casein hydrolysis, the micelles aggregate together into para-casein-micelles and finally coagulate sufficiently to form a gel. In milk, approximately 85% of the κ-casein must be hydrolysed for coagulation to occur.

Caseins can be produced recombinantly by precision fermentation. Besides the amino acid sequence, the chemical modifications of the proteins after their translation, so called posttranslational modifications, contribute significantly to their final structure and functionalities. In case of α- and β-caseins phosphorylation is crucial for their coagulation and gelling properties which are key for making cheese. However, phosphorylation is less common and mostly of a different nature in some groups of microorganisms, especially in bacterial species. Consequently, caseins produced recombinantly by bacteria lack phosphate groups and thus, their ability to build and stabilize gel networks by the typical Ca²⁺ bridges. In previous trials and scientific papers, it was described that non-phosphorylated caseins build only weak and fragile gels which have a very low cohesiveness. Hence, their suitability for cheese manufacturing is very low.

It is known in the art that dephosphorylated bovine β-casein is less able to aggregate (see Mc Carthy et al., Food Chemistry, vol 138:1304-1311 (2013); Ohmiya et al., Agricultural and Biological Chemistry, Volume 47:535-542 (1983)) and that partially dephosphorylated casein in casein micelles adversely impacted the casein's ability to coagulate (see Pearse et al., Journal of Dairy Research, Vol 53:381-390 (1986)). The ability of chymosin to induce coagulation of dephosphorylated casein has also been observed (see Yamauchi et al., Agricultural and Biological Chemistry 42:1031-1035 (1978). Van Hekken et al., noted (J Dairy Science 77:907-916 (1994)), that dephosphorylation influences the way that casein can associate with itself and other protein to form micelles, with dephosphorylation removing the majority of the ca2+ binding sites, leaving only the weaker sites of glutamic acids and aspartic acid residues. Consequently, the loss of phosphate groups leads to abnormal micelles which are less stable in the presence of calcium ions.

One issue that many producers in the field of dairy substitutes have in common is the challenge in scaling at a rapid and cost-effective rate. Recombinant protein manufacturing may be costly and time-consuming. This is due in part to the fact that the downstream costs of protein purification can account for up to 80% of total protein production processing costs, with a drop in protein yield of up to 70% depending on the purity of the product.

Since the development and production of recombinant caseins is costly and difficult, it would be desirable to produce artificial casein micelles, having similar structural and functional properties, including in terms of mineral content and micelle size, to those observed in dairy milk, but without requiring the presence of all four caseins present in dairy milk (αₛ₁-casein, αₛ₂-casein, β-casein and κ-casein), thereby greatly simplifying the production of such artificial casein micelles, especially where the casein proteins used are sourced from non-dairy origins such as via recombinant microorganisms. It would also be desirable to produce curds compositions, having similar structural and functional properties, including in terms of texture, hardness, elasticity, melt behaviour in the downstream derivative products (such as cheeses) and desirable browning behaviour when cooked or grilled, to those observed in such curds compositions and downstream derivative products derived from whole dairy milk, but without requiring the presence of all four caseins present in dairy milk (αₛ₁-casein, αₛ₂-casein, β-casein and κ-casein), thereby greatly simplifying the production of such artificial curds compositions and downstream derivative products, especially where the casein proteins used are sourced from non-dairy origins such as via recombinant microorganisms.

It is against this background that the present invention has been developed.

### SUMMARY OF THE INVENTION

By developing a new process for the preparation of a curd composition, the present inventors have created artificial curds products from κ-casein only (whether phosphorylated or not), or from a combination of κ-casein (whether phosphorylated or not) and β-casein (whether phosphorylated or not), without the need of αₛ₁-casein and αₛ₂-casein, and with properties very similar to natural bovine-derived curds products in terms of texture, hardness, elasticity, melt behaviour in the downstream derivative products (such as cheeses) and desirable browning behaviour when cooked or grilled, to those observed in such curds compositions and downstream derivative products derived from whole dairy milk.

The components of natural bovine-derived milk used to conventionally form curds products include κ-casein, β-casein, αₛ₁-casein and αₛ₂-casein, each of which is present in varying degrees of phosphorylation. However, to produce non-mammalian derived substitute curds products from equivalently phosphorylated κ-casein, β-casein, αₛ₁-casein and αₛ₂-casein is an intensive processing challenge and is costly and difficult. On the other hand, precision fermentation processes are capable of producing κ-casein in non-phosphorylated, or mono-phosphorylated, or di-phosphorylated form, cost effectively. Accordingly, the present invention provides an advantageously cost-effective route to the production of non-animal derived curds products and their downstream derivative products.

These artificial curds products are coagulated by the action of acid, and/or microbial agents, and/or fermentation, and/or rennet, and/or enzymes, and/or via hydrolysis or dissociation of glucono-delta-lactone, to create curds that result in the same cheese textures as those produced from bovine milk, allowing for the complete (or partial) replacement of the functionality of bovine derived curds products and their downstream derivative products such as cheeses.

Furthermore, by developing a method to (re) assemble non-micellar caseins into casein micelles, the present inventors have created artificial casein micelles from β-casein and κ-casein only, without the need of αₛ₁-casein and αₛ₂-casein, and with properties very similar to natural bovine casein micelles in terms of micelle size and mineral content. These artificial micelles may also be coagulated by the action of rennet to create the same cheese textures as those produced from bovine milk, allowing for the complete replacement of the functionality of bovine casein micelles.

In a first aspect, the disclosure herein provides a micellar solution comprising a plurality of artificial casein micelles, wherein the artificial casein micelles comprise isolated non-human β-casein and isolated non-human κ-casein, and wherein the artificial casein micelles are substantially free of αₛ-caseins.

In some embodiments, the Z-average diameter of the artificial casein micelles is greater than 30 nm.

In preferred embodiments, the Z-average diameter of the artificial casein micelles falls within the range of 40 to 500 nm.

In some embodiments, the micellar solutions described herein comprise less than 7 wt % αₛ-caseins as a percentage of the total caseins present in the micellar solution.

In some embodiments, the micellar solutions described herein comprise a wt % ratio of non-human β-casein to non-human κ-casein falling within the range of 10:90 to 90:10.

In some embodiments, the micellar solutions described herein comprise a total casein concentration falling within the range of 10 g/L to 95 g/L.

In some embodiments, the micellar solutions described herein comprise a total non-human β-casein concentration falling within the range of 1 g/L to 90 g/L.

In some embodiments, the micellar solutions described herein comprise a total non-human κ-casein concentration falling within the range of 1 g/L to 90 g/L.

In some embodiments, the micellar solutions described herein comprise an αₛ₁-casein concentration falling within the range of 0 g/L to 2 g/L.

In some embodiments, the micellar solutions described herein comprise an αₛ₂-casein concentration falling within the range of 0 g/L to 1 g/L.

In some embodiments, the hydration of the artificial casein micelles in the micellar solutions of the present invention, falls within the range of 1 to 8 (g water/g micellar protein).

In some embodiments, the non-micellar caseins as a percentage of total caseins in the micellar solutions of the present invention, falls within the range of 5 to 20%.

In some embodiments, the micellar calcium content in the micellar solutions of the present invention, is at least 70% of the total calcium in the micellar solution.

In some embodiments, the micellar magnesium content in the micellar solutions of the present invention, is at least 30% of the total magnesium in the micellar solution. In preferred embodiments, the micellar magnesium content in the micellar solutions of the present invention, is at least 35% of the total magnesium in the micellar solution.

In some embodiments, the micellar inorganic phosphate content in the micellar solutions of the present invention, is at least 50% of the total inorganic phosphate in the micellar solution.

In some embodiments, the micellar citrate content in the micellar solutions of the present invention, is at least 5% of the total citrate in the micellar solution.

In one embodiment, the disclosure herein provides a curds composition comprising the micellar solution of the present invention, in coagulated form.

In some embodiments, the curds composition further comprises a renneting agent.

In a preferred embodiment, the curds composition has a Maximum G′ (storage modulus) falling within the range of 5 to 200 Pa, preferably after 1 hour incubation with rennet.

In a further embodiment, the disclosure herein provides an edible composition comprising the micellar solution of the present invention, or the curds composition of the present invention.

In some embodiments, the edible composition does not contain any animal-derived protein.

In one embodiment, the disclosure herein provides a method for producing an edible composition, comprising: combining isolated non-human β-casein, isolated non-human κ-casein and at least one salt under conditions wherein the β-casein and the κ-casein form a micellar solution, wherein the micellar solution is substantially free of αₛ-caseins; and subjecting the micellar solution to a first condition to form coagulates.

In some embodiments of the method for producing an edible composition, the first condition is the addition of acid or acidification of the micellar solution with a microorganism.

In some embodiments of the method for producing an edible composition, the method further comprises subjecting the coagulates to a renneting agent to form a rennetted curd.

In some embodiments of the method for producing an edible composition, the method further comprises aging and/or maturing the rennetted curd to form a cheese composition.

In some embodiments of the method for producing an edible composition, the edible composition does not contain any animal-derived protein.

In a second aspect, the disclosure herein provides a process for the preparation of a curd composition, wherein the process comprises the steps of:
a) preparing an emulsion comprising;
   (i) phosphorylated κ-casein; or
   (ii) dephosphorylated or non-phosphorylated κ-casein; or
   (iii) phosphorylated κ-casein and dephosphorylated or non-phosphorylated κ-casein; or
   (iv) phosphorylated κ-casein, dephosphorylated or non-phosphorylated κ-casein and dephosphorylated or non-phosphorylated β-casein; or
   (v) dephosphorylated or non-phosphorylated κ-casein and dephosphorylated or non-phosphorylated β-casein; or
   (vi) phosphorylated κ-casein and dephosphorylated or non-phosphorylated β-casein; and
   (vii) optionally, a lipid source;
b) adding a calcium salt to the emulsion; and
c) coagulating the emulsion.

In some embodiments, coagulation step c) of the process comprises addition of an acid; and/or addition of a rennet; and/or addition of an enzyme; and/or addition of chymosin, to provide a coagulated emulsion.

In some embodiments, the process further comprises an additional step of heating the emulsion before step b); and/or heating the emulsion before step c); at a suitable temperature and for a suitable period of time; preferably wherein the temperature falls within the range of 45° C. to 70° C.; preferably wherein the period of time falls with the range of 1 min to 180 min. The most highly preferred period of heat treatment time is 30 minutes, and the most highly preferred heat treatment temperature is 63° C.

In some embodiments, the process further comprises an additional step of treating the emulsion with transglutaminase before step b); and/or treating the emulsion with transglutaminase before step c); preferably wherein the additional step of treating the emulsion with transglutaminase comprises adding transglutaminase to the emulsion and incubating at a suitable temperature and for a suitable period of time; preferably wherein the temperature falls within the range of 45° C. to 60° C.; preferably wherein the period of time falls with the range of 1 min to 180 min. The most highly preferred period of incubation time is 30 minutes, and the most highly preferred incubation temperature is 50° C.

The step of heat treatment and the step of transglutaminase incubation are unrelated optional steps that may be performed independently of one another. However, in some embodiments, the step of heat treatment may be advantageously performed after the step of transglutaminase incubation, such that the heat treatment step performs the dual functions of enhancing the functionality (particularly stretchability) of the cheese, and also deactivating the transglutaminase enzyme.

In some embodiments of the process, the emulsion comprises a total protein concentration falling within the range of 2 wt. % to 20 wt. %; preferably wherein the emulsion comprises a total protein concentration falling within the range of 3 wt. % to 10 wt. %; most preferably wherein the emulsion comprises a total protein concentration falling within the range of 4 wt. % to 8 wt. %.

In some embodiments of the process, the emulsion comprises a fat to protein ratio falling within the range of fat free to 2:0.5; preferably wherein the emulsion comprises a fat to protein ratio falling within the range of 1:1.5 to 1.5:1; most preferably wherein the emulsion comprises a fat to protein ratio of about 1:1.

In some embodiments of the process, the calcium salt added at step b) is added to bring the concentration of calcium in the emulsion to a concentration falling within the range of 2 mM to 20 mM; preferably wherein the calcium salt is added to bring the concentration of calcium in the emulsion to a concentration falling within the range of 5 mM to 15 mM; most preferably wherein the calcium salt is added to bring the concentration of calcium in the emulsion to a concentration falling within the range of 8 mM to 12 mM.

In some embodiments of the process, the calcium salt added at step b) is selected from the group consisting of; calcium chloride, calcium hydroxide, calcium carbonate, calcium citrate, calcium phosphate, calcium stearate, calcium malate, calcium glycerophosphate, calcium lactate, and calcium gluconate or mixtures thereof.

In some embodiments of the process, the lipid source added at step a)(vii) is selected from the group consisting of; a non-animal fat or oil, a plant fat or oil, a microbial fat or oil, a fungal fat or oil, a recombinantly-produced fat or oil or a mixture of any of the aforementioned lipid sources; preferably wherein the lipid source is a vegetable oil selected from the group consisting of peanut oil, soy bean oil, sunflower oil, safflower oil, canola oil, corn oil, avocado oil, almond oil, olive oil, cotton seed oil, coconut oil, sesame oil, chia (Salvia Hispanica L.) seed oil, wheatgerm oil, grape seed oil, rice bran oil, linseed oil, mustard oil, palm oil, castor oil, hydrogenated castor oil, hemp seed oil, and any mixtures thereof.

In some embodiments of the process, step c) of coagulating the emulsion comprises acidifying the emulsion via addition of an acid, or acidifying the emulsion via treatment with a microbial acidifying agent, or via a fermentation process, or via hydrolysis or dissociation of glucono-delta-lactone.

In some embodiments of the process, step c) of coagulating the emulsion comprises acidifying the emulsion to a pH falling within the range of pH 4.2 to pH 6.5; preferably wherein coagulating the emulsion comprises acidifying the emulsion to a pH falling within the range of pH 4.8 to pH 5.8; most preferably wherein acidifying the emulsion comprises bringing the emulsion to a pH of about 5.2.

In some embodiments, the process further comprises the step of;
d) incubating the coagulated emulsion produced at step c) for a period of time at a suitable temperature, to produce a coagulate comprising a raw curd and a liquid phase; preferably wherein the period of time falls within the range of 10 min to 180 min; most preferably wherein the period of time falls within the range of 20 min to 60 min; preferably wherein the temperature falls within the range of 18° C. to 50° C.; most preferably wherein the temperature falls within the range of 25° C. to 40° C.

In some embodiments, the process further comprises the step of;
e) removing the raw curd of the coagulate produced in step d) from the liquid phase of the coagulate produced in step d) to provide a curd composition.

In some embodiments, the process further comprises the step of;
f) texturizing the curd composition produced in step e) in water, or brine, or water comprising whey, or brine comprising whey, at an elevated temperature, to provide a textured curd composition.

In some embodiments of the process, step f) of texturizing the curd composition produced in step e) in water, or brine, or water comprising whey, or brine comprising whey, at an elevated temperature, comprises an elevated temperature falling within the range of 60° C. to 95° C.; preferably an elevated temperature falling within the range of 70° C. to 90° C.; most preferably an elevated temperature falling within the range of 75° C. to 85° C.

In some embodiments of the process, step f) of texturizing the curd composition produced in step e) in water, or brine, or water comprising whey, or brine comprising whey, at an elevated temperature, comprises texturizing at a curd composition to water ratio falling within the range of 0.5:3 to 3:0.5; preferably at a curd composition to water ratio falling within the range of 1:2 to 2:1; most preferably at a curd composition to water ratio of 1:2.

In some embodiments of the process, step f) of texturizing the curd composition produced in step e) in water, or brine, or water comprising whey, or brine comprising whey, at an elevated temperature comprises texturizing via kneading and/or stretching and/or folding the curd composition, and optionally forming the curd composition into a ball.

In some embodiments, the process further comprises the step of;
g) cooling the textured curd composition; preferably in brine or water.

In some embodiments, the textured curd composition provided by step f) is a non-animal derived cheese product; preferably a non-animal derived mozzarella type cheese product.

In some embodiments, the disclosure herein provides a food product comprising caseins, when produced by the process of the present invention.

In some embodiments, the food product is a non-animal derived cheese product.

In a preferred embodiment, the food product is a non-animal derived mozzarella type cheese product.

In a third aspect, the present invention provides an emulsified composition comprising one or more lipid and protein components, wherein the protein component has a protein content of at least 80% (by weight) protein, wherein about 25-40% (by weight) of the protein content comprises zein protein, the remainder being micellar and/or non-micellar casein.

The present invention further provides a process of forming an emulsified composition according to the invention, wherein said process comprises the steps of:
i) Preparing a mixture of a non-micellar casein and/or zein protein;
ii) Adding one or more lipid;
iii) Emulsifying the mixture to obtain the emulsified composition.

In the process of the present invention, the zein protein component may be first dissolved in an alkaline aqueous solution. Thus, the present invention may provide a process of forming an emulsified composition according to the invention, wherein said process comprises the steps of:
i) Preparing a zein protein solution at alkaline pH;
ii) Adding the non-micellar casein;
ii) Adding one or more lipid;
iii) Emulsifying the mixture to obtain the emulsified composition.

In an alternative process of forming an emulsified composition according to the invention, the process comprises the steps of:
i) Preparing an aqueous solution of the non-micellar casein;
ii) Adding one or more lipid;
iii) Emulsifying the mixture and zein protein to obtain the emulsified composition.

The present invention further provides a process of forming a fibrous or pasta filata cheese product, wherein said process comprises forming an emulsified composition according to the first aspect of the invention. Specifically, by providing an emulsified composition according to the first aspect of the invention and inducing gel formation by acidifying the emulsion and/or by the addition of a calcium salt such as CaCl₂).

Optionally the addition of the calcium salt (CaCl₂)) can be conducted with addition of an alkali to increase the pH, for example to pH 6 or higher. Generally, where the pH is alkaline, the calcium salt is added to induce gel formation. Optionally, temperature changes can also be used to promote gel formation. The coagulated product formed by gel formation can be processed using standard cheese processing steps to produce a pasta filata style (for example mozzarella-style) cheese product.

The pasta filata style cheese product obtained forms a further embodiment of the present invention.

In a fourth aspect, the present invention provides a process of forming a cheese product, wherein said process comprises the step of treating dephosphorylated casein or caseinate with a transglutaminase. The treated casein or caseinate can then be combined with a fat to form an emulsion, and processed into a cheese product, for example by addition of chymosin to the emulsion or by acidification (for example to a pH of 4 to 6). Acidification may occur by the direct addition of an acid or by addition of a micro-organism (starter) culture. The process can be conducted at ambient temperature. Alternatively, the curd can be produced by acidification of the emulsion, either by addition of an acid or by use of a starter culture.

In one embodiment, the present invention provides a cheese product, said product comprising transglutaminase treated dephosphorylated casein proteins. Optionally, the cheese product can be a pasta filata-style cheese product. Optionally, the cheese product can be a Mozzarella-style cheese product.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1.1 is a schematic overview of the process for the formation of the artificial casein micelles of the present invention.

FIG. 2.1 is a plot of the Z-average Diameter (intensity weighted mean hydrodynamic size) of artificial casein micelles of the prepared samples of micellar solutions comprising artificial casein micelles, as a function of total β-casein content (%) in the samples.

FIG. 3.1 is series of Scanning Electron Microscopy (SEM) images of artificial casein micelles (ACMs) according to the present invention, with varying ratios of β-casein to κ-casein (b:k): (1) ACM b:k 70:30, (2) ACM b:k 75:25, (3) ACM b:k 80:20, (4) ACM b:k 85:15. Scale bar=0.5 μm.

FIG. 4.1 is a Scanning Electron Microscopy (SEM) image of bovine skim milk. Scale bar=0.5 μm.

FIG. 5.1 is a plot of the Micellar casein or sedimentable casein (the part of the casein that sediments upon ultracentrifugation) of the prepared samples of ACM micellar solutions comprising artificial casein micelles, as a function of total β-casein content (%) in the samples.

FIG. 6.1 is a plot of the hydration of the ACM micelles of the prepared samples of micellar solutions comprising artificial casein micelles, as a function of total β-casein content (%) in the samples.

FIG. 7.1 is a plot of the Maximum G′ (storage modulus; measure of the firmness) of the produced curds upon rennet-induced coagulation of the samples at pH 6.3 and with 0.10% added CaCl₂, of the prepared samples of ACM micellar solutions comprising artificial casein micelles, as a function of total β-casein content (%) in the samples.

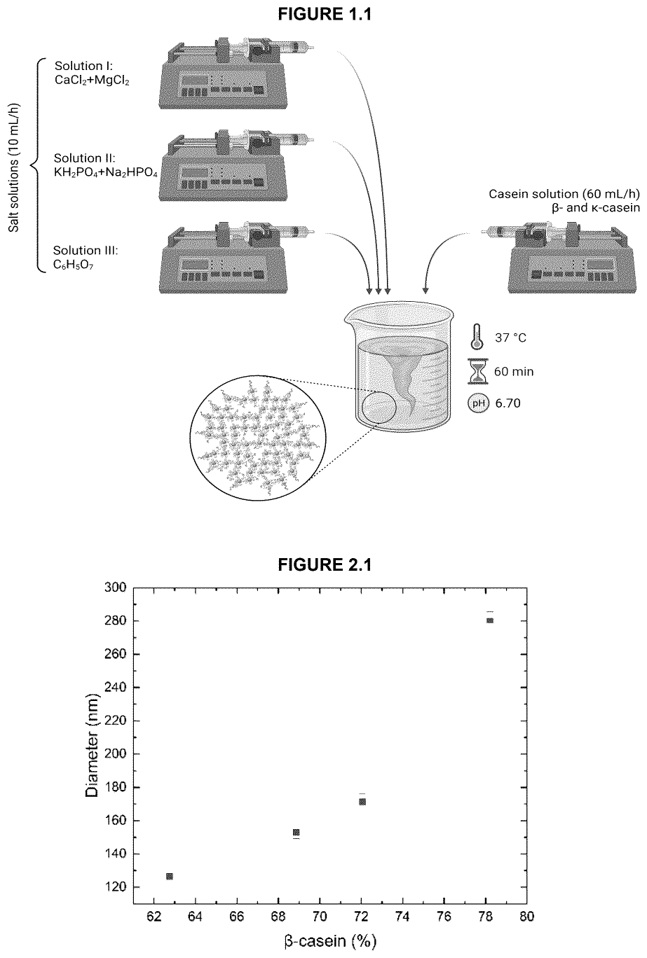

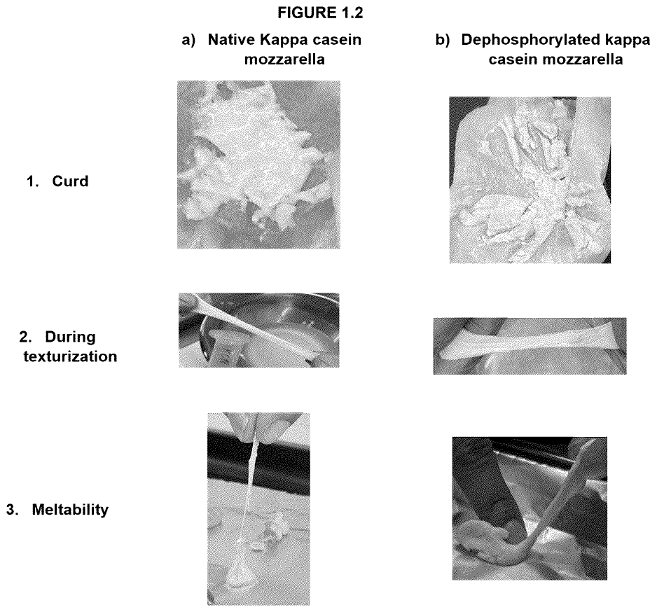

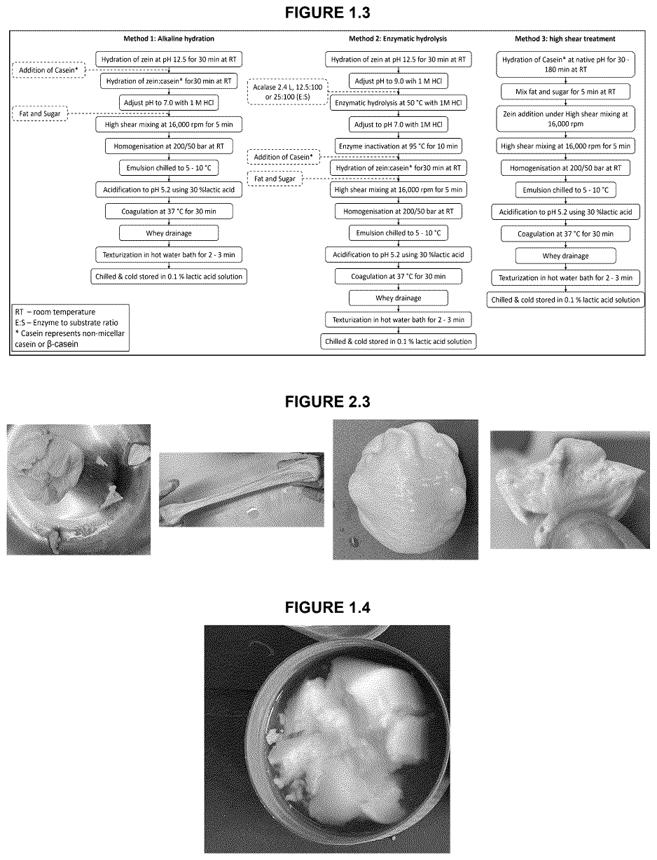

FIG. 1.2 is a series of photographs of curd compositions made in accordance with the process of the present invention from; a) phosphorylated κ-casein alone; and b) dephosphorylated κ-casein alone; at the stages of; 1. raw curd separation; 2. texturization; and 3. after heating the texturized composition to test for meltability.

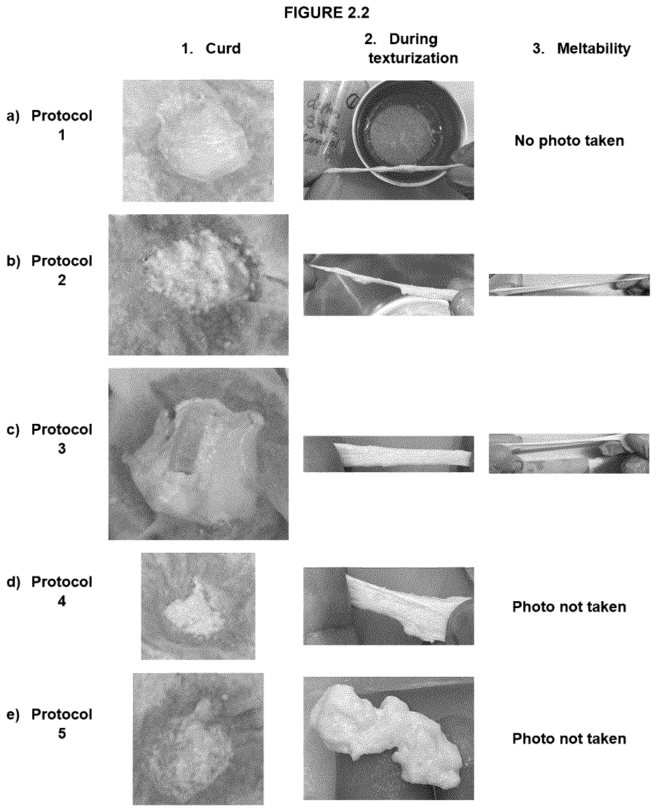

FIG. 2.2 is a series of photographs of curd compositions made in accordance with the process of the present invention from a combination of dephosphorylated β-casein and phosphorylated κ-casein following protocols 1 to 5 [a)-e)] as described in example 3.2; at the stages of 1. raw curd separation; 2. texturization; and 3. after heating the texturized composition to test for meltability.

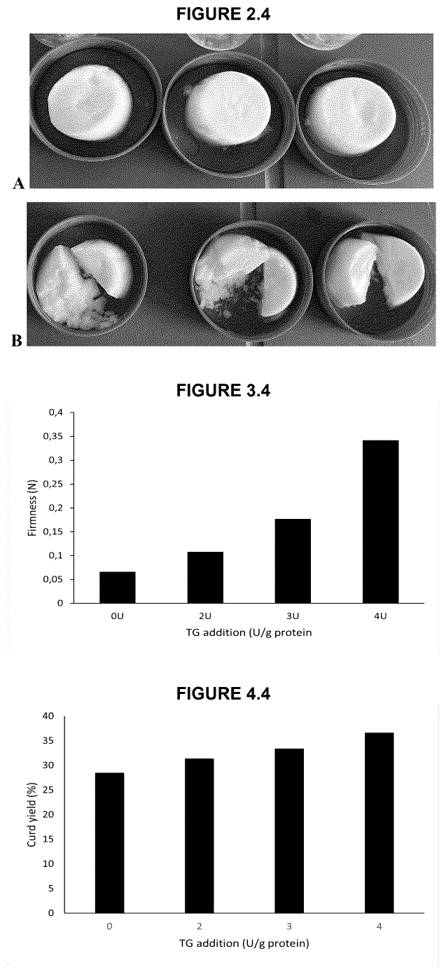

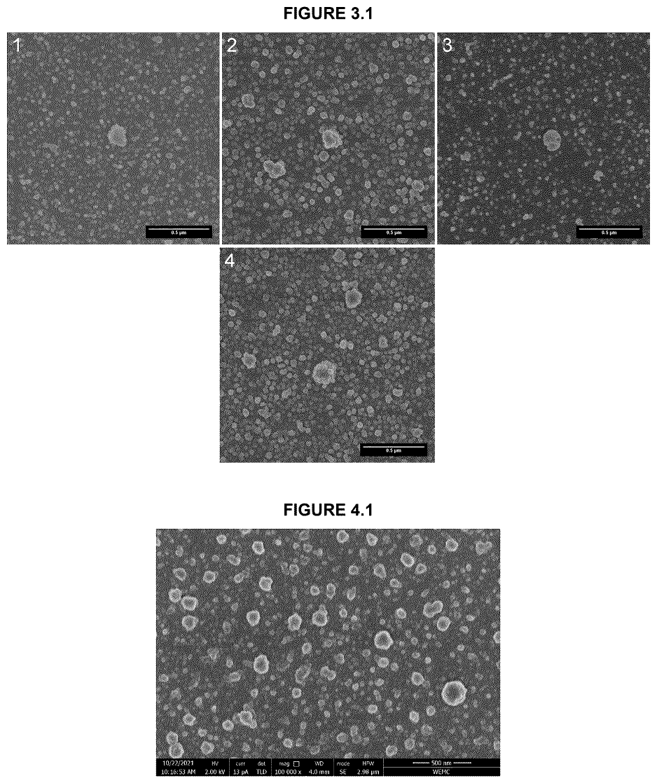

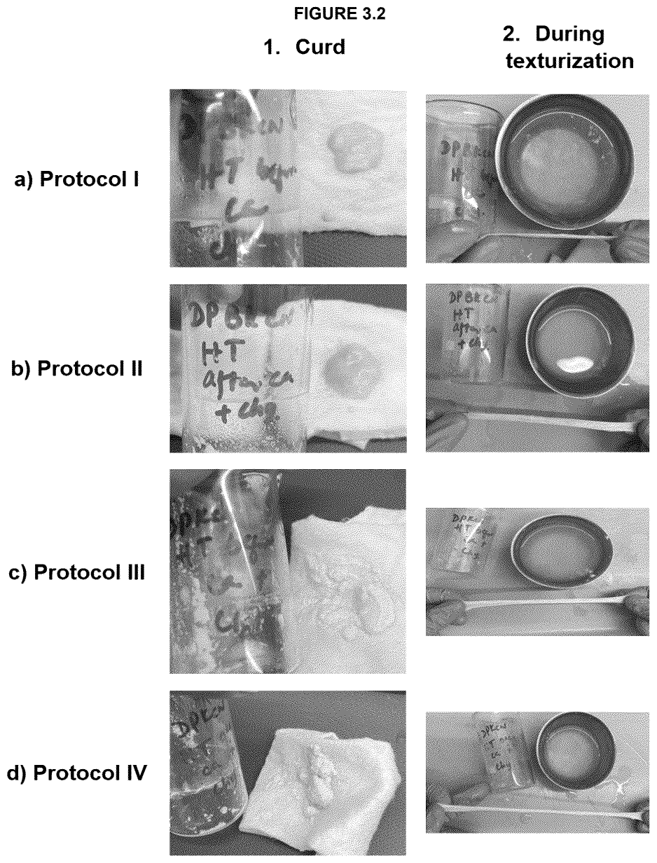

FIG. 3.2 is a series of photographs of curd compositions made in accordance with the process of the present invention from a combination of dephosphorylated β-casein and phosphorylated κ-casein [a) & b)]; and dephosphorylated κ-casein [c) & d)]; following protocols I to IV as described in example 4.2; at the stages of 1. raw curd separation; and 2. Texturization.

FIG. 1.3 is a flow chart of the process for forming mozzarella cheese of the present invention.

FIG. 2.3 shows the a) the curd after whey drainage; b) the curd during kneading and stretching; c) the mozzarella after cold storage; and d) the texture of the cheese.

FIG. 1.4 shows photographs of dephosphorylated sodium caseinate acid gel, with no transglutaminase treatment.

FIG. 2.4 shows photographs of dephosphorylated sodium caseinate acid gel. FIG. 2.2A shows uncut gel. FIG. 2.2B shows cut gel, each with transglutaminase treatment: a) 2U enzyme/g protein; b) 3U enzyme/g protein; and c) 4U enzyme/g protein.

FIG. 3.4 is a bar graph showing gel firmness with increasing transglutaminase concentration during the treatment of the dephosphorylated casein/caseinate.

FIG. 4.4 is a bar graph showing curd yield with increasing transglutaminase concentration during the treatment of the dephosphorylated casein/caseinate.

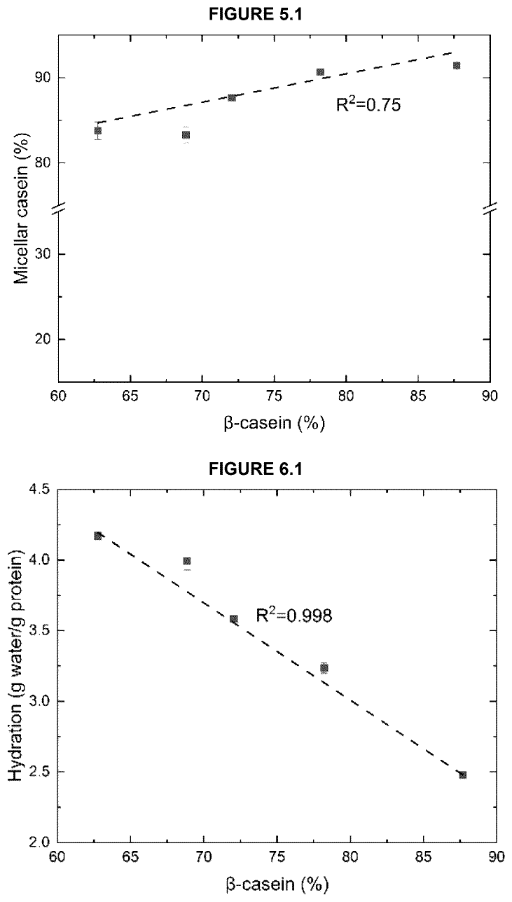

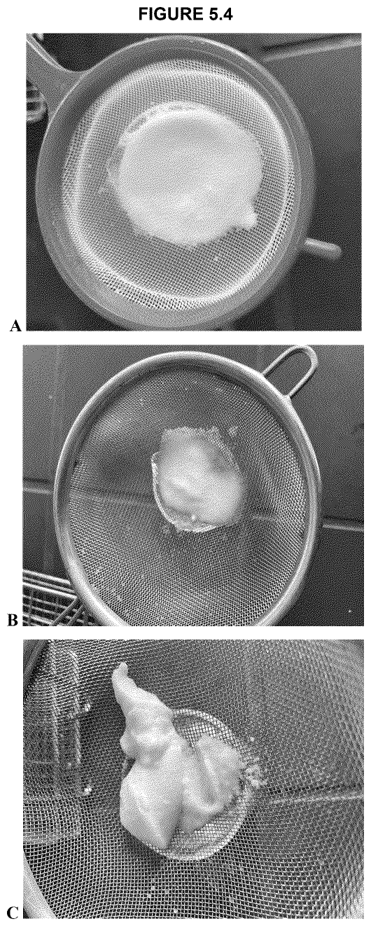

FIG. 5.4 shows photographs of the curd of the dephosphorylated casein/caseinate during whey drainage a) without treatment with transglutaminase, pH 5.2; b) without treatment with transglutaminase, pH 5.6; and c) following treatment with transglutaminase (4U/g protein), pH 5.6.

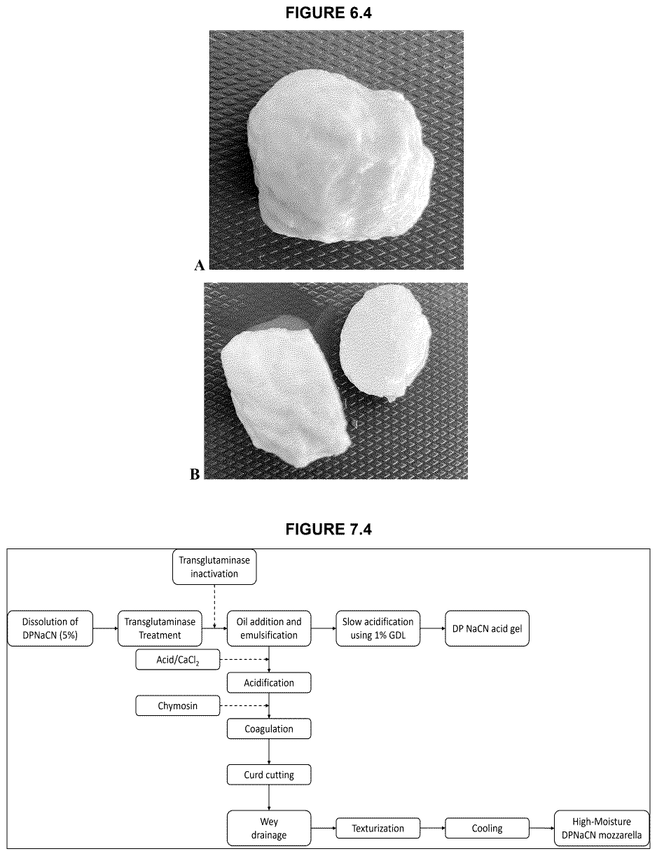

FIG. 6.4 shows photographs of a Mozzarella-like cheese product formed according to the invention.

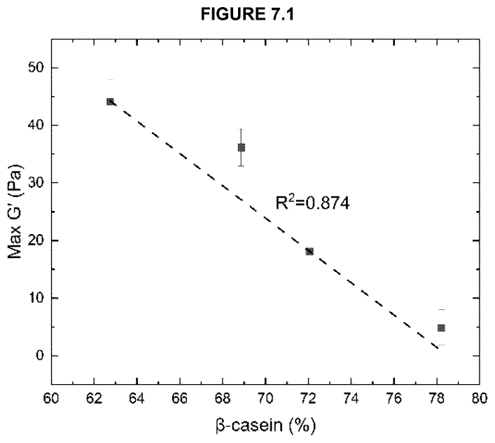

FIG. 7.4 is a schematic diagram showing the process of the present invention.

### Definitions

Throughout this specification, unless the context requires otherwise, the word “comprise” or variations such as “comprises” or “comprising”, will be understood to imply the inclusion of a stated integer or group of integers but not the exclusion of any other integer or group of integers.

Unless expressly indicated as otherwise, the term “%” shall be understood throughout this specification as referring to weight %, or wt. %.

As used herein, the term “micelle”, and grammatical variations thereof, shall be understood to mean a generally (or roughly) spherical supramolecular structure that exists as a dispersion within a composition or solution. A micelle can have, e.g., a surface that is composed of a charged outer layer. A micelle can encapsulate one or more biomolecules. For example, a micelle can encapsulate two or more proteins (e.g., a β-casein protein and a κ-casein protein). A micelle can have diameter of between about 10 nm and about 500 nm. Additional aspects and characteristics of micelles are known in the art.

As used herein, the phrase “substantially free of αₛ-caseins” as it applies to the micellar solutions of the present invention, shall be understood to mean that although some αₛ-caseins may be present as minor impurities in the micellar solutions, they will represent a very minor constituent of the micellar solutions, being at most 0.3% of the total micellar solutions, preferably at most 0.2% of the total micellar solutions, most preferably not more than 0.18% of the total micellar solutions. In terms of the total caseins present in the micellar solutions of the present invention, the phrase “substantially free of αₛ-caseins” shall be understood to mean that although some αₛ-caseins may be present as minor impurities in the total caseins present in the micellar solutions, the αₛ-caseins will be less than 10 wt % of the total caseins present in the micellar solution, preferably less than 8 wt % of the total caseins present in the micellar solution, most preferably not more than 7 wt % of the total caseins present in the micellar solution. The person skilled in the art will be aware that where the protocols described herein are applied to assembling artificial casein micelles comprising recombinantly produced β-casein and κ-casein, the micellar solutions of the present invention, shall be completely free of αₛ-caseins (ie; they will contain 0% αₛ-caseins as a percentage of the total micellar solutions and they will contain 0 wt % αₛ-caseins as a percentage of the total caseins present in the micellar solution).

As used herein, the terms “about,” “approximately,” and grammatical variations thereof, shall be understood to mean within an acceptable error range for the particular value as determined by one of ordinary skill in the art, which can depend in part on how the value is measured or determined, or on the limitations of the measurement system. It should be understood that all ranges and quantities described below are approximations and are not intended to limit the invention. Where ranges and numbers are used these can be approximate to include statistical ranges or measurement errors or variation. In some embodiments, for instance, measurements could be plus or minus 10%.

As used herein, the term “isolated non-human β-casein” shall be understood to mean any β-casein isolated from any non-human source, including β-casein isolates of any non-human mammalian species, as well as any synthetically or recombinantly produced β-casein, and including variants having at least 80% sequence homology with any mammalian β-casein sequence, and including such variants having at least 80% sequence homology with any mammalian β-casein sequence with or without post-translational modifications such as glycosylation and/or phosphorylation. Some embodiments of the artificial micelles of the present invention comprise synthetically or recombinantly produced β-casein variants possessing a sequence homology with any mammalian β-casein sequence, wherein the sequence homology with any mammalian β-casein sequence is selected from the group of sequence homologies consisting of; 80%, 81%, 82%, 83%, 84%, 85%, 86%, 87%, 88%, 89%, 90%, 91%, 92%, 93%, 94%, 95%, 96%, 97%, 98%, 99%, and 100% sequence homology with any mammalian β-casein sequence, with or without post-translational modifications such as glycosylation and/or phosphorylation.

As used herein, the term “κ-casein”, unless the context indicates otherwise, shall be understood to mean any κ-casein isolated from any source, including κ-casein isolates of any mammalian species, as well as any synthetically or recombinantly produced κ-casein, and including variants having at least 80% sequence homology with any mammalian κ-casein sequence, and including such variants having at least 80% sequence homology with any mammalian κ-casein sequence with or without post-translational modifications such as glycosylation and/or phosphorylation. Some embodiments of the curd compositions of the present invention comprise synthetically or recombinantly produced κ-casein variants possessing a sequence homology with any mammalian-casein sequence, wherein the sequence homology with any mammalian κ-casein sequence is selected from the group of sequence homologies consisting of, 80%, 81%, 82%, 83%, 84%, 85%, 86%, 87%, 88%, 89%, 90%, 91%, 92%, 93%, 94%, 95%, 96%, 97%, 98%, 99%, and 100% sequence homology with any mammalian κ-casein sequence, with or without post-translational modifications such as glycosylation and/or phosphorylation.

As used herein, the term “isolated non-human κ-casein” shall be understood to mean any κ-casein isolated from any non-human source, including κ-casein isolates of any non-human mammalian species, as well as any synthetically or recombinantly produced κ-casein, and including variants having at least 80% sequence homology with any mammalian κ-casein sequence, and including such variants having at least 80% sequence homology with any mammalian κ-casein sequence with or without post-translational modifications such as glycosylation and/or phosphorylation. Some embodiments of the artificial micelles of the present invention comprise synthetically or recombinantly produced κ-casein variants possessing a sequence homology with any mammalian-casein sequence, wherein the sequence homology with any mammalian κ-casein sequence is selected from the group of sequence homologies consisting of; 80%, 81%, 82%, 83%, 84%, 85%, 86%, 87%, 88%, 89%, 90%, 91%, 92%, 93%, 94%, 95%, 96%, 97%, 98%, 99%, and 100% sequence homology with any mammalian κ-casein sequence, with or without post-translational modifications such as glycosylation and/or phosphorylation.

As used herein, the term “β-casein”, unless the context indicates otherwise, shall be understood to mean any β-casein isolated from any source, including β-casein isolates of any mammalian species, as well as any synthetically or recombinantly produced β-casein, and including variants having at least 80% sequence homology with any mammalian β-casein sequence, and including such variants having at least 80% sequence homology with any mammalian β-casein sequence with or without post-translational modifications such as glycosylation and/or phosphorylation. Some embodiments of the curd compositions of the present invention comprise synthetically or recombinantly produced β-casein variants possessing a sequence homology with any mammalian β-casein sequence, wherein the sequence homology with any mammalian β-casein sequence is selected from the group of sequence homologies consisting of; 80%, 81%, 82%, 83%, 84%, 85%, 86%, 87%, 88%, 89%, 90%, 91%, 92%, 93%, 94%, 95%, 96%, 97%, 98%, 99%, and 100% sequence homology with any mammalian β-casein sequence, with or without post-translational modifications such as glycosylation and/or phosphorylation.

As used herein, the term “phosphorylated” as it applies to the κ-casein and β-casein constituents utilized in the process of the present invention, will be understood to mean that the constituent to which the term “phosphorylated” is applied, is at least partially phosphorylated, that is to say, a phosphorylated κ-casein will have at least one phosphate group attached to it, and may have a plurality of phosphate groups attached to it, and a phosphorylated β-casein will have at least one phosphate group attached to it, and may have a plurality of phosphate groups attached to it. In other words, the term “phosphorylated” will be understood to include partial phosphorylation as well as complete phosphorylation. Accordingly, the term “phosphorylated κ-casein” will be understood to include native κ-casein (ie; κ-casein isolated from mammalian milk without any dephosphorylation step), as well as partially dephosphorylated κ-casein, as well as recombinantly produced κ-casein that has been partially or completely phosphorylated. Similarly, the term “phosphorylated β-casein” will be understood to include native β-casein, (ie; β-casein isolated from mammalian milk without any dephosphorylation step), as well as partially dephosphorylated β-casein, as well as recombinantly produced β-casein that has been partially or completely phosphorylated.

As used herein, the term “non-phosphorylated” as it applies to the κ-casein and β-casein constituents utilized in the process of the present invention, will be understood to mean that the constituent to which the term “non-phosphorylated” is applied, does not have any phosphate groups attached to it, that is to say, a non-phosphorylated κ-casein will have no phosphate groups attached to it, and a non-phosphorylated β-casein will have no phosphate groups attached to it. In other words, the term “non-phosphorylated” will be understood to include recombinant κ-casein and recombinant β-casein which have not been subjected to any phosphorylation, as well as mammalian-derived κ-casein and mammalian-derived β-casein which have been completely dephosphorylated.

As used herein, the term “dephosphorylated” as it applies to the κ-casein and β-casein constituents utilized in the process of the present invention, will be understood to mean that the constituent to which the term “dephosphorylated” is applied, is at least partially dephosphorylated, that is to say, a dephosphorylated κ-casein may have no phosphate groups attached to it, or may have at least one phosphate group attached to it, or may have a plurality of phosphate groups attached to it, and a dephosphorylated-casein may have no phosphate groups attached to it, or may have at least one phosphate group attached to it, or may have a plurality of phosphate groups attached to it. In other words, the term “dephosphorylated” will be understood to include partial dephosphorylation as well as complete dephosphorylation.

As used herein, the term “animal-derived protein” shall be understood to mean any protein derived from any animal source. It shall further be understood that the term “animal-derived protein” does not include any proteins that are synthetically or recombinantly produced.

As used herein, the term “non-animal derived” as it applies to the curds and downstream products derived from the curds (such as cheese products), as well as any of their individual constituents, will be understood to mean that the constituent or product or composition to which the term “non-animal derived” is applied, will not contain anything derived from an animal, whether the animal is a mammal, a bird, a reptile, a fish, an insect, or another type of animal. However, as used herein, the term “non-animal derived” does include constituents or products or compositions derived from microbial species. That is to say, a plant fat or oil is a non-animal derived lipid, and a recombinantly derived β-casein is a non-animal derived β-casein. A plant protein is a non-animal derived protein, etc. In other words, the term “non-animal derived” includes any constituents or compositions or products derived from plant sources, or from synthetic sources, or microbial sources, or fungal sources, or recombinant sources.

As used herein, the phrase “fat free” as it applies to the emulsions of the process of the present invention, shall be understood to mean that although some fat may be present as minor constituents in the emulsions, they will represent a minor constituent of the emulsions, being at most 3% of the emulsions, preferably at most 2% of the emulsions, most preferably not more than 1% of the emulsions.

Other definitions for selected terms used herein may be found within the detailed description of the invention and apply throughout. Unless otherwise defined, all other scientific and technical terms used herein have the same meaning as commonly understood to one of ordinary skill in the art to which the invention belongs.

### DETAILED DESCRIPTION

### Artificial Micelles

The disclosure herein provides an unprecedented protocol that allows for the preparation of micellar solutions comprising a plurality of artificial casein micelles, wherein the artificial casein micelles comprise isolated non-human β-casein and isolated non-human κ-casein, and wherein the artificial casein micelles are substantially free of αₛ-caseins.

Advantageously, the artificial micellar solutions of the present invention possess suitable micelle sizes and micellar mineral salt content for applicability to downstream product manufacturing such as cheesemaking.

This protocol is directly applicable to the preparation of artificial casein micelles from recombinantly produced β-casein and κ-casein, which are inherently completely free of αₛ-caseins. To provide an initial proof of principle, artificial casein micelles were prepared from bovine β-casein (about 98% pure, containing a minor proportion of α-casein) and bovine κ-casein (70% pure, also containing a minor proportion) in the ratio 75:25. FIG. 1.1 illustrates the process set up.

The pictured beaker glass (FIG. 1.1) represents a jacketed titration vessel coupled to a water bath at a preferred temperature (37° C.). Three separate salt solutions of preferred salts (Solution I: CaCl₂) and MgCl₂; Solution II: KH₂PO₄ and Na₂HPO₄; Solution III; trisodium C₆H₅₀₇) at preferred concentrations (Solution I: 325 mM CaCl₂) and 61.2 mM MgCl₂ adjusted to pH 6.70 with 0.1M HCl; Solution II: 155 mM KH₂PO₄ and 155 mM Na₂HPO₄; Solution III: 14.5 mM trisodium citrate), are titrated into the titration vessel preferred rates (10 mL/h), concomitantly with the titration of a fourth casein solution containing a preferred ratio and a preferred concentration of isolated non-human β-casein and isolated non-human κ-casein (75:25, 64.1 g L⁻¹) metered into the titration vessel at a preferred rate (60 mL/h). After a preferred time period (1 hour) of pumping the solutions, the micelle solution is equilibrated for a preferred time period (30 minutes) at a preferred pH (pH 6.7) and a preferred temperature (37° C.).

The person skilled in the art will appreciate that whilst the abovementioned preferred conditions were utilized to provide proof of principle of the present protocols, variations may be made to each of these preferred conditions without departing from the general principle of application provided by the disclosure of the core inventive concept set forth herein.

For example, the water bath temperature may be varied within any suitable range above or below the preferred temperature of 37° C. For example, the water bath temperature may be set at any temperature selected from the group consisting of; 15±0.5° C., 16±0.5° C., 17±0.5° C., 18±0.5° C., 19±0.5° C., 20±0.5° C., 21±0.5° C., 22±0.5° C., 23±0.5° C., 24±0.5° C., 25±0.5° C., 26±0.5° C., 27±0.5° C., 28±0.5° C., 29±0.5° C., 30±0.5° C., 31±0.5° C., 32±0.5° C., 33±0.5° C., 34±0.5° C., 35±0.5° C., 36±0.5° C., 37±0.5° C., 38±0.5° C., 39±0.5° C., 40±0.5° C., 41±0.5° C., 42±0.5° C., 43±0.5° C., 44±0.5° C., 45±0.5° C., 46±0.5° C., 47±0.5° C., 48±0.5° C., 49±0.5° C., and 50±0.5° C.

Furthermore, the solutions of preferred salts (Solution I: CaCl₂) and MgCl₂; Solution II: KH₂PO₄ and Na₂HPO₄; Solution III; trisodium C₆H₅O₇) may be varied via the use of alternative salts to provide the desired sources of Ca²⁺, Mg²⁺, K⁺, Na⁺, PO₄³⁻, and C₆H₅O₇³⁻ ions. For example, other salts such as, without limitation; calcium acetate, calcium carbonate, calcium citrate, calcium gluconate, calcium sulfate, calcium phosphate, calcium nitrate, magnesium acetate, magnesium carbonate, magnesium citrate, magnesium gluconate, magnesium sulfate, magnesium phosphate, magnesium nitrate, potassium acetate, potassium carbonate, potassium citrate, potassium gluconate, potassium sulfate, dipotassium phosphate, tripotassium phosphate, potassium nitrate, sodium acetate, sodium carbonate, monosodium citrate, disodium citrate, sodium gluconate, sodium sulfate, monosodium phosphate, trisodium phosphate, and sodium nitrate may be used as alternative sources of Ca²⁺, Mg²⁺, K⁺, Na⁺, PO₄³⁻, and C₆H₅O₇³⁻ ions.

Furthermore, whilst four separate solutions (three salt solutions and one casein solution) were utilized in the embodiment illustrated in FIG. 1.1, any number of solutions may be utilized and titrated into the titration vessel to provide the artificial micelles of the present invention. For example, separate individual solutions may be prepared and titrated into the titration vessel for each of the Ca²⁺, Mg²⁺, K⁺, Na⁺, PO₄³⁻, and C₆H₅O₆³⁻ ions, and for each of β-casein and κ-casein, and additionally for any acid, base or buffering solutions. Without departing from the invention described herein, the process of the present invention may be executed using 2, 3, 4, 5, 6, 7, 8, 9, 10, 11, 12, 13, 14, or 15 separate solutions. For example, Solution I may be combined with Solution II prior to titration into the titration vessel, and Solution III may be combined with the β-casein and κ-casein solution prior to titration into the titration vessel, resulting in the need to only titrate two solutions into the titration vessel. Alternatively, separate solutions may be prepared and individually titrated into the titration vessel for each of Ca²⁺, Mg²⁺, K⁺, Na⁺, PO₄³⁻, and C₆H₅O₇³⁻ ions, and for each of β-casein and κ-casein, resulting in the need to titrate eight solutions into the titration vessel. Additionally, if a further buffering solution or pH modifying solution is provided, nine solutions would be separately titrated into the titration vessel.

Furthermore, the solutions of salts at preferred concentrations may be varied in their concentrations of Ca²⁺, Mg²⁺, K⁺, Na⁺, PO₄³⁻, and C₆H₅O₇³⁻ ions. For example, Ca²⁺, Mg²⁺, K⁺, Na⁺, PO₄³⁻, and C₆H₅O₇³⁻ ions may each independently be provided in concentrations which vary, and which fall anywhere within the range of from 0.01 mM to 1.0 M, depending on the process scale, rate of titration and desired characteristics in the resultant micellar solution. Preferably, but without limitation, Ca²⁺, Mg²⁺, K⁺, Na⁺, PO₄³⁻, and C₆H₅O₇³⁻ ions may each independently be provided in concentrations selected from the group comprising 1±0.5 mM, 2±1 mM, 4±1 mM, 6±1 mM, 8±1 mM, 10±1 mM, 12±1 mM, 14±1 mM, 16±1 mM, 18±1 mM, 20±1 mM, 22±1 mM, 24±1 mM, 26±1 mM, 28±1 mM, 30±1 mM, 32±1 mM, 34±1 mM, 36═1 mM, 38±1 mM, 40±1 mM, 42±1 mM, 44±1 mM, 46±1 mM, 48±1 mM, 50±1 mM, 52±1 mM, 54±1 mM, 56±1 mM, 58±1 mM, 60±1 mM, 62±1 mM, 64±1 mM, 66±1 mM, 68±1 mM, 70±1 mM, 72±1 mM, 74±1 mM, 76±1 mM, 78±1 mM, 80±1 mM, 82±1 mM, 84±1 mM, 86±1 mM, 88±1 mM, 90±1 mM, 92±1 mM, 94±1 mM, 96±1 mM, 98±1 mM, 100±1 mM, 102±1 mM, 104±1 mM, 106±1 mM, 108±1 mM, 110±1 mM, 112±1 mM, 114±1 mM, 116±1 mM, 118±1 mM, 120±1 mM, 122±1 mM, 124±1 mM, 126±1 mM, 128±1 mM, 130±1 mM, 132±1 mM, 134±1 mM, 136±1 mM, 138±1 mM, 140±1 mM, 142±1 mM, 144±1 mM, 146±1 mM, 148±1 mM, 150±1 mM, 152±1 mM, 154±1 mM, 156±1 mM, 158±1 mM, 160±1 mM, 162±1 mM, 164±1 mM, 166±1 mM, 168±1 mM, 170±1 mM, 172±1 mM, 174±1 mM, 176±1 mM, 178±1 mM, 180±1 mM, 182±1 mM, 184±1 mM, 186±1 mM, 188±1 mM, 190±1 mM, 192±1 mM, 194±1 mM, 196±1 mM, 198±1 mM, 200±1 mM, 202±1 mM, 204±1 mM, 206±1 mM, 208±1 mM, 210±1 mM, 212±1 mM, 214±1 mM, 216±1 mM, 218±1 mM, 220±1 mM, 222±1 mM, 224±1 mM, 226±1 mM, 228±1 mM, 230±1 mM, 232±1 mM, 234±1 mM, 236±1 mM, 238±1 mM, 240±1 mM, 242±1 mM, 244±1 mM, 246±1 mM, 248±1 mM, 250±1 mM, 252±1 mM, 254±1 mM, 256±1 mM, 258±1 mM, 260±1 mM, 262±1 mM, 264±1 mM, 266±1 mM, 268±1 mM, 270±1 mM, 272±1 mM, 274±1 mM, 276±1 mM, 278±1 mM, 280±1 mM, 282±1 mM, 284±1 mM, 286±1 mM, 288±1 mM, 290±1 mM, 292±1 mM, 294±1 mM, 296±1 mM, 298±1 mM, 300±1 mM, 302±1 mM, 304±1 mM, 306±1 mM, 308±1 mM, 310±1 mM, 312±1 mM, 314±1 mM, 316±1 mM, 318±1 mM, 320±1 mM, 322±1 mM, 324±1 mM, 326±1 mM, 328±1 mM, 330±1 mM, 332±1 mM, 334±1 mM, 336±1 mM, 338±1 mM, 340±1 mM, 342±1 mM, 344±1 mM, 346±1 mM, 348±1 mM, 350±1 mM, 352±1 mM, 354±1 mM, 356±1 mM, 358±1 mM, 360±1 mM, 362±1 mM, 364±1 mM, 366±1 mM, 368±1 mM, 370±1 mM, 372±1 mM, 374±1 mM, 376±1 mM, 378±1 mM, 380±1 mM, 382±1 mM, 384±1 mM, 386±1 mM, 388±1 mM, 390±1 mM, 392±1 mM, 394±1 mM, 396±1 mM, 398±1 mM, 400±1 mM, 402±1 mM, 404±1 mM, 406±1 mM, 408±1 mM, 410±1 mM, 412±1 mM, 414±1 mM, 416±1 mM, 418±1 mM, 420±1 mM, 422±1 mM, 424±1 mM, 426±1 mM, 428±1 mM, 430±1 mM, 432±1 mM, 434±1 mM, 436±1 mM, 438=1 mM, 440±1 mM, 442±1 mM, 444±1 mM, 446±1 mM, 448±1 mM, 450±1 mM, 452±1 mM, 454±1 mM, 456±1 mM, 458±1 mM, 460±1 mM, 462±1 mM, 464±1 mM, 466±1 mM, 468±1 mM, 470±1 mM, 472±1 mM, 474±1 mM, 476±1 mM, 478±1 mM, 480±1 mM, 482±1 mM, 484±1 mM, 486±1 mM, 488±1 mM, 490±1 mM, 492±1 mM, 494±1 mM, 496±1 mM, 498±1 mM, and 500±1 mM.

Similarly, the solutions of isolated non-human β-casein and isolated non-human κ-casein at preferred concentrations may be varied in their concentrations of isolated non-human β-casein and isolated non-human κ-casein. For example, isolated non-human β-casein and isolated non-human κ-casein may each independently be provided in concentrations which vary, and which fall anywhere within the range of from 1 g/L to 500 g/L, depending on the process scale, rate of titration and desired characteristics in the resultant micellar solution. Preferably, but without limitation, isolated non-human β-casein and isolated non-human κ-casein may each independently be provided in concentrations selected from the group comprising; 1 g/L, 2 g/L, 3 g/L, 4 g/L, 5 g/L, 6 g/L, 7 g/L, 8 g/L, 9 g/L, 10±5 g/L, 20±5 g/L, 30±5 g/L, 40±5 g/L, 50±5 g/L, 60±5 g/L, 70±5 g/L, 80±5 g/L, 90±5 g/L, 100±5 g/L, 1100±5 g/L, 120±5 g/L, 130±5 g/L, 140±5 g/L, 150±5 g/L, 160±5 g/L, 170±5 g/L, 180±5 g/L, 190±5 g/L, 200±5 g/L, 210±5 g/L, 220±5 g/L, 230±5 g/L, 240±5 g/L, 250±5 g/L, 260±5 g/L, 270±5 g/L, 280±5 g/L, 290±5 g/L, 300±5 g/L, 310±5 g/L, 320±5 g/L, 330±5 g/L, 340±5 g/L, 350±5 g/L, 360±5 g/L, 370±5 g/L, 380±5 g/L, 390±5 g/L, 400±5 g/L, 410±5 g/L, 420±5 g/L, 430±5 g/L, 440±5 g/L, 450±5 g/L, 460±5 g/L, 470±5 g/L, 480±5 g/L, 490±5 g/L, and 500±5 g/L.

In addition, the solutions of isolated non-human β-casein and isolated non-human κ-casein when combined in a single solution, at preferred ratios may be varied in their ratios of isolated non-human β-casein and isolated non-human κ-casein. For example, isolated non-human β-casein and isolated non-human κ-casein may be provided in ratios of β-casein: κ-casein which vary, and which fall anywhere within the range of from 5:95 to 95:5, depending on the process scale, rate of titration and desired characteristics in the resultant micellar solution. Preferably, but without limitation, isolated non-human β-casein and isolated non-human κ-casein may be provided in ratios (β-casein: κ-casein) selected from the group comprising; 5:95, 10:90, 15:85, 20:80, 25:75, 30:70, 35:65, 40:60, 45:55, 50:50, 55:45, 60:40, 65:35, 70:30, 75:25, 80:20, 85:15, 90:10, and 95:5. Alternatively, isolated non-human β-casein and isolated non-human κ-casein may be provided in separate solutions and their individual concentrations and rates of titration into the titration vessel may be suitably controlled in order to achieve any of the aforementioned ratios of β-casein: κ-casein in the final micellar solution product produced by the process of the present invention.

Furthermore, each of the solutions of Ca²⁺, Mg²⁺, K⁺, Na⁺, PO₄³⁻, and C₆H₅O₇³⁻ ions, and the solutions of isolated non-human β-casein and isolated non-human κ-casein, may be varied in their pH, above and below the preferred pH of 6.70, by addition of a suitable acid or base prior to titration into the titration vessel. Suitable acids include HCl, acetic acid, citric acid, malic acid, tartartic acid, folic acid, fumaric acid, ascorbic acid, phosphoric acid, or any other organic acid or inorganic acid that is “Generally recognized as safe” (GRAS) in accordance with the United States Food and Drug Administration (FDA) designation that a chemical or substance added to food is considered safe by experts under the conditions of its intended use. Suitable bases include sodium hydroxide, potassium hydroxide, sodium carbonate, sodium bicarbonate, ammonium bicarbonate, calcium carbonate, potassium carbonate, potassium bicarbonate, or any other organic base or inorganic base that is GRAS. Each of the solutions of Ca²⁺, Mg²⁺, K⁺, Na⁺, PO₄³⁻, and C₆H₅O₇³⁻ ions and the solutions of isolated non-human β-casein and isolated non-human κ-casein may be varied in their pH to any pH falling within the range of pH 4 to pH 10, depending on the process scale, rate of titration and desired characteristics in the resultant micellar solution. Preferably, but without limitation, the solutions of Ca²⁺, Mg²⁺, K⁺, Na⁺, PO₄³⁻, and C₆H₅O₇³⁻ ions and the solutions of isolated non-human β-casein and isolated non-human κ-casein may each independently be provided at a pH selected from the group comprising; pH 4.0, pH 4.1, pH 4.2, pH 4.3, pH 4.4, pH 4.5, pH 4.6, pH 4.7, pH 4.8, pH 4.9, pH 5.0, pH 5.1, pH 5.2, pH 5.3, pH 5.4, pH 5.5, pH 5.6, pH 5.7, pH 5.8, pH 5.9, pH 6.0, pH 6.1, pH 6.2, pH 6.3, pH 6.4, pH 6.5, pH 6.6, pH 6.7, pH 6.8, pH 6.9, pH 7.0, pH 7.1, pH 7.2, pH 7.3, pH 7.4, pH 7.5, pH 7.6, pH 7.7, pH 7.8, pH 7.9, pH 8.0, pH 8.1, pH 8.2, pH 8.3, pH 8.4, pH 8.5, pH 8.6, pH 8.7, pH 8.8, pH 8.9, pH 9.0, pH 9.1, pH 9.2, pH 9.3, pH 9.4, pH 9.5, pH 9.6, pH 9.7, pH 9.8, pH 9.9, and pH 10.

Furthermore, each of the solutions of Ca²⁺, Mg²⁺, K⁺, Na⁺, PO₄³⁻, and C₆H₅O₇³⁻ ions and the solutions of isolated non-human β-casein and isolated non-human κ-casein may be independently titrated into the titration vessel at rates which vary above and below the preferred rate (10 mL/h). For example, and without limitation, each of the solutions of Ca²⁺, Mg²⁺, K⁺, Na⁺, PO₄³⁻, and C₆H₅O₇³⁻ ions and the solutions of isolated non-human β-casein and isolated non-human κ-casein may be independently titrated into the titration vessel at a rate falling within the range of 1.0 mL/h to 1000 L/h, depending on the process scale, rate of titration and desired characteristics in the resultant micellar solution. Preferably, but without limitation, each of the solutions of Ca²⁺, Mg²⁺, K⁺, Na⁺, PO₄³⁻, and C₆H₅O₇³⁻ ions and the solutions of isolated non-human β-casein and isolated non-human κ-casein may be independently titrated into the titration vessel at a rate selected from the group comprising; 1 mL/h, 2 mL/h, 3 mL/h, 4 mL/h, 5 mL/h, 6 mL/h, 7 mL/h, 8 mL/h, 9 mL/h, 10±5 mL/h, 20±5 mL/h, 30±5 mL/h, 40±5 mL/h, 50±5 mL/h, 60±5 mL/h, 70±5 mL/h, 80±5 mL/h, 90±5 mL/h, 100±5 mL/h, 110±5 mL/h, 120±5 mL/h, 130±5 mL/h, 140±5 mL/h, 150±5 mL/h, 160±5 mL/h, 170±5 mL/h, 180±5 mL/h, 190±5 mL/h, 200±5 mL/h, 210=5 mL/h, 220±5 mL/h, 230±5 mL/h, 240±5 mL/h, 250±5 mL/h, 260±5 mL/h, 270±5 mL/h, 280±5 mL/h, 290±5 mL/h, 300±5 mL/h, 310±5 mL/h, 320±5 mL/h, 330±5 mL/h, 340±5 mL/h, 350±5 mL/h, 360±5 mL/h, 370±5 mL/h, 380±5 mL/h, 390±5 mL/h, 400±5 mL/h, 410±5 mL/h, 420±5 mL/h, 430±5 mL/h, 440±5 mL/h, 450±5 mL/h, 460±5 mL/h, 470±5 mL/h, 480±5 mL/h, 490±5 mL/h, 500±5 mL/h, 510±5 mL/h, 520±5 mL/h, 530±5 mL/h, 540±5 mL/h, 550±5 mL/h, 560±5 mL/h, 570±5 mL/h, 580=5 mL/h, 590±5 mL/h, 600±5 mL/h, 610±5 mL/h, 620=5 mL/h, 630±5 mL/h, 640±5 mL/h, 650±5 mL/h, 660±5 mL/h, 670±5 mL/h, 680±5 mL/h, 690±5 mL/h, 700±5 mL/h, 710±5 mL/h, 720±5 mL/h, 730±5 mL/h, 740±5 mL/h, 750±5 mL/h, 760±5 mL/h, 770±5 mL/h, 780±5 mL/h, 790±5 mL/h, 800±5 mL/h, 810±5 mL/h, 820±5 mL/h, 830±5 mL/h, 840±5 mL/h, 850±5 mL/h, 860±5 mL/h, 870±5 mL/h, 880±5 mL/h, 890±5 mL/h, 900±5 mL/h, 910±5 mL/h, 920±5 mL/h, 930±5 mL/h, 940±5 mL/h, 950±5 mL/h, 960±5 mL/h, 970±5 mL/h, 980±5 mL/h, 990±5 mL/h, 1000±5 mL/h, 2 L/h, 3 L/h, 4 L/h, 5 L/h, 6 L/h, 7 L/h, 8 L/h, 9 L/h, 0±5 L/h, 20±5 L/h, 30±5 L/h, 40±5 L/h, 50±5 L/h, 60±5 L/h, 70±5 L/h, 80±5 L/h, 90±5 L/h, 100±5 L/h, 110±5 L/h, 120±5 L/h, 130±5 L/h, 140±5 L/h, 150±5 L/h, 160±5 L/h, 170±5 L/h, 180±5 L/h, 190±5 L/h, 200±5 L/h, 210±5 L/h, 220±5 L/h, 230±5 L/h, 240±5 L/h, 250±5 L/h, 260±5 L/h, 270±5 L/h, 280±5 L/h, 290±5 L/h, 300±5 L/h, 310±5 L/h, 320±5 L/h, 330±5 L/h, 340±5 L/h, 350±5 L/h, 360±5 L/h, 370±5 L/h, 380±5 L/h, 390±5 L/h, 400±5 L/h, 410±5 L/h, 420±5 L/h, 430±5 L/h, 440±5 L/h, 450±5 L/h, 460±5 L/h, 470±5 L/h, 480±5 L/h, 490±5 L/h, 500±5 L/h, 510±5 L/h, 520±5 L/h, 530±5 L/h, 540±5 L/h, 550±5 L/h, 560±5 L/h, 570±5 L/h, 580±5 L/h, 590±5 L/h, 600±5 L/h, 610±5 L/h, 620±5 L/h, 630±5 L/h, 640±5 L/h, 650±5 L/h, 660±5 L/h, 670±5 L/h, 680±5 L/h, 690±5 L/h, 700±5 L/h, 710±5 L/h, 720±5 L/h, 730±5 L/h, 740±5 L/h, 750±5 L/h, 760±5 L/h, 770±5 L/h, 780±5 L/h, 790±5 L/h, 800±5 L/h, 810±5 L/h, 820±5 L/h, 830±5 L/h, 840±5 L/h, 850±5 L/h, 860±5 L/h, 870±5 L/h, 880±5 L/h, 890±5 L/h, 900±5 L/h, 910±5 L/h, 920±5 L/h, 930±5 L/h, 940±5 L/h, 950±5 L/h, 960±5 L/h, 970±5 L/h, 980±5 L/h, 990±5 L/h, and 1000±5 L/h.

Furthermore, the preferred time period (1 hour) of pumping the solutions may be varied without departing from the process of certain embodiments of the invention described herein. For example, and without limitation, each of the solutions of Ca²⁺, Mg²⁺, K⁺, Na⁺, PO₄³⁻, and C₆H₅O₇³⁻ ions and the solutions of isolated non-human β-casein and isolated non-human κ-casein may be independently pumped into the titration vessel for a period of time falling within the range of 0.1 h to 96 h, depending on the process scale, rate of titration and desired characteristics in the resultant micellar solution. Preferably, but without limitation, each of the solutions of Ca²⁺, Mg²⁺, K⁺, Na⁺, PO₄³⁻, and C₆H₅O₇³⁻ ions and the solutions of isolated non-human β-casein and isolated non-human κ-casein may be pumped into the titration vessel for a period of time selected from the group comprising; 0.1 h, 0.2 h, 0.3 h, 0.4 h, 0.5 h, 0.6 h, 0.7 h, 0.8 h, 0.9 h, 1 h, 2±1 h, 4±1 h, 6±1 h, 8±1 h, 10±1 h, 12±1 h, 14±1 h, 16±1 h, 18±1 h, 20±1 h, 22±1 h, 24±1 h, 26±1 h, 28±1 h, 30±1 h, 32±1 h, 34±1 h, 36±1 h, 38±1 h, 40±1 h, 42±1 h, 44±1 h, 46±1 h, 48±1 h, 50±1 h, 52±1 h, 54±1 h, 56±1 h, 58±1 h, 60±1 h, 62±1 h, 64±1 h, 66=1 h, 68±1 h, 70±1 h, 72±1 h, 74±1 h, 76±1 h, 78±1 h, 80±1 h, 82±1 h, 84±1 h, 86±1 h, 88±1 h, 90±1 h, 92±1 h, 94±1 h, and 96=1 h.

Furthermore, the period of time in which the micelle solution is equilibrated, may be varied above and below the preferred time period (30 minutes). For example, and without limitation, the period of time in which the micelle solution is equilibrated may be selected from a time period falling within the range of 1 min to 300 min, depending on the process scale, rate of titration and desired characteristics in the resultant micellar solution. Preferably, but without limitation, the period of time in which the micelle solution is equilibrated may be selected from the group comprising; 1 min, 2 min, 3 min, 4 min, 5 min, 6 min, 7 min, 8 min, 9 min, 10 min, 11 min, 12 min, 13 min, 14 min, 15 min, 16 min, 17 min, 18 min, 19 min, 20 min, 21 min, 22 min, 23 min, 24 min, 25 min, 26 min, 27 min, 28 min, 29 min, 30 min, 31 min, 32 min, 33 min, 34 min, 35 min, 36 min, 37 min, 38 min, 39 min, 40 min, 41 min, 42 min, 43 min, 44 min, 45 min, 46 min, 47 min, 48 min, 49 min, 50 min, 51 min, 52 min, 53 min, 54 min, 55 min, 56 min, 57 min, 58 min, 59 min, 60 min, 61 min, 62 min, 63 min, 64 min, 65 min, 66 min, 67 min, 68 min, 69 min, 70 min, 71 min, 72 min, 73 min, 74 min, 75 min, 76 min, 77 min, 78 min, 79 min, 80 min, 81 min, 82 min, 83 min, 84 min, 85 min, 86 min, 87 min, 88 min, 89 min, 90 min, 91 min, 92 min, 93 min, 94 min, 95 min, 96 min, 97 min, 98 min, 99 min, 100 min, 101 min, 102 min, 103 min, 104 min, 105 min, 106 min, 107 min, 108 min, 109 min, 110 min, 111 min, 112 min, 113 min, 114 min, 115 min, 116 min, 117 min, 118 min, 119 min, 120 min, 121 min, 122 min, 123 min, 124 min, 125 min, 126 min, 127 min, 128 min, 129 min, 130 min, 131 min, 132 min, 133 min, 134 min, 135 min, 136 min, 137 min, 138 min, 139 min, 140 min, 141 min, 142 min, 143 min, 144 min, 145 min, 146 min, 147 min, 148 min, 149 min, 150 min, 151 min, 152 min, 153 min, 154 min, 155 min, 156 min, 157 min, 158 min, 159 min, 160 min, 161 min, 162 min, 163 min, 164 min, 165 min, 166 min, 167 min, 168 min, 169 min, 170 min, 171 min, 172 min, 173 min, 174 min, 175 min, 176 min, 177 min, 178 min, 179 min, 180 min, 181 min, 182 min, 183 min, 184 min, 185 min, 186 min, 187 min, 188 min, 189 min, 190 min, 191 min, 192 min, 193 min, 194 min, 195 min, 196 min, 197 min, 198 min, 199 min, 200 min, 201 min, 202 min, 203 min, 204 min, 205 min, 206 min, 207 min, 208 min, 209 min, 210 min, 211 min, 212 min, 213 min, 214 min, 215 min, 216 min, 217 min, 218 min, 219 min, 220 min, 221 min, 222 min, 223 min, 224 min, 225 min, 226 min, 227 min, 228 min, 229 min, 230 min, 231 min, 232 min, 233 min, 234 min, 235 min, 236 min, 237 min, 238 min, 239 min, 240 min, 241 min, 242 min, 243 min, 244 min, 245 min, 246 min, 247 min, 248 min, 249 min, 250 min, 251 min, 252 min, 253 min, 254 min, 255 min, 256 min, 257 min, 258 min, 259 min, 260 min, 261 min, 262 min, 263 min, 264 min, 265 min, 266 min, 267 min, 268 min, 269 min, 270 min, 271 min, 272 min, 273 min, 274 min, 275 min, 276 min, 277 min, 278 min, 279 min, 280 min, 281 min, 282 min, 283 min, 284 min, 285 min, 286 min, 287 min, 288 min, 289 min, 290 min, 291 min, 292 min, 293 min, 294 min, 295 min, 296 min, 297 min, 298 min, 299 min, and 300 min.

Furthermore, the pH at which the micelle solution is equilibrated, may be varied above and below the preferred (pH 6.7). For example, and without limitation, the pH at which the micelle solution is equilibrated may be selected from a pH falling within the range of pH 4 to pH 10, depending on the process scale, rate of titration and desired characteristics in the resultant micellar solution. Preferably, but without limitation, the pH at which the micelle solution is equilibrated may be selected from the group comprising; pH 4.0, pH 4.1, pH 4.2, pH 4.3, pH 4.4, pH 4.5, pH 4.6, pH 4.7, pH 4.8, pH 4.9, pH 5.0, pH 5.1, pH 5.2, pH 5.3, pH 5.4, pH 5.5, pH 5.6, pH 5.7, pH 5.8, pH 5.9, pH 6.0, pH 6.1, pH 6.2, pH 6.3, pH 6.4, pH 6.5, pH 6.6, pH 6.7, pH 6.8, pH 6.9, pH 7.0, pH 7.1, pH 7.2, pH 7.3, pH 7.4, pH 7.5, pH 7.6, pH 7.7, pH 7.8, pH 7.9, pH 8.0, pH 8.1, pH 8.2, pH 8.3, pH 8.4, pH 8.5, pH 8.6, pH 8.7, pH 8.8, pH 8.9, pH 9.0, pH 9.1, pH 9.2, pH 9.3, pH 9.4, pH 9.5, pH 9.6, pH 9.7, pH 9.8, pH 9.9, and pH 10.

Furthermore, the temperature of micelle solution equilibration may be varied within any suitable range above or below the preferred temperature of 37° C. For example, the temperature of micelle solution equilibration may be set at any temperature selected from the group consisting of; 15±0.5° C., 16±0.5° C., 17±0.5° C., 18±0.5° C., 19±0.5° C., 20±0.5° C., 21±0.5° C., 22±0.5° C., 23±0.5° C., 24±0.5° C., 25±0.5° C., 26±0.5° C., 27±0.5° C., 28±0.5° C., 29±0.5° C., 30±0.5° C., 31±0.5° C., 32±0.5° C., 33±0.5° C., 34±0.5° C., 35±0.5° C., 36±0.5° C., 37±0.5° C., 38±0.5° C., 39±0.5° C., 40±0.5° C., 41±0.5° C., 42±0.5° C., 43±0.5° C., 44±0.5° C., 45±0.5° C., 46±0.5° C., 47±0.5° C., 48±0.5° C., 49±0.5° C., and 50±0.5° C.

The skilled addressee will appreciate that infringement of the claims of the present specification may be detected by a number of means. Without limitation, one means by which infringement of the claims of the present specification may be detected is via high-performance liquid chromatography (HPLC) analysis of the protein content of a potentially infringing product or micelle, where the absence, or detection of only very small amounts of αₛ-caseins, may be indicative of infringement. Alternatively, and without limitation, it may be possible to determine infringement via microscopical methods such as scanning electron microscopy (SEM).

The protocols described herein provide micellar solutions comprising a plurality of artificial casein micelles, wherein the artificial casein micelles comprise isolated non-human β-casein and isolated non-human κ-casein, and wherein the artificial casein micelles are substantially free of αₛ-caseins.

In some embodiments, the Z-average diameter of the artificial casein micelles is greater than 30 nm. The Z-average diameter of the artificial casein micelles of the present invention may be determined, for example and without limitation, via dynamic light scattering measurements or via scanning electron microscopy (SEM) as performed in the examples herein. Without limitation, the Z-average diameter of the artificial casein micelles of the present invention may be greater than; 30 nm, 31 nm, 32 nm, 33 nm, 34 nm, 35 nm, 36 nm, 37 nm, 38 nm, 39 nm, 40 nm, 41 nm, 42 nm, 43 nm, 44 nm, 45 nm, 46 nm, 47 nm, 48 nm, 49 nm, 50 nm, 51 nm, 52 nm, 53 nm, 54 nm, 55 nm, 56 nm, 57 nm, 58 nm, 59 nm, 60 nm, 61 nm, 62 nm, 63 nm, 64 nm, 65 nm, 66 nm, 67 nm, 68 nm, 69 nm, 70 nm, 71 nm, 72 nm, 73 nm, 74 nm, 75 nm, 76 nm, 77 nm, 78 nm, 79 nm, 80 nm, 81 nm, 82 nm, 83 nm, 84 nm, 85 nm, 86 nm, 87 nm, 88 nm, 89 nm, 90 nm, 91 nm, 92 nm, 93 nm, 94 nm, 95 nm, 96 nm, 97 nm, 98 nm, 99 nm, 100 nm, 101 nm, 102 nm, 103 nm, 104 nm, 105 nm, 106 nm, 107 nm, 108 nm, 109 nm, 110 nm, 111 nm, 112 nm, 113 nm, 114 nm, 115 nm, 116 nm, 117 nm, 118 nm, 119 nm, 120 nm, 121 nm, 122 nm, 123 nm, 124 nm, 125 nm, 126 nm, 127 nm, 128 nm, 129 nm, 130 nm, 131 nm, 132 nm, 133 nm, 134 nm, 135 nm, 136 nm, 137 nm, 138 nm, 139 nm, 140 nm, 141 nm, 142 nm, 143 nm, 144 nm, 145 nm, 146 nm, 147 nm, 148 nm, 149 nm, 150 nm, 151 nm, 152 nm, 153 nm, 154 nm, 155 nm, 156 nm, 157 nm, 158 nm, 159 nm, 160 nm, 161 nm, 162 nm, 163 nm, 164 nm, 165 nm, 166 nm, 167 nm, 168 nm, 169 nm, 170 nm, 171 nm, 172 nm, 173 nm, 174 nm, 175 nm, 176 nm, 177 nm, 178 nm, 179 nm, 180 nm, 181 nm, 182 nm, 183 nm, 184 nm, 185 nm, 186 nm, 187 nm, 188 nm, 189 nm, 190 nm, 191 nm, 192 nm, 193 nm, 194 nm, 195 nm, 196 nm, 197 nm, 198 nm, 199 nm, 200 nm, 201 nm, 202 nm, 203 nm, 204 nm, 205 nm, 206 nm, 207 nm, 208 nm, 209 nm, 210 nm, 211 nm, 212 nm, 213 nm, 214 nm, 215 nm, 216 nm, 217 nm, 218 nm, 219 nm, 220 nm, 221 nm, 222 nm, 223 nm, 224 nm, 225 nm, 226 nm, 227 nm, 228 nm, 229 nm, 230 nm, 231 nm, 232 nm, 233 nm, 234 nm, 235 nm, 236 nm, 237 nm, 238 nm, 239 nm, 240 nm, 241 nm, 242 nm, 243 nm, 244 nm, 245 nm, 246 nm, 247 nm, 248 nm, 249 nm, 250 nm, 251 nm, 252 nm, 253 nm, 254 nm, 255 nm, 256 nm, 257 nm, 258 nm, 259 nm, 260 nm, 261 nm, 262 nm, 263 nm, 264 nm, 265 nm, 266 nm, 267 nm, 268 nm, 269 nm, 270 nm, 271 nm, 272 nm, 273 nm, 274 nm, 275 nm, 276 nm, 277 nm, 278 nm, 279 nm, 280 nm, 281 nm, 282 nm, 283 nm, 284 nm, 285 nm, 286 nm, 287 nm, 288 nm, 289 nm, 290 nm, 291 nm, 292 nm, 293 nm, 294 nm, 295 nm, 296 nm, 297 nm, 298 nm, 299 nm, or 300 nm.

In preferred embodiments, the Z-average diameter of the artificial casein micelles falls within the range of 40 to 500 nm. Without limitation, the Z-average diameter of the artificial casein micelles of particularly preferred embodiments may fall within any range selected from the group of ranges comprising; 40 to 500 nm, 45 to 500 nm, 50 to 500 nm, 55 to 500 nm, 60 to 500 nm, 65 to 500 nm, 70 to 500 nm, 75 to 500 nm, 80 to 500 nm, 85 to 500 nm, 90 to 500 nm, 95 to 500 nm, 100 to 500 nm, 105 to 500 nm, 110 to 500 nm, 115 to 500 nm, 120 to 500 nm, 125 to 500 nm, 130 to 500 nm, 135 to 500 nm, 140 to 500 nm, 145 to 500 nm, 150 to 500 nm, 155 to 500 nm, 160 to 500 nm, 165 to 500 nm, 170 to 500 nm, 175 to 500 nm, 180 to 500 nm, 185 to 500 nm, 190 to 500 nm, 195 to 500 nm, 200 to 500 nm, 205 to 500 nm, 210 to 500 nm, 215 to 500 nm, 220 to 500 nm, 225 to 500 nm, 230 to 500 nm, 235 to 500 nm, 240 to 500 nm, 245 to 500 nm, 250 to 500 nm, 255 to 500 nm, 260 to 500 nm, 265 to 500 nm, 270 to 500 nm, 275 to 500 nm, 280 to 500 nm, 285 to 500 nm, 290 to 500 nm, 295 to 500 nm, 300 to 500 nm, 305 to 500 nm, 310 to 500 nm, 315 to 500 nm, 320 to 500 nm, 325 to 500 nm, 330 to 500 nm, 335 to 500 nm, 340 to 500 nm, 345 to 500 nm, 350 to 500 nm, 355 to 500 nm, 360 to 500 nm, 365 to 500 nm, 370 to 500 nm, 375 to 500 nm, 380 to 500 nm, 385 to 500 nm, 390 to 500 nm, 395 to 500 nm, 400 to 500 nm, 405 to 500 nm, 410 to 500 nm, 415 to 500 nm, 420 to 500 nm, 425 to 500 nm, 430 to 500 nm, 435 to 500 nm, 440 to 500 nm, 445 to 500 nm, 450 to 500 nm, 455 to 500 nm, 460 to 500 nm, 465 to 500 nm, 470 to 500 nm, 475 to 500 nm, 480 to 500 nm, 485 to 500 nm, 490 to 500 nm, and 495 to 500 nm.

In some embodiments, the micellar solutions described herein comprise less than 7 wt % αₛ-caseins as a percentage of the total caseins present in the micellar solution. Preferably, the micellar solutions described herein comprise an amount of αₛ-caseins, as a percentage of the total caseins present in the micellar solution, selected from the group comprising; 7 wt %, 6.9 wt %, 6.8 wt %, 6.7 wt %, 6.6 wt %, 6.5 wt %, 6.4 wt %, 6.3 wt %, 6.2 wt %, 6.1 wt %, 6 wt %, 5.9 wt %, 5.8 wt %, 5.7 wt %, 5.6 wt %, 5.5 wt %, 5.4 wt %, 5.3 wt %, 5.2 wt %, 5.1 wt %, 5 wt %, 4.9 wt %, 4.8 wt %, 4.7 wt %, 4.6 wt %, 4.5 wt %, 4.4 wt %, 4.3 wt %, 4.2 wt %, 4.1 wt %, 4 wt %, 3.9 wt %, 3.8 wt %, 3.7 wt %, 3.6 wt %, 3.5 wt %, 3.4 wt %, 3.3 wt %, 3.2 wt %, 3.1 wt %, 3 wt %, 2.9 wt %, 2.8 wt %, 2.7 wt %, 2.6 wt %, 2.5 wt %, 2.4 wt %, 2.3 wt %, 2.2 wt %, 2.1 wt %, 2 wt %, 1.9 wt %, 1.8 wt %, 1.7 wt %, 1.6 wt %, 1.5 wt %, 1.4 wt %, 1.3 wt %, 1.2 wt %, 1.1 wt %, 1 wt %, 0.9 wt %, 0.8 wt %, 0.7 wt %, 0.6 wt %, 0.5 wt %, 0.4 wt %, 0.3 wt %, 0.2 wt %, 0.1 wt %, and 0 wt %.

In some embodiments, the micellar solutions described herein comprise a wt % ratio of non-human β-casein to non-human κ-casein falling within the range of 10:90 to 90:10. Without limitation, the wt % ratio of non-human β-casein to non-human κ-casein (b:k) may be selected from the group comprising; 5:95, 10:90, 15:85, 20:80, 25:75, 30:70, 35:65, 40:60, 45:55, 50:50, 55:45, 60:40, 65:35, 70:30, 75:25, 80:20, 85:15, 90:10, and 95:5.

In some embodiments, the micellar solutions described herein comprise a total casein concentration falling within the range of 10 g/L to 95 g/L. Without limitation, the total casein concentration in the micellar solutions of the present invention may be selected from the group comprising; 10 g/L, 11 g/L, 12 g/L, 13 g/L, 14 g/L, 15 g/L, 16 g/L, 17 g/L, 18 g/L, 19 g/L, 20 g/L, 21 g/L, 22 g/L, 23 g/L, 24 g/L, 25 g/L, 26 g/L, 27 g/L, 28 g/L, 29 g/L, 30 g/L, 31 g/L, 32 g/L, 33 g/L, 34 g/L, 35 g/L, 36 g/L, 37 g/L, 38 g/L, 39 g/L, 40 g/L, 41 g/L, 42 g/L, 43 g/L, 44 g/L, 45 g/L, 46 g/L, 47 g/L, 48 g/L, 49 g/L, 50 g/L, 51 g/L, 52 g/L, 53 g/L, 54 g/L, 55 g/L, 56 g/L, 57 g/L, 58 g/L, 59 g/L, 60 g/L, 61 g/L, 62 g/L, 63 g/L, 64 g/L, 65 g/L, 66 g/L, 67 g/L, 68 g/L, 69 g/L, 70 g/L, 71 g/L, 72 g/L, 73 g/L, 74 g/L, 75 g/L, 76 g/L, 77 g/L, 78 g/L, 79 g/L, 80 g/L, 81 g/L, 82 g/L, 83 g/L, 84 g/L, 85 g/L, 86 g/L, 87 g/L, 88 g/L, 89 g/L, 90 g/L, 91 g/L, 92 g/L, 93 g/L, 94 g/L, and 95 g/L.

In some embodiments, the micellar solutions described herein comprise a total non-human β-casein concentration falling within the range of 1 g/L to 90 g/L. Without limitation, the total non-human β-casein concentration in the micellar solutions of the present invention may be selected from the group comprising; 1 g/L, 2 g/L, 3 g/L, 4 g/L, 5 g/L, 6 g/L, 7 g/L, 8 g/L, 9 g/L, 10 g/L, 11 g/L, 12 g/L, 13 g/L, 14 g/L, 15 g/L, 16 g/L, 17 g/L, 18 g/L, 19 g/L, 20 g/L, 21 g/L, 22 g/L, 23 g/L, 24 g/L, 25 g/L, 26 g/L, 27 g/L, 28 g/L, 29 g/L, 30 g/L, 31 g/L, 32 g/L, 33 g/L, 34 g/L, 35 g/L, 36 g/L, 37 g/L, 38 g/L, 39 g/L, 40 g/L, 41 g/L, 42 g/L, 43 g/L, 44 g/L, 45 g/L, 46 g/L, 47 g/L, 48 g/L, 49 g/L, 50 g/L, 51 g/L, 52 g/L, 53 g/L, 54 g/L, 55 g/L, 56 g/L, 57 g/L, 58 g/L, 59 g/L, 60 g/L, 61 g/L, 62 g/L, 63 g/L, 64 g/L, 65 g/L, 66 g/L, 67 g/L, 68 g/L, 69 g/L, 70 g/L, 71 g/L, 72 g/L, 73 g/L, 74 g/L, 75 g/L, 76 g/L, 77 g/L, 78 g/L, 79 g/L, 80 g/L, 81 g/L, 82 g/L, 83 g/L, 84 g/L, 85 g/L, 86 g/L, 87 g/L, 88 g/L, 89 g/L, and 90 g/L.

In some embodiments, the micellar solutions described herein comprise a total non-human κ-casein concentration falling within the range of 1 g/L to 90 g/L. Without limitation, the total non-human κ-casein concentration in the micellar solutions of the present invention may be selected from the group comprising; 1 g/L, 2 g/L, 3 g/L, 4 g/L, 5 g/L, 6 g/L, 7 g/L, 8 g/L, 9 g/L, 10 g/L, 11 g/L, 12 g/L, 13 g/L, 14 g/L, 15 g/L, 16 g/L, 17 g/L, 18 g/L, 19 g/L, 20 g/L, 21 g/L, 22 g/L, 23 g/L, 24 g/L, 25 g/L, 26 g/L, 27 g/L, 28 g/L, 29 g/L, 30 g/L, 31 g/L, 32 g/L, 33 g/L, 34 g/L, 35 g/L, 36 g/L, 37 g/L, 38 g/L, 39 g/L, 40 g/L, 41 g/L, 42 g/L, 43 g/L, 44 g/L, 45 g/L, 46 g/L, 47 g/L, 48 g/L, 49 g/L, 50 g/L, 51 g/L, 52 g/L, 53 g/L, 54 g/L, 55 g/L, 56 g/L, 57 g/L, 58 g/L, 59 g/L, 60 g/L, 61 g/L, 62 g/L, 63 g/L, 64 g/L, 65 g/L, 66 g/L, 67 g/L, 68 g/L, 69 g/L, 70 g/L, 71 g/L, 72 g/L, 73 g/L, 74 g/L, 75 g/L, 76 g/L, 77 g/L, 78 g/L, 79 g/L, 80 g/L, 81 g/L, 82 g/L, 83 g/L, 84 g/L, 85 g/L, 86 g/L, 87 g/L, 88 g/L, 89 g/L, and 90 g/L.

In some embodiments, the micellar solutions described herein comprise an αₛ₁-casein concentration falling within the range of 0 g/L to 2 g/L. Without limitation, the αₛ₁-casein concentration of the micellar solutions may fall within any range selected from the group of ranges comprising; 0 g/L to 2 g/L, 0 g/L to 1.9 g/L, 0 g/L to 1.8 g/L, 0 g/L to 1.7 g/L, 0 g/L to 1.6 g/L, 0 g/L to 1.5 g/L, 0 g/L to 1.4 g/L, 0 g/L to 1.3 g/L, 0 g/L to 1.2 g/L, 0 g/L to 1.1 g/L, 0 g/L to 1 g/L, 0 g/L to 0.9 g/L, 0 g/L to 0.8 g/L, 0 g/L to 0.7 g/L, 0 g/L to 0.6 g/L, 0 g/L to 0.5 g/L, 0 g/L to 0.4 g/L, 0 g/L to 0.3 g/L, 0 g/L to 0.2 g/L, and 0 g/L to 0.1 g/L.

In some embodiments, the micellar solutions described herein comprise an αₛ₂-casein concentration falling within the range of 0 g/L to 1 g/L. Without limitation, the αₛ₂-casein concentration of the micellar solutions may fall within any range selected from the group of ranges comprising; 0 g/L to 1 g/L, 0 g/L to 0.9 g/L, 0 g/L to 0.8 g/L, 0 g/L to 0.7 g/L, 0 g/L to 0.6 g/L, 0 g/L to 0.5 g/L, 0 g/L to 0.4 g/L, 0 g/L to 0.3 g/L, 0 g/L to 0.2 g/L, and 0 g/L to 0.1 g/L.

In some embodiments, the hydration of the artificial casein micelles in the micellar solutions of the present invention, falls within the range of 1 to 8 (g water/g micellar protein). Without limitation, the hydration of the artificial casein micelles in the micellar solutions of the present invention, may be selected from the group comprising; 1 (g water/g micellar protein), 1.1 (g water/g micellar protein), 1.2 (g water/g micellar protein), 1.3 (g water/g micellar protein), 1.4 (g water/g micellar protein), 1.5 (g water/g micellar protein), 1.6 (g water/g micellar protein), 1.7 (g water/g micellar protein), 1.8 (g water/g micellar protein), 1.9 (g water/g micellar protein), 2 (g water/g micellar protein), 2.1 (g water/g micellar protein), 2.2 (g water/g micellar protein), 2.3 (g water/g micellar protein), 2.4 (g water/g micellar protein), 2.5 (g water/g micellar protein), 2.6 (g water/g micellar protein), 2.7 (g water/g micellar protein), 2.8 (g water/g micellar protein), 2.9 (g water/g micellar protein), 3 (g water/g micellar protein), 3.1 (g water/g micellar protein), 3.2 (g water/g micellar protein), 3.3 (g water/g micellar protein), 3.4 (g water/g micellar protein), 3.5 (g water/g micellar protein), 3.6 (g water/g micellar protein), 3.7 (g water/g micellar protein), 3.8 (g water/g micellar protein), 3.9 (g water/g micellar protein), 4 (g water/g micellar protein), 4.1 (g water/g micellar protein), 4.2 (g water/g micellar protein), 4.3 (g water/g micellar protein), 4.4 (g water/g micellar protein), 4.5 (g water/g micellar protein), 4.6 (g water/g micellar protein), 4.7 (g water/g micellar protein), 4.8 (g water/g micellar protein), 4.9 (g water/g micellar protein), 5 (g water/g micellar protein), 5.1 (g water/g micellar protein), 5.2 (g water/g micellar protein), 5.3 (g water/g micellar protein), 5.4 (g water/g micellar protein), 5.5 (g water/g micellar protein), 5.6 (g water/g micellar protein), 5.7 (g water/g micellar protein), 5.8 (g water/g micellar protein), 5.9 (g water/g micellar protein), 6 (g water/g micellar protein), 6.1 (g water/g micellar protein), 6.2 (g water/g micellar protein), 6.3 (g water/g micellar protein), 6.4 (g water/g micellar protein), 6.5 (g water/g micellar protein), 6.6 (g water/g micellar protein), 6.7 (g water/g micellar protein), 6.8 (g water/g micellar protein), 6.9 (g water/g micellar protein), 7 (g water/g micellar protein), 7.1 (g water/g micellar protein), 7.2 (g water/g micellar protein), 7.3 (g water/g micellar protein), 7.4 (g water/g micellar protein), 7.5 (g water/g micellar protein), 7.6 (g water/g micellar protein), 7.7 (g water/g micellar protein), 7.8 (g water/g micellar protein), 7.9 (g water/g micellar protein), and 8 (g water/g micellar protein).

In some embodiments, the non-micellar caseins as a percentage of total caseins in the micellar solutions of the present invention, falls within the range of 5 to 20%. Without limitation, the non-micellar caseins as a percentage of total caseins in the micellar solutions of the present invention may be selected from the group comprising; 5%, 5.1%, 5.2%, 5.3%, 5.4%, 5.5%, 5.6%, 5.7%, 5.8%, 5.9%, 6%, 6.1%, 6.2%, 6.3%, 6.4%, 6.5%, 6.6%, 6.7%, 6.8%, 6.9%, 7%, 7.1%, 7.2%, 7.3%, 7.4%, 7.5%, 7.6%, 7.7%, 7.8%, 7.9%, 8%, 8.1%, 8.2%, 8.3%, 8.4%, 8.5%, 8.6%, 8.7%, 8.8%, 8.9%, 9%, 9.1%, 9.2%, 9.3%, 9.4%, 9.5%, 9.6%, 9.7%, 9.8%, 9.9%, 10%, 10.1%, 10.2%, 10.3%, 10.4%, 10.5%, 10.6%, 10.7%, 10.8%, 10.9%, 11%, 11.1%, 11.2%, 11.3%, 11.4%, 11.5%, 11.6%, 11.7%, 11.8%, 11.9%, 12%, 12.1%, 12.2%, 12.3%, 12.4%, 12.5%, 12.6%, 12.7%, 12.8%, 12.9%, 13%, 13.1%, 13.2%, 13.3%, 13.4%, 13.5%, 13.6%, 13.7%, 13.8%, 13.9%, 14%, 14.1%, 14.2%, 14.3%, 14.4%, 14.5%, 14.6%, 14.7%, 14.8%, 14.9%, 15%, 15.1%, 15.2%, 15.3%, 15.4%, 15.5%, 15.6%, 15.7%, 15.8%, 15.9%, 16%, 16.1%, 16.2%, 16.3%, 16.4%, 16.5%, 16.6%, 16.7%, 16.8%, 16.9%, 17%, 17.1%, 17.2%, 17.3%, 17.4%, 17.5%, 17.6%, 17.7%, 17.8%, 17.9%, 18%, 18.1%, 18.2%, 18.3%, 18.4%, 18.5%, 18.6%, 18.7%, 18.8%, 18.9%, 19%, 19.1%, 19.2%, 19.3%, 19.4%, 19.5%, 19.6%, 19.7%, 19.8%, 19.9%, and 20%.

In some embodiments, the micellar calcium content in the micellar solutions of the present invention, is at least 70% of the total calcium in the micellar solution. Without limitation, the micellar calcium content in the micellar solutions of the present invention may be more than any percentage selected from the group of percentages comprising; 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, and 99%; of the total calcium in the micellar solution.

In some embodiments, the micellar magnesium content in the micellar solutions of the present invention, is at least 30%, preferably at least 35% of the total magnesium in the micellar solution. Without limitation, the micellar magnesium content in the micellar solutions of the present invention may be more than any percentage selected from the group of percentages comprising; 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, and 99%; of the total magnesium in the micellar solution.

In some embodiments, the micellar inorganic phosphate content in the micellar solutions of the present invention, is at least 50% of the total inorganic phosphate in the micellar solution. Without limitation, the micellar inorganic phosphate content in the micellar solutions of the present invention may be more than any percentage selected from the group of percentages comprising; 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, and 99%; of the total inorganic phosphate in the micellar solution.

In some embodiments, the micellar citrate content in the micellar solutions of the present invention, is at least 5% of the total citrate in the micellar solution. Without limitation, the micellar citrate content in the micellar solutions of the present invention may be more than any percentage selected from the group of percentages comprising; 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, and 99%; of the total citrate in the micellar solution.

In one embodiment, the disclosure herein provides a curds composition comprising the micellar solution of the present invention, in coagulated form.

The curds composition may be a useful precursor for the manufacture of downstream products such as yogurt or cheese. The curds composition may be coagulated by the action of an acid or a renneting agent. Suitable acids for coagulation include, without limitation, citric acid vinegar, and lactic acid.

In some embodiments, a yogurt composition may be formed using the methods described herein. The yogurt may be formed using the micellar solution described herein. The method may comprise heating and then cooling the micellar solution and acidifying the micellar solution with an acid or a microorganism. The microorganism may comprise one or more of Lactobacillus delbrueckii subsp. bulgaricus, Streptococcus thermophilus, a lactobacilli, or a bifidobacteria.

In some embodiments, following acidification, a renneting agent may be added to form a renneted curd (coagulated curd matrix), which may then be used to make cheese. Micelles in a micellar solution, such as milk and also the micellar solution described herein, are stable and repel each other in colloidal suspension. In presence of renneting agents or milk-clotting enzymes, and when acidified, micelles are destabilized and attract each other, and thus coagulate. In presence of renneting agents or milk-clotting enzymes, cross-linked coagulated curd matrix is formed.

In some embodiments, the curds composition further comprises a renneting agent. Renneting agents suitable for performance of the present invention include, without limitation, protease enzymes, chymosin, pepsin, lipase, animal derived rennet, plant derived rennet (including extracts from Galium spp., dried caper leaves, nettles, thistles, mallow, Withania coagulans, ground ivy, Cynara, soy), calf rennet, kid goat rennet, fungi derived rennet, microbially derived rennet (eg., extracts of Rhizomucor miehei) and recombinantly produced chymosin.

In a preferred embodiment, the curds composition has a Maximum G′ (storage modulus) falling within the range of 5 to 200 Pa, preferably after 1 hour incubation with rennet. Without limitation, the Maximum G′ of the curds composition of the present invention after any period of incubation with rennet selected from the group comprising; 0.1 hr, 0.2 hr, 0.3 hr, 0.4 hr, 0.5 hr, 0.6 hr, 0.7 hr, 0.8 hr, 0.9 hr, 1 hr, 1.1 hr, 1.2 hr, 1.3 hr, 1.4 hr, 1.5 hr, 1.6 hr, 1.7 hr, 1.8 hr, 1.9 hr, 2 hr, 2.1 hr, 2.2 hr, 2.3 hr, 2.4 hr, 2.5 hr, 2.6 hr, 2.7 hr, 2.8 hr, 2.9 hr, 3 hr, 3.1 hr, 3.2 hr, 3.3 hr, 3.4 hr, 3.5 hr, 3.6 hr, 3.7 hr, 3.8 hr, 3.9 hr, 4 hr, 4.1 hr, 4.2 hr, 4.3 hr, 4.4 hr, 4.5 hr, 4.6 hr, 4.7 hr, 4.8 hr, 4.9 hr, 5 hr, 5.1 hr, 5.2 hr, 5.3 hr, 5.4 hr, 5.5 hr, 5.6 hr, 5.7 hr, 5.8 hr, 5.9 hr, and 6 hr; may fall within any range selected from the group of ranges comprising; 5 to 200 Pa, 10 to 200 Pa, 15 to 200 Pa, 20 to 200 Pa, 25 to 200 Pa, 30 to 200 Pa, 35 to 200 Pa, 40 to 200 Pa, 45 to 200 Pa, 50 to 200 Pa, 55 to 200 Pa, 60 to 200 Pa, 65 to 200 Pa, 70 to 200 Pa, 75 to 200 Pa, 80 to 200 Pa, 85 to 200 Pa, 90 to 200 Pa, 95 to 200 Pa, 100 to 200 Pa, 105 to 200 Pa, 110 to 200 Pa, 115 to 200 Pa, 120 to 200 Pa, 125 to 200 Pa, 130 to 200 Pa, 135 to 200 Pa, 140 to 200 Pa, 145 to 200 Pa, 150 to 200 Pa, 155 to 200 Pa, 160 to 200 Pa, 165 to 200 Pa, 170 to 200 Pa, 175 to 200 Pa, 180 to 200 Pa, 185 to 200 Pa, 190 to 200 Pa, and 195 to 200 Pa.

In a further embodiment, the disclosure herein provides an edible composition comprising the micellar solution of the present invention, or the curds composition of the present invention. Such edible compositions include, without limitation, yogurts, cheeses and milk substitutes.

In some embodiments, the edible composition does not contain any animal-derived protein.

In one embodiment, the disclosure herein provides a method for producing an edible composition, comprising: combining isolated non-human β-casein, isolated non-human κ-casein and at least one salt under conditions wherein the β-casein and the κ-casein form a micellar solution, wherein the micellar solution is substantially free of αₛ-caseins; and subjecting the micellar solution to a first condition to form coagulates.

In some embodiments of the method for producing an edible composition, the first condition is the addition of acid or acidification of the micellar solution with a microorganism.

In some embodiments of the method for producing an edible composition, the method further comprises subjecting the coagulates to a renneting agent to form a rennetted curd.

In some embodiments of the method for producing an edible composition, the method further comprises aging and/or maturing the rennetted curd to form a cheese composition. Renneted curd may be further treated to create a cheese or cheese like product. In some cases, such as a mozzarella product, the renneted curd may be heated and stretched. In other embodiments, the renneted curd is aged, such as for brie, camembert, feta, halloumi, gouda, edam, cheddar, manchego, swiss, colby, muenster, blue cheese or parmesan type cheese or cheese-like product.

In some embodiments, the micellar solution or renneted curd may be treated with hot water for the formation of cheese, such as for mozzarella-type cheese. Hot water treatment may be performed at a temperature of about 50° C. to about 90° C. Hot water treatment may be performed at a temperature of at least 55° C. Hot water treatment may be performed at a temperature of at most 75° C. Hot water treatment may be performed at a temperature of 50° C. to 55° C., 55° C. to 60° C., 55° C. to 65° C., 55° C. to 70° C., 55° C. to 75° C., 60° C. to 65° C., 60° C. to 70° C., 60° C. to 75° C., 65° C. to 70° C., 65° C. to 75° C., 70° C. to 75° C., 75° C. to 80° C., 80° C. to 85° C., or 85° C. to 90° C. Hot water treatment may be performed at a temperature of about 50° C., about 55° C., about 60° C., about 65° C., about 70° C., about 75° C., about 80° C., about 85° C. or about 90° C. Hot water treatment may be performed at a temperature of at least 50° C., 55° C., 60° C., 65° C., 70° C., 75° C., 80° C., or 85° C. Hot water treatment may be performed at a temperature of at most 55° C., 60° C., 65° C., 70° C., 75° C., 80° C., 85° C. or 90° C. In some cases, after hot water treatment, the product is stretched into a cheese.

In some embodiments of the method for producing an edible composition, the edible composition does not contain any animal-derived protein.

Cheese compositions formed using the methods described herein optionally may not comprise any animal-derived components for example, where recombinantly derived casein proteins are utilised. Cheese compositions formed using the methods described herein may optionally not comprise any animal-derived dairy-based components, such as animal-derived dairy proteins. Cheese compositions formed using the methods described herein may optionally not comprise any whey proteins. Cheese compositions formed using the methods described herein may optionally not comprise any αₛ-casein proteins. Cheese compositions described herein may be pasta-filata like cheese such as mozzarella cheese. Soft cheeses such as paneer, cream cheese or cottage cheese may also be formed using the methods described herein. Other types of cheese such as aged and ripened cheeses may also be formed using the methods described herein, such as brie, camembert, feta, halloumi, gouda, edam, cheddar, manchego, swiss, colby, muenster, blue cheese and parmesan.

The texture of a cheese made by methods described herein may be comparable to the texture of a similar type of cheese made using animal-derived dairy derived proteins, such as cheese made from animal milk. Texture of a cheese may be tested using a trained panel of human subjects or machines such as a texture analyzer.

The taste of a cheese made by methods described herein may be comparable to a similar type of cheese made using animal-derived dairy proteins. Taste of a cheese may be tested using a trained panel of human subjects.

Cheese compositions described herein may have a browning ability which is comparable to a similar type of cheese made using animal-derived dairy proteins. Cheese compositions described herein may have a melting ability which is comparable to a similar type of cheese made using animal-derived dairy proteins.

The texture of a yogurt made by methods described herein may be comparable to the texture of a similar type of yogurt made using animal-derived dairy derived proteins, such as yogurt made from animal milk. Texture of a yogurt may be tested using a trained panel of human subjects or machines such as a texture analyzer.

The taste of a yogurt made by methods described herein may be comparable to a similar type of yogurt made using animal-derived dairy proteins. Taste of a yogurt may be tested using a trained panel of human subjects.

### Emulsions and Curds Compositions

The disclosure herein provides an unprecedented process that allows for the preparation of curds compositions comprising κ-casein alone, or optionally in combination with β-casein, and wherein the curds compositions are substantially free of αₛ-caseins.

Advantageously, the curds compositions of the present invention possess suitable chemical, physical and functional properties for applicability to downstream derivative product manufacturing such as cheesemaking.

This process is directly applicable to the preparation of curds compositions and downstream derivative products from recombinantly produced κ-casein, and optionally β-casein, which are inherently completely free of αₛ-caseins.

Thus, the present disclosure provides a process for the preparation of a curd composition, wherein the process comprises the steps of:
a) preparing an emulsion comprising;
   (i) phosphorylated κ-casein; or
   (ii) dephosphorylated or non-phosphorylated κ-casein; or
   (iii) phosphorylated κ-casein and dephosphorylated or non-phosphorylated κ-casein; or
   (iv) phosphorylated κ-casein, dephosphorylated or non-phosphorylated κ-casein and dephosphorylated or non-phosphorylated β-casein; or
   (v) dephosphorylated or non-phosphorylated κ-casein and dephosphorylated or non-phosphorylated β-casein; or
   (vi) phosphorylated κ-casein and dephosphorylated or non-phosphorylated β-casein; and
   (vii) a lipid source;
b) adding a calcium salt to the emulsion; and
c) coagulating the emulsion.

To provide an initial proof of principle, purified samples of bovine-derived κ-casein and β-casein were obtained to investigate the process of the present invention. Portions of these purified samples of bovine-derived κ-casein and β-casein were also subjected to dephosphorylation to further obtain dephosphorylated κ-casein and dephosphorylated β-casein for use in further investigating the process of the present invention.

As these κ-casein, β-casein, dephosphorylated κ-casein and dephosphorylated β-casein starting materials were bovine-derived, small amounts of αₛ-caseins will be present in them. Accordingly, the process of the present invention includes emulsions which comprise, consist essentially of, or consist of, their specified κ-casein and optionally β-casein, starting materials. Step a) of the process of the present invention involves preparing an emulsion comprising:
(i) phosphorylated κ-casein; or
(ii) dephosphorylated or non-phosphorylated κ-casein; or
(iii) phosphorylated κ-casein and dephosphorylated or non-phosphorylated κ-casein; or
(iv) phosphorylated κ-casein, dephosphorylated or non-phosphorylated κ-casein and dephosphorylated or non-phosphorylated β-casein; or
(v) dephosphorylated or non-phosphorylated κ-casein and dephosphorylated or non-phosphorylated β-casein; or
(vi) phosphorylated κ-casein and dephosphorylated or non-phosphorylated β-casein; and
(vii) a lipid source.

Accordingly, in some embodiments of the invention, step a) of the process of the present invention involves preparing an emulsion consisting essentially of:
(i) phosphorylated-casein; or
(ii) dephosphorylated or non-phosphorylated κ-casein; or
(iii) phosphorylated κ-casein and dephosphorylated or non-phosphorylated κ-casein; or
(iv) phosphorylated κ-casein, dephosphorylated or non-phosphorylated κ-casein and dephosphorylated or non-phosphorylated β-casein; or
(v) dephosphorylated or non-phosphorylated κ-casein and dephosphorylated or non-phosphorylated β-casein; or
(vi) phosphorylated κ-casein and dephosphorylated or non-phosphorylated β-casein; and
(vii) a lipid source.

Furthermore, in some embodiments of the invention, step a) of the process of the present invention involves preparing an emulsion consisting of:
(i) phosphorylated κ-casein; or
(ii) dephosphorylated or non-phosphorylated κ-casein; or
(iii) phosphorylated κ-casein and dephosphorylated or non-phosphorylated κ-casein; or
(iv) phosphorylated κ-casein, dephosphorylated or non-phosphorylated κ-casein and dephosphorylated or non-phosphorylated β-casein; or
(v) dephosphorylated or non-phosphorylated κ-casein and dephosphorylated or non-phosphorylated β-casein; or
(vi) phosphorylated κ-casein and dephosphorylated or non-phosphorylated β-casein; and
(vii) a lipid source.

The lipid source for the preparation of the emulsion precursors for the process of the present invention may be any lipid source suitable for use in food, such as, for example, any lipid source that is “Generally recognized as safe” (GRAS) in accordance with the United States Food and Drug Administration (FDA) designation that a chemical or substance added to food is considered safe by experts under the conditions of its intended use. Where dietary constraints such as vegetarianism or veganism are not of concern, the lipid source may be an animal-derived lipid source, such as fish oil, or krill oil, or milk fat. Where the product of the present process is intended for consumption by vegans, for example, the choice of lipid source should be limited to non-animal-derived lipid sources, such as a non-animal fat or oil, a plant fat or oil, a microbial fat or oil, a fungal fat or oil, a recombinantly-produced fat or oil or a mixture of any of the aforementioned lipid sources. Preferably, the lipid source is a vegetable oil. For example, without limitation, the lipid source may be a vegetable oil selected from the group consisting of peanut oil, soy bean oil, sunflower oil, safflower oil, canola oil, corn oil, avocado oil, almond oil, olive oil, cotton seed oil, coconut oil, sesame oil, chia (Salvia Hispanica L.) seed oil, wheatgerm oil, grape seed oil, rice bran oil, linseed oil, mustard oil, palm oil, castor oil, hydrogenated castor oil, hemp seed oil, and any mixtures of any of the aforementioned vegetable oils.

The emulsion precursors employed in the process of the present invention comprise a total protein concentration falling within the range of 2 wt. % to 20 wt. %; preferably wherein the emulsion comprises a total protein concentration falling within the range of 3 wt. % to 10 wt. %; most preferably wherein the emulsion comprises a total protein concentration falling within the range of 4 wt. % to 8 wt. %. Without departing from the scope of the process of the present invention, the emulsion precursors employed in the process of the present invention may comprise a total protein concentration selected from the group consisting of; 1±0.5 wt. %, 2±0.5 wt. %, 3±0.5 wt. %, 4±0.5 wt. %, 5±0.5 wt. %, 6±0.5 wt. %, 7±0.5 wt. %, 8±0.5 wt. %, 9±0.5 wt. %, 10±0.5 wt. %, 11±0.5 wt. %, 12±0.5 wt. %, 13±0.5 wt. %, 14±0.5 wt. %, 15±0.5 wt. %, 16±0.5 wt. %, 17±0.5 wt. %, 18±0.5 wt. %, 19±0.5 wt. %, and 20±0.5 wt. %.

The emulsion precursors employed in the process of the present invention comprise a fat to protein ratio falling within the range of fat free to 2:0.5; preferably wherein the emulsion comprises a fat to protein ratio falling within the range of 1:1.5 to 1.5:1; most preferably wherein the emulsion comprises a fat to protein ratio of about 1:1. Without departing from the scope of the process of the present invention, the emulsion precursors employed in the process of the present invention may comprise a fat to protein ratio selected from the group consisting of; 0:00, 0.1:0.5, 0.2:0.5, 0.3:0.5, 0.4:0.5, 0.5:0.5, 0.6:0.5, 0.7:0.5, 0.8:0.5, 0.9:0.5, 1:0.5, 1.1:0.5, 1.2:0.5, 1.3:0.5, 1.4:0.5, 1.5:0.5, 1.6:0.5, 1.7:0.5, 1.8:0.5, 1.9:0.5, 2:0.5, 0.1:0.4, 0.2:0.4, 0.3:0.4, 0.4:0.4, 0.5:0.4, 0.6:0.4, 0.7:0.4, 0.8:0.4, 0.9:0.4, 1:0.4, 1.1:0.4, 1.2:0.4, 1.3:0.4, 1.4:0.4, 1.5:0.4, 1.6:0.4, 1.7:0.4, 1.8:0.4, 1.9:0.4, 2:0.4, 0.1:0.3, 0.2:0.3, 0.3:0.3, 0.4:0.3, 0.5:0.3, 0.6:0.3, 0.7:0.3, 0.8:0.3, 0.9:0.3, 1:0.3, 1.1:0.3, 1.2:0.3, 1.3:0.3, 1.4:0.3, 1.5:0.3, 1.6:0.3, 1.7:0.3, 1.8:0.3, 1.9:0.3, 2:0.3, 0.1:0.2, 0.2:0.2, 0.3:0.2, 0.4:0.2, 0.5:0.2, 0.6:0.2, 0.7:0.2, 0.8:0.2, 0.9:0.2, 1:0.2, 1.1:0.2, 1.2:0.2, 1.3:0.2, 1.4:0.2, 1.5:0.2, 1.6:0.2, 1.7:0.2, 1.8:0.2, 1.9:0.2, 2:0.2, 0.1:0.1, 0.2:0.1, 0.3:0.1, 0.4:0.1, 0.5:0.1, 0.6:0.1, 0.7:0.1, 0.8:0.1, 0.9:0.1, 1:0.1, 1.1:0.1, 1.2:0.1, 1.3:0.1, 1.4:0.1, 1.5:0.1, 1.6:0.1, 1.7:0.1, 1.8:0.1, 1.9:0.1 and 2:0.1.

Step b) of the process of the present invention involves adding a calcium salt to the emulsion. Without wishing to be bound by theory, the present inventors believe that the addition of calcium ions to a solution comprising κ-casein induces the formation of micelles, resulting in a micellar solution of caseins, suitable for treatments that induce coagulation in accordance with the present invention.

Although calcium chloride is the preferred salt for the performance of step b) of the process of the present invention, the person skilled in the art will appreciate that any suitable alternative source of Ca²⁺ ions may be used without departing from the scope of the present invention. For example, without limitation, the calcium salt may be any calcium salt selected from the group consisting of; calcium chloride, calcium hydroxide, calcium carbonate, calcium acetate, calcium sulfate, calcium nitrate, calcium citrate, calcium phosphate, calcium stearate, calcium malate, calcium glycerophosphate, calcium lactate, and calcium gluconate or mixtures of any of the aforementioned calcium salts.

In some embodiments, the calcium salt is added at step b) of the process of the present invention, in an amount sufficient to bring the concentration of calcium in the emulsion to a concentration falling within the range of 2 mM to 20 mM; preferably wherein the calcium salt is added to bring the concentration of calcium in the emulsion to a concentration falling within the range of 5 mM to 15 mM; most preferably wherein the calcium salt is added to bring the concentration of calcium in the emulsion to a concentration falling within the range of 8 mM to 12 mM. Without departing from the scope of the process of the present invention, the calcium salt may be added to bring the concentration of calcium in the emulsion to any concentration selected from the group consisting of; 2±0.5 mM, 3±0.5 mM, 4±0.5 mM, 5±0.5 mM, 6±0.5 mM, 7±0.5 mM, 8±0.5 mM, 9±0.5 mM, 10±0.5 mM, 11±0.5 mM, 12±0.5 mM, 13±0.5 mM, 14±0.5 mM, 15±0.5 mM, 16±0.5 mM, 17±0.5 mM, 18±0.5 mM, 19±0.5 mM, and 20±0.5 mM.

Step c) of the process of the present invention involves coagulating the emulsion.

The person skilled in the art will appreciate that a key step in the production of any curd composition from micellar protein solutions is that of coagulation. Coagulation may be facilitated by a number of different means to achieve the necessary coagulation, including coagulation via acidification, and/or coagulation via treatment with an enzyme, and/or coagulation via treatment with a rennet, and/or coagulation via microbial fermentation, and/or assistance of coagulation via heat treatment, at any stage prior to step c). Each of these possible means of inducing coagulation may be combined with the others, and they may be performed in parallel, or sequentially in any order, within certain practical limitations. For example, depending on the temperature employed, heat treatment may not be suitable to perform in parallel with enzyme treatment or microbial fermentation, as the temperature of the heat treatment may denature the enzyme, or kill the microbes, therefore heat treatment may be performed either before, or after enzyme treatment, or before, or after microbial fermentation, in order to avoid may denaturing the enzyme, and/or killing the microbes.

Where coagulation is assisted or facilitated via heat treatment, the skilled addressee will appreciate that process of the present invention may further comprise an additional step of heating the emulsion before step b) (addition of the calcium salt); and/or heating the emulsion before step c) (coagulating the emulsion); at a suitable temperature and for a suitable period of time; preferably wherein the temperature falls within the range of 45° C. to 70° C.; preferably wherein the period of time falls with the range of 1 min to 180 min. Without departing from the scope of the process of the present invention, the suitable temperature may be any temperature selected from the group consisting of; 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C., 65° C., 66° C., 67° C., 68° C., 69° C., and 70° C.; and the suitable period of time may be any period of time selected from the group consisting of; 1 min, 2 min, 3 min, 4 min, 5 min, 6 min, 7 min, 8 min, 9 min, 10 min, 11 min, 12 min, 13 min, 14 min, 15 min, 16 min, 17 min, 18 min, 19 min, 20 min, 21 min, 22 min, 23 min, 24 min, 25 min, 26 min, 27 min, 28 min, 29 min, 30 min, 31 min, 32 min, 33 min, 34 min, 35 min, 36 min, 37 min, 38 min, 39 min, 40 min, 41 min, 42 min, 43 min, 44 min, 45 min, 46 min, 47 min, 48 min, 49 min, 50 min, 51 min, 52 min, 53 min, 54 min, 55 min, 56 min, 57 min, 58 min, 59 min, 60 min, 61 min, 62 min, 63 min, 64 min, 65 min, 66 min, 67 min, 68 min, 69 min, 70 min, 71 min, 72 min, 73 min, 74 min, 75 min, 76 min, 77 min, 78 min, 79 min, 80 min, 81 min, 82 min, 83 min, 84 min, 85 min, 86 min, 87 min, 88 min, 89 min, 90 min, 91 min, 92 min, 93 min, 94 min, 95 min, 96 min, 97 min, 98 min, 99 min, 100 min, 101 min, 102 min, 103 min, 104 min, 105 min, 106 min, 107 min, 108 min, 109 min, 110 min, 111 min, 112 min, 113 min, 114 min, 115 min, 116 min, 117 min, 118 min, 119 min, 120 min, 121 min, 122 min, 123 min, 124 min, 125 min, 126 min, 127 min, 128 min, 129 min, 130 min, 131 min, 132 min, 133 min, 134 min, 135 min, 136 min, 137 min, 138 min, 139 min, 140 min, 141 min, 142 min, 143 min, 144 min, 145 min, 146 min, 147 min, 148 min, 149 min, 150 min, 151 min, 152 min, 153 min, 154 min, 155 min, 156 min, 157 min, 158 min, 159 min, 160 min, 161 min, 162 min, 163 min, 164 min, 165 min, 166 min, 167 min, 168 min, 169 min, 170 min, 171 min, 172 min, 173 min, 174 min, 175 min, 176 min, 177 min, 178 min, 179 min, and 180 min.

Where coagulation is facilitated via acidification, the skilled addressee will appreciate that sufficient acidification may be suitably achieved via addition of an acid, or via treatment with a microbial acidifying agent, or via a fermentation process, or via hydrolysis or dissociation of glucono-delta-lactone. In certain embodiments, sufficient acidification may be suitably achieved by addition of the calcium salt in step b) of the process of the present invention. For example, where calcium phosphate or calcium sulfate are added, or where the caseins in the emulsion are sufficiently phosphorylated and calcium chloride is added, a sufficient reduction in the pH to suitably acidic levels may occur. In other embodiments, sufficient acidification may be suitably achieved via direct addition of an acid. Suitable acids include HCl, acetic acid, citric acid, malic acid, tartartic acid, folic acid, fumaric acid, ascorbic acid, phosphoric acid, salicylic acid, lactic acid, calcium phosphate, or any other organic acid or inorganic acid that is “Generally recognized as safe” (GRAS) in accordance with the United States Food and Drug Administration (FDA) designation that a chemical or substance added to food is considered safe by experts under the conditions of its intended use. Suitable microbial acidifying agents that may be employed in acidification via fermentation include, without limitation, enterobacteria, acetic acid bacteria, lactic acid bacteria, saccharomyces, and yeasts.

In some embodiments, step c) of coagulating the emulsion comprises acidifying the emulsion to a pH falling within the range of pH 4.2 to pH 6.5; preferably wherein coagulating the emulsion comprises acidifying the emulsion to a pH falling within the range of pH 4.8 to pH 5.8; most preferably wherein acidifying the emulsion comprises bringing the emulsion to a pH of about 5.2. Without departing from the scope of the process of the present invention, the emulsion may brought, at step c), to any pH selected from the group consisting of; pH 4.2, pH 4.3, pH 4.4, pH 4.5, pH 4.6, pH 4.7, pH 4.8, pH 4.9, pH 5, pH 5.1, pH 5.2, pH 5.3, pH 5.4, pH 5.5, pH 5.6, pH 5.7, pH 5.8, pH 5.9, pH 6, pH 6.1, pH 6.2, pH 6.3, pH 6.4, and pH 6.5.

Where coagulation is facilitated via treatment with an enzyme, suitable enzymes include, without limitation, aspartic (acid) proteinases, aspartic proteases, aspartic endopeptidases, pepsins, lysyl oxidases, chymosins and/or transglutaminases. Suitable chymosins include, without limitation, recombinantly produced chymosins, and fermentation-produced chymosins (FPCs). Suitable transglutaminases include, without limitation, recombinantly produced transglutaminases and fermentation-produced transglutaminases, Keratinocyte transglutaminase (TGM1), Tissue transglutaminase (TGM2), Epidermal transglutaminase (TGM3), Prostate transglutaminase (TGM4), TGM X (TGM5), TGM Y (TGM6), TGM Z (TGM7), Protein 4.2 (EPB42), Factor XIII (F13 A1), or a transglutaminase from Streptoverticillium mobaraense.

Where coagulation is assisted or facilitated via treatment with a transglutaminase, the skilled addressee will appreciate that process of the present invention may further comprise an additional step of treating the emulsion with transglutaminase before step b) (addition of calcium salt); and/or treating the emulsion with transglutaminase before step c) (coagulation of the emulsion); preferably wherein the additional step of treating the emulsion with transglutaminase comprises adding transglutaminase to the emulsion and incubating at a suitable temperature and for a suitable period of time; preferably wherein the temperature falls within the range of 45° C. to 60° C.; preferably wherein the period of time falls with the range of 1 min to 180 min. Without departing from the scope of the process of the present invention, the suitable temperature may be any temperature selected from the group consisting of; 45° C., 46° C., 47° C., 48° C., 49° C., 50° C., 51° C., 52° C., 53° C., 54° C., 55° C., 56° C., 57° C., 58° C., 59° C., and 60° C.; and the suitable period of time may be any period of time selected from the group consisting of; 1 min, 2 min, 3 min, 4 min, 5 min, 6 min, 7 min, 8 min, 9 min, 10 min, 11 min, 12 min, 13 min, 14 min, 15 min, 16 min, 17 min, 18 min, 19 min, 20 min, 21 min, 22 min, 23 min, 24 min, 25 min, 26 min, 27 min, 28 min, 29 min, 30 min, 31 min, 32 min, 33 min, 34 min, 35 min, 36 min, 37 min, 38 min, 39 min, 40 min, 41 min, 42 min, 43 min, 44 min, 45 min, 46 min, 47 min, 48 min, 49 min, 50 min, 51 min, 52 min, 53 min, 54 min, 55 min, 56 min, 57 min, 58 min, 59 min, 60 min, 61 min, 62 min, 63 min, 64 min, 65 min, 66 min, 67 min, 68 min, 69 min, 70 min, 71 min, 72 min, 73 min, 74 min, 75 min, 76 min, 77 min, 78 min, 79 min, 80 min, 81 min, 82 min, 83 min, 84 min, 85 min, 86 min, 87 min, 88 min, 89 min, 90 min, 91 min, 92 min, 93 min, 94 min, 95 min, 96 min, 97 min, 98 min, 99 min, 100 min, 101 min, 102 min, 103 min, 104 min, 105 min, 106 min, 107 min, 108 min, 109 min, 110 min, 111 min, 112 min, 113 min, 114 min, 115 min, 116 min, 117 min, 118 min, 119 min, 120 min, 121 min, 122 min, 123 min, 124 min, 125 min, 126 min, 127 min, 128 min, 129 min, 130 min, 131 min, 132 min, 133 min, 134 min, 135 min, 136 min, 137 min, 138 min, 139 min, 140 min, 141 min, 142 min, 143 min, 144 min, 145 min, 146 min, 147 min, 148 min, 149 min, 150 min, 151 min, 152 min, 153 min, 154 min, 155 min, 156 min, 157 min, 158 min, 159 min, 160 min, 161 min, 162 min, 163 min, 164 min, 165 min, 166 min, 167 min, 168 min, 169 min, 170 min, 171 min, 172 min, 173 min, 174 min, 175 min, 176 min, 177 min, 178 min, 179 min, and 180 min.

The person skilled in the art will understand that the additional step of heat treatment and the additional step of transglutaminase incubation are unrelated optional steps that may be performed independently of one another, either before or after the addition of the calcium salt at step b) of the process of the present invention, and that both of these additional steps are intended to facilitate favourable coagulation (at step c) and improved functional and physical properties of the resultant curd product. However, in some embodiments, the step of heat treatment may be advantageously performed after the step of transglutaminase incubation, such that the heat treatment step performs the dual functions of enhancing the functionality (particularly stretchability) of the cheese, and also deactivating the transglutaminase enzyme, prior to final coagulation via addition of acid, enzyme, microbe or rennet.

Where coagulation is facilitated via treatment with a rennet, suitable renneting agents include, without limitation, protease enzymes, chymosins, pepsins, lipases, animal derived rennets, plant derived rennets (including extracts from Galium spp., dried caper leaves, nettles, thistles, mallow, Withania coagulans, ground ivy, Cynara, soy), calf rennet, kid goat rennet, fungi derived rennet, microbially derived rennet (eg; extracts of Rhizomucor miehei) and recombinantly produced chymosins.

Where coagulation is facilitated via microbial fermentation, suitable microbes include acidifying fungi, bacteria or yeasts, or species of fungi, bacteria or yeasts that produce enzymes including, without limitation, aspartic (acid) proteinases, aspartic proteases, aspartic endopeptidases, pepsins, lysyl oxidases, chymosins and/or transglutaminases. For example, without limitation, a suitable microbe may be selected from the group consisting of; enterobacteria, acetic acid bacteria, lactic acid bacteria, saccharomyces, yeasts, Rhizomucor miehei, and Streptoverticillium mobaraense.

In some embodiments, at the completion of step c), optimal coagulation is observed after a period of incubation at a suitable temperature. Accordingly, in some embodiments, the process of the present invention further comprises the step of;
d) Incubating the coagulated emulsion produced at step c) for a period of time at a suitable temperature, to produce a coagulate comprising a raw curd and a liquid phase; preferably wherein the period of time falls within the range of 10 min to 180 min; most preferably wherein the period of time falls within the range of 20 min to 60 min; preferably wherein the temperature falls within the range of 18° C. to 50° C.; most preferably wherein the temperature falls within the range of 25° C. to 40° C.

Without departing from the scope of the process of the present invention, the suitable temperature for incubation step d) may be any temperature selected from the group consisting of; 18° C., 19° C., 20° C., 21° C., 22° C., 23° C., 24° C., 25° C., 26° C., 27° C., 28° C., 29° C., 30° C., 31° C., 32° C., 33° C., 34° C., 35° C., 36° C., 37° C., 38° C., 39° C., 40° C., 41° C., 42° C., 43° C., 44° C., 45° C., 46° C., 47° C., 48° C., 49° C., and 50° C.; and the suitable period of time for incubation step d) may be any period of time selected from the group consisting of; 10 min, 11 min, 12 min, 13 min, 14 min, 15 min, 16 min, 17 min, 18 min, 19 min, 20 min, 21 min, 22 min, 23 min, 24 min, 25 min, 26 min, 27 min, 28 min, 29 min, 30 min, 31 min, 32 min, 33 min, 34 min, 35 min, 36 min, 37 min, 38 min, 39 min, 40 min, 41 min, 42 min, 43 min, 44 min, 45 min, 46 min, 47 min, 48 min, 49 min, 50 min, 51 min, 52 min, 53 min, 54 min, 55 min, 56 min, 57 min, 58 min, 59 min, 60 min, 61 min, 62 min, 63 min, 64 min, 65 min, 66 min, 67 min, 68 min, 69 min, 70 min, 71 min, 72 min, 73 min, 74 min, 75 min, 76 min, 77 min, 78 min, 79 min, 80 min, 81 min, 82 min, 83 min, 84 min, 85 min, 86 min, 87 min, 88 min, 89 min, 90 min, 91 min, 92 min, 93 min, 94 min, 95 min, 96 min, 97 min, 98 min, 99 min, 100 min, 101 min, 102 min, 103 min, 104 min, 105 min, 106 min, 107 min, 108 min, 109 min, 110 min, 111 min, 112 min, 113 min, 114 min, 115 min, 116 min, 117 min, 118 min, 119 min, 120 min, 121 min, 122 min, 123 min, 124 min, 125 min, 126 min, 127 min, 128 min, 129 min, 130 min, 131 min, 132 min, 133 min, 134 min, 135 min, 136 min, 137 min, 138 min, 139 min, 140 min, 141 min, 142 min, 143 min, 144 min, 145 min, 146 min, 147 min, 148 min, 149 min, 150 min, 151 min, 152 min, 153 min, 154 min, 155 min, 156 min, 157 min, 158 min, 159 min, 160 min, 161 min, 162 min, 163 min, 164 min, 165 min, 166 min, 167 min, 168 min, 169 min, 170 min, 171 min, 172 min, 173 min, 174 min, 175 min, 176 min, 177 min, 178 min, 179 min, and 180 min.

The process of the present invention provides a curd composition at step e):
e) removing the raw curd of the coagulate produced in step d) (incubation) from the liquid phase of the coagulate produced in step d) to provide a curd composition.

The curd composition produced by the process of the present invention may be further processed to provide favourable functional and physical properties, depending on the downstream derivative product intended to be produced with the curd composition. Accordingly, in some embodiments, the process of the present invention further comprises the step of:
f) texturizing the curd composition produced in step e) (isolation of curd composition) in water, or brine, or water comprising whey, or brine comprising whey, at an elevated temperature, to provide a textured curd composition.

In some embodiments, step f) of texturizing the curd composition produced in step e) in water, or brine, or water comprising whey, or brine comprising whey, at an elevated temperature, comprises an elevated temperature falling within the range of 60° C. to 95° C.; preferably an elevated temperature falling within the range of 70° C. to 90° C.; most preferably an elevated temperature falling within the range of 75° C. to 85° C. Without departing from the scope of the process of the present invention, the elevated temperature for texturizing step f) may be any temperature selected from the group consisting of; 60° C., 61° C., 62° C., 63° C., 64° C., 65° C., 66° C., 67° C., 68° C., 69° C., 70° C., 71° C., 72° C., 73° C., 74° C., 75° C., 76° C., 77° C., 78° C., 79° C., 80° C., 81° C., 82° C., 83° C., 84° C., 85° C., 86° C., 87° C., 88° C., 89° C., 90° C., 91° C., 92° C., 93° C., 94° C., and 95° C.

In some embodiments, step f) of texturizing the curd composition produced in step e) in water, or brine, or water comprising whey, or brine comprising whey, at an elevated temperature comprises texturizing at a curd composition to water ratio falling within the range of 0.5:3 to 3:0.5; preferably at a curd composition to water ratio falling within the range of 1:2 to 2:1; most preferably at a curd composition to water ratio of 1:2. Without departing from the scope of the process of the present invention, the curd composition to water ratio for texturizing the curd composition in step f) may be any ratio selected from the group consisting of; 0.5:3, 0.6:3, 0.7:3, 0.8:3, 0.9:3, 1:3, 1.1:3, 1.2:3, 1.3:3, 1.4:3, 1.5:3, 1.6:3, 1.7:3, 1.8:3, 1.9:3, 2:3, 2.1:3, 2.2:3, 2.3:3, 2.4:3, 2.5:3, 2.6:3, 2.7:3, 2.8:3, 2.9:3, 3:3, 3:2.9, 3:2.8, 3:2.7, 3:2.6, 3:2.5, 3:2.4, 3:2.3, 3:2.2, 3:2.1, 3:2, 3:1.9, 3:1.8, 3:1.7, 3:1.6, 3:1.5, 3:1.4, 3:1.3, 3:1.2, 3:1.1, 3:1, 3:0.9, 3:0.8, 3:0.7, 3:0.6 and 3:0.5.

In some embodiments, step f) of texturizing the curd composition produced in step e) further comprises texturizing via kneading and/or stretching and/or folding the curd composition, and optionally forming the curd composition into a ball.

In some embodiments, the process of the present invention further comprises the step of:
g) cooling the textured curd composition; preferably in brine or water.

By developing a method to (re)assemble non-micellar caseins into casein micelles and then coagulate them, the present inventors have created artificial casein micelles from κ-casein only, and from κ-casein with β-casein only, without the need of αₛ₁-casein and αₛ₂-casein, and with coagulation properties very similar to natural bovine casein micelles in terms of micelle size and mineral content. These artificial micelles may also be coagulated by the action of heat, or rennet, or enzymes, or acids, or microbes, or combinations thereof, to create the same cheese textures as those produced from bovine milk, allowing for the complete replacement of the functionality of bovine casein micelles.

The curds compositions produced by the process of the present invention may be a useful precursor for the manufacture of downstream products such as yogurts or cheeses. Thus, in a further embodiment, the disclosure herein provides an edible composition, or food product comprising the curd composition of the present invention. Such edible compositions or food products include, without limitation, yogurts, and cheeses.

In some embodiments, the present invention provides a food product comprising caseins, when produced by the process of the present invention. In a preferred embodiment, the food product is a non-animal derived cheese product. In a particularly preferred embodiment, the food product is a non-animal derived mozzarella type cheese product, or pasta filata type cheese product.

In some embodiments, a yogurt composition food product may be formed using the methods described herein. The yogurt may be formed using the curd composition produced by the process described herein. The method may comprise incubating the curd composition with a microorganism. The microorganism may comprise one or more of Lactobacillus delbrueckii subsp. bulgaricus, Streptococcus thermophilus, a lactobacilli or a bifidobacteria.

The texture of a yogurt made by methods described herein may be comparable to the texture of a similar type of yogurt made using animal-derived or dairy derived proteins, such as yogurt made from animal milk. Texture of a yogurt may be tested using a trained panel of human subjects or machines such as a texture analyzer.

The taste of a yogurt made by methods described herein may be comparable to a similar type of yogurt made using animal-derived dairy proteins. Taste of a yogurt may be tested using a trained panel of human subjects.

In some embodiments of the process for producing a food product, the process further comprises aging and/or maturing the curd composition to form a cheese composition. The curd composition may be further treated to create a cheese or cheese like product. In some cases, such as a mozzarella product, the curd may be heated and stretched or kneaded to texturize. In these and other embodiments, the curd composition or the texturized curd composition may be aged, such as for brie, camembert, feta, halloumi, gouda, edam, cheddar, manchego, swiss, colby, muenster, blue cheese or parmesan type cheese or any cheese-like product.

Cheese food products described herein may be pasta filata like cheese such as mozzarella cheese. Soft cheeses such as paneer, cream cheese or cottage cheese may also be formed using the methods described herein.

The present inventors have found that the process of the present invention is particularly amenable to the production of pasta filata type cheeses, as well as stretched-curd, pulled-curd and plastic-curd type cheeses, including akkawi, braided cheese, cacio figurato, caciocavallo, galbanino, halloumi, kashkaval, mozzarella, bocconcini, buffalo mozzarella, Oaxaca cheese, oscypek, oštiepok, pallone di gravina, palmito cheese, provolone, ragusano, queso de mano, scamorza, stracciata, stracciatella di bufala, string cheese, chechil, korbáčik, sulguni, and Vastedda della valle del Belice.

In some embodiments, the textured curd composition provided by step f) of the process of the present invention is a non-animal derived cheese product; preferably a non-animal derived mozzarella type cheese product.

The texture of a cheese made by methods described herein may be comparable to the texture of a similar type of cheese made using animal-derived or dairy derived proteins, such as cheese made from animal milk. Texture of a cheese may be tested using a trained panel of human subjects or machines such as a texture analyzer.

The taste of a cheese made by methods described herein may be comparable to a similar type of cheese made using animal-derived dairy proteins. Taste of a cheese may be tested using a trained panel of human subjects.

Cheese compositions described herein may have a browning ability which is comparable to a similar type of cheese made using animal-derived dairy proteins. Cheese compositions described herein may have a melting ability which is comparable to a similar type of cheese made using animal-derived dairy proteins.

### Emulsions and Curds Compositions Comprising Non-Animal Derived Proteins

The present invention provides an emulsified composition comprising one or more lipid and protein components, wherein the protein component has a protein content of at least 80% by weight protein, wherein about 25-40% by weight of the protein content comprises zein protein, the remainder being non-micellar casein.

Optionally, the protein component starting material can be in the form of a powder.

Optionally, the protein component starting material can also include non-protein components, but will typically comprise at least 80% protein (by weight), for example around 85% protein, for example around 90% protein.

The protein component will include non-micellar casein, such as β-casein, or sodium caseinate, and zein protein as the primary protein. That is the protein component may include about 40% (by weight) of caseinate/β-casein and about 40% (by weight) of zein protein in the protein fraction (i.e., of the total protein content of the protein component). Optionally the protein component is predominantly β-casein.

In the process of the invention the starting material, for example, β-casein is in a free form, i.e., is not in the form of a casein micelle. It is possible for the β-casein to be induced to form dimers or micelle-like assemblies consisting only of β-casein. The β-casein can be produced from the cold microfiltration of milk, for example bovine milk. Other milk sources can alternatively be used. Beta-casein can also be obtained using cold separation using a decanter centrifuge or separator (or any type of centrifuge). For this process the protein solution, suspension, dispersion or emulsion need to be cooled to a temperature below 10° C. and then acidified to precipitate the alpha-and-caseins, which can then be separated via centrifugation. Alternatively, the β-casein (or any of the casein proteins provided herein) can be produced by recombinant expression using techniques known in the art. Where cold microfiltration of milk is used to provide the β-casein, the resultant powder can include non-protein components, but will typically comprise at least 80 weight % protein, for example more than 82% protein, for example around 85% protein. The protein component will include β-casein and zein protein as the primary protein, that is the protein component will include at least 80% (by weight) of protein content, wherein around 25-40% (by weight) of the protein content is made up of zein protein, the remainder being β-casein.

The β-casein can conveniently be sourced from cow's milk. Other suitable sources include milk from other ungulates, such as sheep milk, goat milk, horse milk, camel milk, or buffalo milk.

The β-casein or any of the other individual casein proteins of the invention mentioned herein can also be produced through expression of its gene in a suitable recombinant construct using a suitable host expression system. The term “recombinant” is known by those of ordinary skill in the art. When referring to a nucleic acid (e.g., a gene), the term “recombinant” can be used to describe a nucleic acid that has been removed from its natural context, a nucleic acid that is not associated with all or a portion of a nucleic acid abutting or proximal to the nucleic acid when it is found in nature, a nucleic acid that is operatively linked to a nucleic acid which it is not linked to in nature, or a nucleic acid that does not occur in nature. The term “recombinant” can be used to describe cloned DNA isolates, or a nucleic acid including a chemically synthesized nucleotide analogue. When “recombinant” is used to describe a protein, e.g., recombinant β-casein or recombinant κ-casein, it can refer to, e.g., a protein that is produced in a cell of a different species or type, as compared to the species or type of cell that produces the protein in nature, e.g., by use of a “recombinant” nucleic acid.

Three different methods of hydration of zein were performed by the inventors: Hydration at alkaline pH, Enzymatic hydrolysis of zein, Incorporation of the zein in the emulsion using high shear. All three different methods of hydration lead to stretchy and meltable cheese in a zein-caseinate system.

Thus the present invention further provides a process of forming an emulsified composition according to the invention, wherein said process comprises the steps of:
i) Preparing a mixture of a non-micellar casein and zein protein;
ii) Adding one or more lipid;
iii) Homogenising the mixture to obtain the emulsified composition.

In the process of the present invention, the zein protein component may be first dissolved in an alkaline aqueous solution. The pH of the aqueous solution may be in the range of pH 11.3 to 12.7, for example pH 12.5. Alternatively, the pH range may be at least pH 12.0.

Dissolution of the zein to form an aqueous solution can be conducted at a temperature of 5-50° C. and ambient pressure. For convenience room temperature (20-25° C.) is generally used.

Thus, the present invention preferably provides a process of forming an emulsified composition according to the invention, wherein said process comprises the steps of:
i) Preparing an aqueous solution of zein protein at alkaline pH;
ii) Adding the non-micellar casein;
ii) Adding one or more lipid and optionally sugar;
iii) Homogenising the mixture to obtain the emulsified composition

The mixture of a non-micellar casein and zein protein in step (i) of the process of the invention may be prepared as follows:

(1) i) Preparing a mixture of an aqueous solution of a zein protein at alkaline pH and non-micellar casein;
ii) Reducing the pH of the solution to neutral (about pH 7.0).

The dissolution steps (i) and (ii) can be conducted room temperature and ambient pressure.

The mixture of a non-micellar casein and zein protein in step (i) of the process of the invention may alternatively be prepared as follows:
i) Preparing an aqueous solution of zein protein at alkaline pH;
ii) Enzymatic hydrolysis of the zein protein at pH 9.0;
iii) Adding the non-micellar casein to the zein protein solution at pH 7.0.

The enzyme hydrolysis step can be conducted at a temperature of about 50° C. and ambient pressure. The enzymatic hydrolysis can be performed with different enzymes and the process condition depends on the enzyme. For example, Alcalase (2.4 L FG) may be used at pH 8.0-9.0, 50° C.-60° C.

The mixture of a non-micellar casein and zein protein in step (i) of the process of the invention may be prepared by dissolving the zein protein in an alkaline aqueous solution as described above followed by addition of the non-micellar casein component. The pH is then reduced to neutral typically about pH 7.0 by acidification.

In an alternative process of forming an emulsified composition according to the invention, the process comprises the steps of:
i) Preparing an aqueous solution of the non-micellar casein;
ii) Adding one or more lipid;
iii) Emulsifying the mixture and zein protein to obtain the emulsified composition.

The emulsification step takes place by high shear method sufficient to incorporate the zein into the emulsion. This mechanical energy can be introduced by a “common” high speed mixer using a rotor-stator-system or high-pressure valves or sonication (ultrasound). For high shear the range may be between 3000-25000 rpm (approx. 50-420 rotation per second). Ultra turrax, a rotor-stator dispersing unit aka high shear mixer, may be used.

The process may include step (iv) involving homogenising the mixture obtained from step (iii). Thus, the claimed process may comprise the steps of:
i) Preparing an aqueous solution of the non-micellar casein;
ii) Adding one or more lipid and optionally sugar;
iii) Emulsifying the mixture and zein protein to obtain the emulsified composition by high shear to incorporate the zein into the emulsion;
iv) Homogenising the mixture obtained from step (iii).

The hydration of the non-micellar casein in (i) typically takes place at neutral pH and room temperature.

In the process of the present invention, the protein component, typically β-casein and zein, may be first dissolved in an aqueous solution. A solution containing up to 10% (by weight), typically up to 2% by wt, of protein component can be prepared. Optionally a salt able to form a soluble calcium salt can also be included, for example sodium citrate, to facilitate dissolution of the protein component. For example, a 10% solution of protein component (β-casein and zein) can be prepared by addition of 10 g β-casein/zein in 90 g water, optionally with the addition of 0.15 g tri-sodium citrate. For example, a concentration of 0.05 to 0.055 mmol citrate per g β-casein/zein can be used. The dissolution step can be conducted at cold temperatures (for example at about 5° C.) or may be conducted at warmer temperatures, for example at temperatures up to approximately 50° C. However, at higher protein concentrations the β-casein will agglomerate at temperatures above 50° C.

Optionally, the dissolution step is conducted at ambient pressure.

Dissolution of the β-casein to form an aqueous solution can be conducted at a temperature of 5-50° C. and ambient pressure. For convenience room temperature (20-25° C.) can optionally be used. However lower temperatures (below 10° C.) can be beneficial to solvate higher protein concentrations.

The process of the present invention then requires the addition of a fat, and optionally sugar, to the beta-casein/zein solution followed by an emulsification step. Optionally, the fat can be an oil at the temperature of the process. Vegetable oil and butter are suitable fats. Suitable vegetable oils include rapeseed oil and sunflower oil, but other vegetable or nut oils can also be used. The fat can be a blend of such oils and/or can be a mixture of oil(s) together with butter. The fat can be added at a ratio of from 3:1 to 1:3 relative to the weight of the protein, for example a 1:1 fat to protein ratio. After combination, the admixture so formed can be emulsified by any suitable means, for example by simple dispersion, or high-speed stirring and/or by homogenisation. Optionally, the emulsification step occurs at a temperature of from 5° C. to 60° C., for example from 30 to 60° C., for example from 45 to 55° C. A temperature of around 50° C. can be suitable. Alternatively, a cooler temperature of from 5° C. to 25° C. can be used. Optionally emulsification step is conducted at a pressure of at least 2,000 kPa (20 bar), for example at a pressure of from 5,000 kPa (50 bar) to 45,000 kPa (450 bar).

The emulsification process can be conducted in a two-stage process using a first higher pressure (for example 20,000 kPa (200 bar), followed by a second lower pressure (for example 5,000 kPa (50 bar). The temperature can be of from 5° C. to 25° C., for example 20° C.

In a further aspect, the present invention provides a process of forming a fibrous or “pasta filata” style cheese product, wherein said process comprises preparing an emulsified composition according to the invention, and forming a treated emulsion by:
i) acidifying the emulsion, and/or
ii) the addition of a calcium salt, for example CaCl₂).

Where the treated emulsion is formed using the addition of a calcium salt, such as CaCl₂, then optionally the emulsion is also treated with alkali to adjust the pH to be at least 6, for example at least pH 7, for example pH7.5 or higher.

Optionally, the temperature of the emulsion can also be changed (lowered) during formation of the treated emulsion, in order to promote gel formation. Optionally, the temperature will be reduced to 10° C. or less than 10° C.

In the treated emulsion gel formation can occur, which can lead to a coagulated product. The coagulated product can then be subjected to traditional pasta filata cheese making steps.

The emulsion can be used to form a fibrous content cheese product, such as a mozzarella-style cheese product, through the formation of a gel. The gel formation is induced by acidification and/or the addition of a calcium salt such as CaCl₂). Alternatively, where the protein source is caseinate/zein, coagulation may be induced by chymosin.

Optionally, gel formation is induced by the addition of a calcium salt (CaCl₂)) with alkalization. Any food grade agent can be used to raise the pH as required. Examples include sodium hydroxide, potassium hydroxide etc.

One option of inducing gel formation is by acidification. Typically, a pH of 4.0 to 8.0, for example a pH of 5.0 to 6.0, for example a pH of 5.0 to 5.5, is obtained for this step. Optionally, the pH of the emulsion is about 7.3 and can be between 6.5 and 7.5, depending on protein, citrate and salt concentration. Optionally the emulsion is chilled prior to acidification, for example to a temperature of 0-20° C., for example to 5-10° C. The cooling step can be conducted over a period of a few minutes, for example around 10 minutes. The exact time taken for cooling the emulsified mixture is not particularly critical.

Any suitable food grade acid can be used to achieve the required pH, for example hydrogen chloride, lactic acid, citric acid, acetic acid, D-(+)-glucono-delta-lactone (“GDL”) or any combination thereof. Optionally starter cultures can be used to create the pH reduction by fermentation. Thermophilic and/or mesophilic lactic acid bacteria suitable for the production of yoghurt or cheese are well-known in the art and can be used, like Lactococcus lactis or Streptococcus salivarius. Where fermentation is used to reduce the pH, it is possible to add a sugar (for example up to 2-5% by weight relative to the mixture) and to use a temperature from ambient to around 37° C. for the fermentation step. Where acids are added to reduce the pH, preferably the acids used are citric acid and/or lactic acid. A pH below 5 may reduce the moisture content of the cheese product.

A suitable calcium salt is calcium chloride, but any soluble calcium salt suitable for use in food production can be used. The calcium ions will become bound by the protein so that the reference to “free calcium” refers to the availability of calcium ions to the composition, which will depend upon the solubility of the calcium salt selected and on the calcium to protein ratio. Preferably the calcium salt is calcium chloride, calcium hydroxide, calcium carbonate, calcium citrate, calcium phosphate, stearate malate, calcium glycerophosphate, calcium lactate, calcium gluconate or mixtures thereof. In a particular preferred embodiment of the invention the calcium salt is calcium chloride.

A further option is to use both acidification and the addition of a calcium salt to induce gel formation. Optionally the acidification of the emulsion occurs first then the calcium salt is added to the emulsion. Or optionally a calcium salt is first added to the emulsion and then the emulsion is acidified.

Once the gel has formed, the usual processing steps for a traditional Mozzarella-style cheese can be followed. Typically, these steps include the cutting of the curd, a period of repeatedly stirring the cut curd, allowing removal of whey by drainage, plasticization and forming of the cheese, cooling the cheese in a solution at a temperature below 15° C. and thereafter storage at a refrigerated temperature in a storage solution (for example 5° C.).

In more detail, following induction of coagulation due to the addition of the calcium salt/reduction of pH, the coagulated product (curd) can be incubated as described above, and optionally cut and repeatedly stirred during the second half of the incubation period. Thereafter, the whey can be drained from the curd in a manner analogous to the whey drainage step in the formation of a traditional Mozzarella-style cheese. Typically, the curd can be placed in a sieve or cloth and the whey allowed to drain for a period of 5 to 60 minutes, for example 5 to 45 minutes. Once the whey has been drained from the curd, the curd can be plasticized pr texturized and formed at a temperature of around 60 to 80° C. for a period of up to 5 minutes, for example 1 to 3 minutes. A temperature above 80° C. results in a sticky curd, whereas a temperature below 60° C. restricts the ability of the curd to stretch. The curd can be texturized in a liquid comprising water (such as water or whey). Conveniently, a ratio of curd: water of from 1:1 to 1:10 (by weight) can be used. The stretching liquid can optionally include up to 5% (by weight) of a calcium salt (such as calcium chloride) or a sodium salt, (such as sodium chloride). Thereafter the cheese can be cooled to a temperature below 15° C. and stored in a refrigerator (for example at a temperature of around 5° C.). Optionally, the cheese can be stored in a storage solution, which is usually an aqueous solution. For example, water can be used to form the storage solution. A suitable storage solution includes, for example, 5 to 25% (by weight) sodium chloride and/or 0.1 to 1% or more calcium chloride and/or 0.2% (by weight) lactic acid.

FIG. 2.3 shows a cheese according to the invention at different stages of its processing and after melting (d).

As discussed above, optionally the pH of the emulsion can be increased (alkalized) in addition to addition of the calcium salt.

Excess kneading of the product during the forming step should be avoided as this can decrease the moisture content of the final product.

The process can be conducted at standard atmospheric pressure, thereby avoiding any expensive pressurization steps.

### Transglutaminase Treatment

The present invention provides a process of forming a cheese product, wherein said process comprises the step of treating dephosphorylated casein or caseinate with a transglutaminase enzyme.

The cheese product formed can be a pasta filata style cheese product.

The cheese product formed can be a cheese product, for example can be a high moisture cheese product.

A “pasta filata-style” cheese product refers to a cheese which is stretched or pulled as a curd, usually after the curd has been steeped in hot water. Stretching or pulling the curd creates a fibrous structure in the cheese.

In the present invention, the term “high moisture content cheese product” denotes any cheese food product having a moisture content of over 60% by weight. Moisture content can be determined with infrared dryers (for example: MA 30, Sartorius). For example, 3.00±0.05 g of grated pasta filata-style cheese can be weighed in an aluminium dish and heated with infrared to a temperature of 105° C. until a constant weight was reached. The moisture loss can then be determined.

In the process of the invention the starting material casein or caseinate used to form the emulsion is dephosphorylated, that is the casein starting material lacks the usual level of phosphorylation as present in mammalian produced casein. The casein protein will generally be in a free form, i.e., is not in the form of a micelle-like assembly. The casein can be in the form of a salt (i.e., a caseinate) or the casein proteins can be in solution as free casein proteins. Examples of suitable caseins are caseinates and single casein fractions. Generally, the dephosphorylated casein or caseinate will be produced recombinantly, using genetic engineering. Alternatively, the dephosphorylated casein or caseinate can be produced using enzymes to remove the phosphate groups, for example using alkaline phosphatase. Optionally, the dephosphorylated casein or caseinate starting material has no more than 50%, for example no more than 40%, for example no more than 30%, for example no more than 20%, for example no more than 10%, for example no more than 5%, for example no more than 3% of the phosphoryl groups as compared to the native casein protein.

The dephosphorylated or non-phosphorylated casein can be a caseinate such as sodium caseinate, a potassium caseinate, a calcium caseinate or a mixture of any of these. Optionally, the caseinate is sodium caseinate. The dephosphorylated or non-phosphorylated casein or caseinate can be a mixture of casein or caseinates, for example can include a combination of the four different casein proteins: αₛ₁-casein, αₛ₂-casein, β-casein and κ-casein, optionally present in the naturally occurring molar ratio of about 4:1:4:1.

As noted above, the dephosphorylated or non-phosphorylated casein can be used in the form of a salt (caseinate) or as single casein proteins in solution. The dephosphorylated casein will not be in the form of a micelle-like assembly. Examples of suitable caseins are caseinates and single casein fractions. Generally, the casein will comprise a mixture of more than one casein protein type. For example, the casein can comprise two or more of αₛ₁-casein, αₛ₂-casein, β-casein and κ-casein, optionally the casein can comprise three or more of αₛ₁-casein, αₛ₂-casein, β-casein and κ-casein, casein can comprise casein, αₛ₂-casein, β-casein and κ-casein.

Whilst recombinantly produced or non-phosphorylated casein or caseinate is envisaged to be the main source of the starting material, the dephosphorylated or non-phosphorylated casein or caseinate can alternatively be derived from mammalian milk. Suitable sources include milk from ungulates, such as cow's milk, sheep milk, goat milk, horse milk, camel milk or buffalo milk. The casein can optionally be present as a sodium caseinate. The casein can be sodium κ-caseinate.

Optionally no milk proteins other than dephosphorylated or non-phosphorylated casein (or caseinate) are used in the process.

The dephosphorylated or non-phosphorylated casein/caseinate solution used as a starting material can have a protein content of 1 to 300 g/L, for example 10 to 200 g/L, for example 50 to 60 g/L. A suitable casein/caseinate solution can have 5% (by weight) of dephosphorylated casein/caseinate.

The dephosphorylated or non-phosphorylated casein or caseinate solution starting material is desirably formed using conditions which ensure that the casein or caseinates are fully hydrated. For example, the solution can be heated to a temperature of 50° C. for around 30 minutes to one hour with stirring.

The transglutaminase enzyme is added to the casein/caseinate solution to induce protein polymerization. The temperature used for incubation is generally below 37° C. to avoid denaturation of the enzyme, which would reduce activity. However, a higher temperature can cause partial unfolding of the substrate protein and increase the substrate sites available to the transglutaminase. Temperatures above 37° C. may therefore be of utility, for example temperatures of 40 to 50° C. One skilled in the art would be able to determine suitable incubation times and temperature. One example is an incubation period of up to 60 minutes, for example 20 to 40 minutes at a suitable incubation temperature, for example a temperature of above 30° C., or even higher temperatures such as 50° C.

The transglutaminase enzyme can conveniently be added at a concentration of at least 0.5 U/g protein. For example, a concentration of 1 U/g protein, for example 2 U/g protein, for example 3 U/g protein, for example 4 U/g protein, for example 5 U/g protein can be used. Higher concentrations of enzyme may be appropriate where a reduced incubation period is required. The length of incubation can be several hours (for example overnight). Additionally, the temperature used for the incubation period will affect the length of incubation and the amount of enzyme required. For example, incubation overnight at 4° C. can be used. For example, incubation for 60 minutes at a temperature of 50° C. can alternatively be used, for example using a transglutaminase enzyme concentration of at least 0.5 U/g protein. All that is required is to achieve a suitable level of degree of polymerization of the protein starting material, and this can be readily determined by one skilled in the art.

Once the polymerization step has been conducted, the transglutaminase enzyme is denatured, for example by heating. An exemplary process to denature the enzyme is to heat the polymerized mixture to 80° C. or above for a few minutes.

The polymerized protein mixture is then combined with an oil or fat (for example a vegetable oil or fat) and processed into an emulsion, for example using high speed mixing. Optionally, the emulsification process is conducted at ambient pressure in combination with high-shear mixing. Optionally the emulsification step is conducted at an increased pressure, i.e., a pressure above ambient. Optionally, the emulsification step is conducted at a temperature between ambient and 60° C.

The process of the present invention requires the addition of a fat to the polymerized casein solution followed by an emulsification step. Optionally, the fat can be an oil at the temperature of the process. Vegetable oil and butter are suitable fats. Suitable vegetable oils include rapeseed oil, but other vegetable or nut oils can also be used. The fat can be a blend of such oils and/or can be a mixture of oil(s) together with butter. A suitable quantity of fat would provide a ratio of protein: fat of 3:1 to 1:3. A preferred ratio would be 2:1 to 1:2. After combination, the admixture so formed can be emulsified by any suitable means, for example by high-speed stirring and/or by homogenisation. Optionally, the emulsification step occurs at a temperature of ambient to 60° C., for example from 30 to 60° C., for example from 45 to 55° C. A temperature of around 50° C. can be suitable. Alternatively, a cooler temperature of from 5° C. to 25° C. can be used. Optionally emulsification step is conducted at a pressure of at least 5,000 kPa (50 bar), for example at a pressure of from 5,000 kPa (50 bar) to 45,000 kPa (450 bar).

Optionally, the emulsification process is conducted at ambient pressure in combination with high-shear mixing. Optionally the emulsification step is conducted at an increased pressure, i.e., a pressure above ambient. For example, the pressure used can be more than 1,000 kPa, for example more than 2,000 kPa. Optionally, at least part of the emulsification process is conducted at a pressure of 3,000 to 7,000 kPa, for example 4,000 to 6,000 kPa. Optionally, the pressure is around 5,000 kPa. Optionally, at least part of the emulsification process is conducted at a temperature between ambient and 60° C.

Optionally, the emulsification process can be conducted in a two-stage process with a first step carried out using a first higher pressure of more than 10,000 kPa (for example 20,000 kPa (200 bar)), followed by a second step conducted at a lower pressure of around 3,000 to 7,000 kPa (for example 5,000 kPa (50 bar)). The temperature can be of from 5° C. to 25° C., for example 20° C.

The emulsion can be used to form a cheese product, such as a fibrous cheese product, for example a mozzarella-style cheese product, by use of chymosin or acid to create a gel. An alternative to acid is to use D-(+)-Glucono-delta-lactone or a bacterial culture which produces an acid by fermentation. Optionally, the chymosin can be added in the form of rennet. Optionally the temperature for the addition of chymosin can be from ambient to around 40° C., for example can be from 25° C. to 40° C., for example can be from 30° C. to 40° C., for example can be from 34 to 37° C. A temperature of around 35° C. can conveniently be used. Typically, the chymosin will be added together with stirring to ensure that the admixture is homogenous. Optionally at least 2 IMCU (International Milk Clotting Units) chymosin per 100 mL emulsion is added, for example from 2 to 10 IMCU chymosin per 100 mL emulsion. As an example, 5 IMCU chymosin per 100 mL emulsion can be used.

Following addition of the chymosin, the admixture can be incubated for a period of from 5 to 30 minutes, for example from 10 to 20 minutes, typically around 15 minutes to allow gel formation. As noted above, the temperature of the mixture during the period of incubation can be from 25° C. to 40° C., for example can be from 30° C. to 40° C., for example can be from 34° C. to 37° C. A temperature of around 35° C. can conveniently be used during incubation.

Once the gel has formed, the usual processing steps for a traditional pasta filata-style cheese can be followed. Typically, these steps include the cutting of the curd, a period of repeatedly stirring the cut curd, allowing removal of whey by drainage, plasticization and forming of the cheese, cooling the cheese in a solution at a temperature below 15° C. and thereafter storage at a refrigerated temperature in a storage solution (for example 5° C.).

In more detail, following induction of coagulation due to the addition of chymosin, the coagulated product (curd) can be incubated as described above, cut and repeatedly stirred during the second half of the incubation period. Thereafter, the whey can be drained from the curd in a manner analogous to the whey drainage step in the formation of a traditional mozzarella style cheese. Typically, the curd can be placed in a sieve and the whey allowed to drain for a period of 10 to 20 minutes. Once the whey has been drained from the curd, the curd can be plasticized and formed at a temperature of around 60 to 80° C. for a period of up to 5 minutes, for example 1 to 3 minutes. The curd can be texturized in a liquid comprising water (such as water or whey). Conveniently, a ratio of curd: water of from 1:1 to 1:2 (by weight) can be used. Thereafter the cheese can be cooled to a temperature below 15° C. and stored in a refrigerator (for example at a temperature of around 5° C.). Optionally, the cheese can be stored in a storage solution, which is usually an aqueous solution. For example, water can be used to form the storage solution. A suitable storage solution includes, for example, 5 to 25% (by weight) sodium chloride and/or 0.2% (by weight) lactic acid.

Optionally, the process of the present invention comprises admixing non-phosphorylated casein or caseinate with a transglutaminase to form a polymerized protein mixture. Fat is then added to the polymerized protein mixture and an emulsion is formed. The emulsion can be induced to gel by the addition of chymosin or by acidification. The gel can then be treated by at least one of the following processing steps:
a) incubation of the admixture, optionally with regular cutting; and/or
b) whey drainage; and/or
c) plasticization and forming to produce a cheese product; and/or
d) cooling the cheese product.

Excess kneading of the product during the forming step should be avoided as this can decrease the moisture content of the final product.

The process of the present invention can also include one of more of the following additional steps:
i) a cooling step after emulsification and prior to addition of chymosin. Following emulsification, the emulsion can be cooled to below ambient temperature, for example to 10° C. or below, for example 4 to 8° C., for example around 5° C.
ii) Addition of a salt such as a calcium salt after emulsification (and optionally prior to acidification or addition of chymosin). Typically, the calcium salt will be water soluble, for example can conveniently be calcium chloride. Optionally sodium chloride can additionally or alternatively be added, for example 1 to 2% by weight of sodium chloride. Optionally, a polyphosphate salt, such as a sodium polyphosphate salt can alternatively or additionally be added, for example in an amount of 0.3% by weight.
iii) An acidification step after emulsification (and optionally after or concomitant with the addition of the calcium salt step, if present). Typically, a pH of 5.0 to 6.0, for example a pH of 5.2 to 5.8, for example a pH of around 5.6 is obtained.

Thus, optional step i) is a cooling step immediately after emulsification. Following emulsification, the emulsion can be cooled to below ambient temperature, for example to 5 to 15° C. for a period of a few minutes, for example up to 10 minutes.

In an optional step iii), the pH of the emulsion is reduced. Optionally, the pH of the emulsification is reduced to a pH of 5.0 to 6.0, for example to a pH of 5.2 to 5.8. The acidification step, if present, will occur after emulsification and after the cooling step, if present. Optionally, the step of acidification can occur at a temperature below ambient, for example from 5 to 15° C. Any suitable food grade acid can be used to achieve the required pH, for example hydrogen chloride, lactic acid, citric acid, acetic acid, D-(+)-Glucono-delta-lactone or any combination thereof.

Optionally starter cultures can be used to create the pH reduction by fermentation. Thermophilic and/or mesophilic lactic acid bacteria suitable for the production of yoghurt or cheese are well-known in the art and can be used, like Lactococcus lactis or Streptococcus salivarius. Optionally, sugar or other nutrients for the bacteria can be added, for example up to 2% by weight of sugar. Where bacteria are used to cause acidification, the temperature of the emulsion is modified to a suitable temperature to promote fermentation, for example is modified to around 37° C. to 40° C. Preferably the acids used for addition are citric acid and/or lactic acid. A pH below 5 may reduce the moisture content of the cheese product. Optionally the acidification step can be conducted at a temperature of from 5 to 15° C., for example 8 to 12° C. Alternatively, the acidification step can occur at the same time as cooling.

In optional step ii) a salt can be added. A suitable salt can be a calcium salt, sodium chloride and/or a polyphosphate salt. A suitable calcium salt is calcium chloride, but any soluble calcium salt suitable for use in food production can be used. The calcium ions will become bound by the protein so that the reference to “free calcium” refers to the availability of calcium ions to the composition, which will depend upon the solubility of the calcium salt selected. Preferably the calcium salt is calcium chloride, calcium hydroxide, calcium carbonate, calcium citrate, calcium phosphate, stearate malate, calcium glycerophosphate, calcium lactate, calcium gluconate or mixtures thereof. In a particular preferred embodiment of the invention the calcium salt is calcium chloride.

Optionally, the calcium salt is added to said emulsion in an amount of 0.2 to 2 mM/g protein.

Optionally, sodium chloride is added in an amount of 1 to 2% by weight of emulsion.

Optionally a polyphosphate (such as sodium polyphosphate) is added in an amount of 0.3% by weight of the emulsion.

Optionally, the process of the invention comprises admixing non-phosphorylated casein or caseinate with a transglutaminase enzyme to form a polymerized protein, adding a fat to the polymerized protein and forming an emulsion, followed by at least one of the following steps to form a treated emulsion:
i) cooling of the emulsion to a temperature of below 10° C.; and/or
ii) addition of a calcium salt to the emulsion, and/or
iii) adjusting the pH of the emulsion of said emulsion to a pH of 5 to 6 or adding chymosin to the emulsion.

Optionally, the process of the present invention comprises admixing non-phosphorylated casein or caseinate with a transglutaminase enzyme to form a polymerized protein, adding a fat to the polymerized protein and forming an emulsion, followed by addition of chymosin and/or acid to the emulsion to form an admixture, and further comprising at least one of the following processing steps:
a) incubation of the admixture, optionally with regular cutting; and/or
b) whey drainage; and/or
c) plasticization and forming to produce a cheese product; and/or
d) cooling the cheese product.

Excess kneading of the product during the forming step should be avoided as this can decrease the moisture content of the final product.

In the present invention, the term “high moisture content cheese product” denotes any cheese food product having a moisture content of over 60% by weight. Moisture content can be determined with infrared dryers (MA 30, Sartorius). For example, a specified quantity of grated pasta filata cheese can be weighted in an aluminium dish and heated with infrared to a temperature of 105° C. until a constant weight was reached, and the moisture content calculated from the weight lost.

The process can be conducted at standard atmospheric pressure, thereby avoiding any expensive pressurization steps.

In a further aspect, the present invention provides a pasta filata-style (for example a mozzarella-style) cheese product formed using the process as described above. Since dephosphorylated casein/caseinate is used to form the pasta filata-style (for example mozzarella-style) cheese product, the cheese product is formed using dephosphorylated casein/caseinate proteins in contrast to a traditional mozzarella cheese where only the casein is present in a phosphorylated form.

Thus, the present invention provides a pasta filata-style (for example mozzarella-style) cheese product formed using dephosphorylated αₛ₁-casein, αₛ₂-casein, β-casein and/or κ-casein.

Preferred or alternative features of each aspect or embodiment of the invention apply mutatis mutandis to each other aspect or embodiment of the invention (unless the context demands otherwise).

### EXAMPLES

### Materials

Bovine sodium caseinate (Lactonat EN, 90.2% protein, of which 41% αₛ-caseins, 42% β-casein, and 17% κ-casein) was kindly donated by Lactoprot (Lactoprot Deutschland GmbH, Kaltenkirchen, Germany).

Tris(hydroxymethyl)aminomethane (Tris; 252859), alkaline phosphatase from bovine intestinal mucosa (P7640), calcium chloride (C1016), magnesium chloride (M8266), potassium phosphate monobasic (P5379), sodium phosphate dibasic (S7907), citric acid (C0759), potassium hydroxide (1.05033), sodium hydroxide (221465), potassium chloride (1.04936), potassium carbonate (1.04928), potassium sulfate (1.05153), trisodium citrate dihydrate (S4641), magnesium citrate tribasic nonahydrate (63067), bovine α-casein (C6780), bovine β-casein (C6905), bovine κ-casein (C0406), hydrochloric acid (1.13386), nitric acid (1.00456), hydrogen peroxide (1.07209), calcium standard (1.19778), phosphorus standard (1.70340), magnesium standard (1.70331), sodium standard (1.70353), potassium standard (1.70230), sodium chloride (31434), sodium phosphate dibasic dihydrate (1.06580), citric acid monohydrate (1.00244), ethanol absolute (1.00983), guanidine hydrochloride (50950), L-dithiothreitol (D9760), and lactic acid solution (252476) were all purchased from Sigma-Aldrich (Merck KGaA, Darmstadt, Germany).

Osmium tetroxide (19134), 50% glutaraldehyde solution (16316-10), and carbon adhesive tabs (77825-12) were purchased from ESM (Electron Microscopy Sciences, Hatfield, PA, USA). Hydrochloric acid solution (7647-01-0) and acetonitrile ULC-MS (75-05-8) were purchased from Actu-All (Actu-All Chemicals B.V., Oss, Netherlands).

Tripotassium citrate monohydrate (6100-05-6) was purchased from VWR (VWR International bvba, Leuven, Belgium). Trifluoroacetic acid (44630) was purchased from Alfa Aesar (Thermo Fisher Scientific, Kandel, Germany). Recombinantly produced chymosin (CHY-MAX Plus, batch no. 3634543) was obtained from Chr. Hansen Holding A/S (Hørsholm, Denmark). Ultrapure water (MilliQ system, Merck KGaA, Darmstadt, Germany) was used for all experiments.

### Purification and Isolation of β-Casein and κ-Casein

Bovine β-casein and κ-casein were purified and isolated from Bovine sodium caseinate in accordance with the methods and procedures described in Schubert et al (2018).¹

### Example 1.1: Preparation of Artificial Casein Micelles

Artificial casein micelles (“ACMs”) were prepared via modifications to the methods according to Schmidt et al. (1977).² Various ratios of β-casein and κ-casein (b:k; 70:30, 75:25, 80:20, 85:15 and 95:5) were dissolved in water with 22.5 mM sodium citrate to a total protein concentration of 64.1 g L⁻¹ by stirring at 60° C. for 30 minutes. Two salt solutions were prepared: solution I contained 325 mM CaCl₂) and 61.2 mM MgCl₂ adjusted to pH 6.70 with 0.1M HCl and solution II contained 155 mM KH₂PO₄ and 155 mM Na₂HPO₄. The caseinate solution (60 mL) and the salt solutions (10 mL each) were carefully pumped into a jacketed glass vessel at 37° C. containing a starting volume of 66 mL water in 60 minutes to reach final concentrations of 30 mM calcium, 22 mM phosphate, 9 mM citrate, 5 mM magnesium, and 25.6 g L⁻¹ casein. The solution was continuously and vigorously stirred using a magnetic stirrer.

Controlled addition of the solutions was achieved by using syringe pumps (Harvard PHD2000, Harvard Apparatus, Holliston, MA, USA and ProSense NE-1600, ProSense B.V., Oosterhout, Netherlands). The pH was maintained at pH 6.70 with 1M NaOH by titration (877 Titrino Plus, Metrohm AG, Barendrecht, Netherlands) and the titration was continued for 20 minutes after reaching the required composition of the micelles to equilibrate the pH. In a typical experiment, approximately 3 mL 1M NaOH was used. The total volume of the solutions was brought to 150 mL with water. All samples were prepared in triplicate.

### Example 2.1: Particle Size Analysis

The hydrodynamic diameter and polydispersity of casein micelles were analysed with a He—Ne laser at a wavelength of 633 nm using a Malvern Zetasizer Ultra (Malvern Panalytical Ltd, Worcestershire, UK). Samples were diluted 100-fold in simulated milk ultrafiltrate prepared according to Jenness and Koops (1962)³ with the modifications proposed by Dumpler et al. (2017)⁴ in a DTS0012 cell and measured at 25° C. and a fixed scattering angle of 173°. The refractive index of the dispersant was set at 1.33, its viscosity at 0.8872 mPa·s, and the refractive index of the casein micelles to 1.57 (Griffin & Griffin, 1985).⁵ For each sample, duplicate measurements were performed, each consisting of 5 sub-measurements.

Dynamic light scattering results, comparing the size (Z-average diameter nm; intensity weighted mean hydrodynamic size, as defined in ISO 13321) of ‘normal’ artificial casein micelles (ACM) produced from bovine sodium caseinate and ACM produced from only isolated bovine β-casein and bovine κ-casein fractions in accordance with the present invention are presented in Table 1 below, and demonstrate that both the diameter and polydispersity indices are comparable.

TABLE 1
Dynamic light scattering result showing the diameter (nm)
of ACM prepared from bovine caseinate (with all four caseins)
and ACM prepared with only ß-casein and
K-casein in accordance with the present invention.

| | Diameter (nm) | Polydispersity Index (−) |
|---|---|---|
| ACM from | 194.8 ± 4.5 | 0.23 ± 0.02 |
| bovine caseinate | | |
| ACM B:K 70:30 | 126.6 ± 1.8 | 0.20 ± 0.01 |
| ACM B:K 75:25 | 152.8 ± 3.7 | 0.19 ± 0.01 |
| ACM B:K 80:20 | 171.2 ± 4.9 | 0.18 ± 0.01 |
| ACM B:K 85:15 | 279.7 ± 6.0 | 0.26 ± 0.01 |

Data presented in FIG. 2.1 shows that micelle particles were obtained in the size range of natural bovine casein micelles (50-400 nm with an average of 200 nm; De Kruif (1998)⁶) and that the size of the particles increases with increasing β-casein levels (thus decreasing κ-casein levels). Observed number average diameters of the micelles in the micellar solutions of the invention range from approximately 125 nm at higher proportions of κ-casein, to approximately 280 nm at higher proportions of β-casein (FIG. 2.1).

### Example 3.1: Scanning Electron Microscopy

Micelle morphology was investigated with scanning electron microscopy (SEM) by using a Magellan 400 microscope (FEI Company, Hillsboro, OR, USA). One drop of sample was pipetted onto 12 mm poly-L-lysine glass slides (Corning Inc., Corning, NY, USA) and left to adhere for 30 minutes. Subsequently, the glass slides were washed twice with a 0.1M phosphate/citrate buffer at pH 7.2 and fixated with 2.5% glutaraldehyde for one hour after removal of the buffer. Afterwards, the fixative was removed and the glass slides were washed six times with phosphate/citrate buffer. Samples were then fixated with a 1% osmium tetroxide solution for one hour. The fixative was removed again and the slides were washed thrice with water and dehydrated using a graded ethanol series (5 minutes 30%, 5 minutes 50%, 5 minutes 70%, 5 minutes 80%, 5 minutes 90%, 5 minutes 96%, 10 minutes 100%, and another 10 minutes 100% EtOH).

Subsequently, the samples were critical point dried with CO₂ using a Leica EM CPD 300 (Leica Biosystems GmbH, Nussloch, Germany). The sputter coated slides were affixed to an aluminium specimen stub using carbon adhesive tabs. Mounted specimens were coated with a 12 nm tungsten layer in a Leica EM SCD 500 sputter coater. Images were taken at 100,000× magnification.

SEM images provide evidence of the presence of spherical micelles in the micellar solutions of the present invention. FIG. 3.1 shows a distribution of micelle sizes that are mostly smaller for higher proportions of κ-casein [FIG. 3.1(1) ACM b:k 70:30, FIG. 3.1 (2) ACM b:k 75:25, FIG. 3.1 (3) ACM b:k 80:20], and that larger micelles are observed where higher proportions of β-casein are present [FIG. 3.1(4) ACM b:k 85:15], confirming the dynamic light scattering results presented above. For comparison, FIG. 4.1 provides an SEM image of bovine skim milk, with a scale bar of the same size as FIG. 3.1. Micelles present in the micellar solution of FIG. 3.1(4) are comparable in size to those of bovine skim milk observed in FIG. 4.1.

### Example 4.1: Ultracentrifugation

Approximately 17 mL sample was equilibrated at room temperature for 1 hour before ultracentrifugation at 100,000×g and 20° C. for 1 hour in a Beckman Coulter Optima XE-90 ultracentrifuge (Beckman Coulter Inc., Woerden, Netherlands) equipped with a 70Ti rotor. All samples were centrifuged in duplicate. About half of each supernatant was collected and the supernatants of corresponding samples were combined.

### Example 5.1: Analysis of Mineral Partitioning

The content of cations (calcium, phosphorus, magnesium, sodium, and potassium) in samples and their supernatants were analysed. 0.5 mL sample was mixed with aqua regia and H₂O₂. The digested material was diluted approximately 200-fold with water. Samples were prepared in duplicate. Analysis was performed by inductively coupled plasma optical emission spectrometry (ICP-OES) by using an Avio 500 ICP-OES system (Perkin Elmer Nederland B.V., Groningen, Netherlands).

The content of anions (chloride, phosphate, and citrate) in samples and their supernatants was analysed by ion chromatography (IC) on a Dionex ICS-6000 liquid chromatography system equipped with a 2 mm standard bore Dionex IonPac AS17-C column for anion analysis (Thermo Fisher Scientific B.V., Breda, Netherlands). Samples were diluted 200-fold and supernatants were diluted 500-fold in water. A conductivity detector was used for peak detection. The flow rate was set to 0.25 mL min⁻¹, the injection volume to 5 μL, and the column temperature to 30° C. Gradient elution was conducted with KOH, first set to 5 mM for 10 minutes, followed by a linear increase to 40 mM within 15 minutes, an isocratic elution at 40 mM for 6 minutes, and a linear decrease to 5 mM in 5 minutes. Samples were analysed in duplicate.

All supernatant concentrations of ionic species were corrected for the excluded volume with a correction factor K calculated according to Pierre and Brule (1981):⁷

$$K = \frac{1000 - P ( 1 + W )}{1000}$$

where P is the measured micellar protein content in g L⁻¹ and W the measured micelle hydration in g water g⁻¹ dry matter.

When studying casein micelles it is common practice to assume that everything that sediments upon ultracentrifugation are the micelles and constitute the micellar phase and everything that does not sediment (nonsedimentable) is in the serum phase. The data in Table 2 shows that the total concentrations of the ionic species (**) are stable across the sample range. Furthermore, the partitioning of the ionic species (*) between the micellar phase and the serum phase is comparable.

TABLE 2
Composition of ionic species of the prepared samples of
the invention compared to natural bovine casein micelles.

| | | | | | Reference |
|---|---|---|---|---|---|
| | | | | | bovine |
| | ACM b:k | ACM b:k | ACM b:k | ACM b:k | casein |
| Parameter | 70:30 | 75:25 | 80:20 | 85:15 | micelles |
| Total Ca (mM)* | 29.1 ± 0.1 | 29.0 ± 0.3 | 29.2 ± 0.2 | 29.0 ± 0.2 | 33.4 ± 0.3 |
| Nonsedimentable Ca (mM) | 7.4 ± 0.2 | 7.9 ± 0.1 | 7.1 ± 0.1 | 7.9 ± 0.1 | 9.2 ± 0.6 |
| Micellar Ca (%) ** | 74.7 ± 0.5 | 72.7 ± 0.2 | 75.8 ± 0.3 | 72.8 ± 0.4 | 72.5 ± 4.3 |
| Micellar Ca (mM) | 21.7 ± 0.1 | 21.1 ± 0.3 | 22.2 ± 0.2 | 21.1 ± 0.2 | 24.2 ± 0.6 |
| Micellar Ca/g of casein (mM) | 0.8 ± <0.1 | 0.8 ± <0.1 | 0.8 ± <0.1 | 0.8 ± <0.1 | 0.8 ± 0.1 |
| Total Mg (mM)* | 4.7 ± <0.1 | 4.6 ± <0.1 | 4.8 ± <0.1 | 4.7 ± <0.1 | 4.9 ± 0.1 |
| Nonsedimentable Mg (mM) | 2.8 ± 0.1 | 2.8 ± <0.1 | 2.8 ± <0.1 | 2.9 ± <0.1 | 3.2 ± 0.2 |
| Micellar Mg (%) ** | 41.8 ± 1.6 | 39.0 ± 0.7 | 41.7 ± 0.6 | 38.3 ± 0.3 | 35.1 ± 1.9 |
| Micellar Mg (mM) | 2.0 ± 0.1 | 1.8 ± <0.1 | 2.0 ± <0.1 | 1.8 ± <0.1 | 1.7 ± 0.2 |
| Total P (mM) | 25.9 ± 0.3 | 26.5 ± 0.3 | 26.2 ± 0.2 | 27.1 ± 0.2 | 32.7 ± 0.4 |
| Total inorganic PO₄ (mM)* | 21.5 ± 0.1 | 21.2 ± 0.1 | 21.8 ± 0.1 | 21.9 ± 0.2 | 21.5 ± 1.2 |
| Nonsedimentable P (mM) | 9.2 ± 0.2 | 10.2 ± 0.1 | 9.0 ± <0.1 | 10.5 ± 0.1 | 13.7 ± 1.0 |
| Nonsedimentable inorganic | 8.6 ± 0.2 | 9.1 ± 0.1 | 8.8 ± <0.1 | 9.3 ± <0.1 | 10.1 ± 0.6 |
| PO₄ (mM) | | | | | |
| Micellar inorganic PO₄ | 59.9 ± 1.0 | 57.2 ± 0.6 | 59.5 ± <0.1 | 57.6 ± 0.7 | 53.0 ± 2.0 |
| (%)** | | | | | |
| Micellar inorganic PO₄ (mM) | 12.9 ± 0.3 | 12.2 ± 0.2 | 13.0 ± 0.1 | 12.6 ± 0.3 | 11.4 ± 0.8 |
| Organic ester PO₄ (mM) | 0.5 ± 0.2 | 1.2 ± <0.1 | 0.2 ± <0.1 | 1.3 ± 0.2 | 3.6 ± 0.8 |
| Micellar organic PO₄ (mM) | 3.9 ± 0.1 | 4.1 ± 0.3 | 4.2 ± 0.3 | 3.9 ± 0.5 | 7.6 ± 1.2 |
| Micellar P/g of casein (mM) | 0.6 ± <0.1 | 0.6 ± <0.1 | 0.6 ± <0.1 | 0.6 ± <0.1 | 0.7 ± <0.1 |
| Total citrate (mM)* | 10.5 ± 0.1 | 10.3 ± 0.1 | 10.6 ± <0.1 | 10.6 ± 0.1 | 9.2 ± 0.4 |
| Nonsedimentable | 7.9 ± 0.2 | 7.9 ± 0.1 | 8.1 ± <0.1 | 8.0 ± <0.1 | 8.3 ± 0.4 |
| citrate (mM) | | | | | |
| Micellar citrate (%)** | 25.0 ± 2.2 | 24.0 ± 1.5 | 23.4 ± 0.4 | 24.2 ± 1.3 | 9.0 ± 0.3 |
| Total Na (mM) | 63.6 ± 0.7 | 62.3 ± 0.1 | 63.8 ± 0.1 | 62.3 ± 0.2 | 18.0 ± 0.6 |
| Total K (mM) | 11.6 ± 0.2 | 11.7 ± 0.2 | 12.0 ± 0.4 | 11.7 ± 0.2 | 42.1 ± 0.6 |
| Total Cl (mM) | 45.8 ± 1.2 | 45.9 ± 0.5 | 46.5 ± 0.3 | 46.8 ± 0.1 | 25.6 ± 1.1 |

The mineral partitioning between the micellar phase and the serum phase as compared to casein micelles from bovine skim milk shows that the formed artificial micelles ‘encapsulate’ similar amounts of calcium phosphate nanoclusters as natural bovine casein micelles, indicating that the structure of the micelles is similar.

### Example 6.1: Analysis of Micellar Casein Composition

The total casein content and the nonsedimentable casein content in the ultracentrifugal supernatants of samples were determined by reversed-phase high performance liquid chromatography (RP-HPLC; Dionex UltiMate 3000 system, Thermo Fisher Scientific B.V., Breda, Netherlands) using a VDSpher OptiBio Pur 300C4-SE column (VDS Optilab, Berlin, Germany) according to Schubert et al. (2018) 1 with modifications. Sedimentable or micellar casein content is inferred from subtracting the nonsedimentable casein content from the total casein content.

The eluent composition during analysis is shown in Table 3, where eluent A was composed of 1% (v/v) acetonitrile (ACN) and 0.1% (v/v) trifluoroacetic acid (TFA) in water and eluent B of 1% (v/v) water and 0.072% (v/v) TFA in ACN. Only linear gradients were used. The flow rate was set at 1.0 mL min-1, the injection volume at 10 μL, the column temperature at 30° C., and the detection wavelength at 214 nm. Samples were diluted 5:1 and supernatants were diluted 2:1 in a buffer solution of 6M guanidine hydrochloride, 20 mM dithiothreitol, and 5 mM sodium citrate and incubated for at least one hour at room temperature before analysis. All analyses were performed in duplicate.

TABLE 3
Eluent composition during RP-HPLC analysis.

| Time (min) | Eluent A (%) | Eluent B (%) |
|---|---|---|
| 0.0 | 72.0 | 28.0 |
| 21.5 | 62.4 | 37.6 |
| 22.5 | 62.4 | 37.6 |
| 26.0 | 54.0 | 46.0 |
| 28.0 | 0.0 | 100.0 |
| 29.0 | 0.0 | 100.0 |
| 30.0 | 72.0 | 28.0 |
| 35.0 | 72.0 | 28.0 |

The total casein content of the prepared samples is presented in Table 4 below.

TABLE 4
Casein composition of the prepared samples.

| | Concentration (g L⁻¹) | | | | | β:κ |
|---|---|---|---|---|---|---|
| Sample | αₛ₁-CN | αₛ₂-CN | β-CN | κ-CN | Total | ratio |
| ACM b:k 70:30 | 1.2 ± 0.1 | 0.5 ± <0.1 | 16.5 ± 0.2 | 8.1 ± 0.1 | 26.2 ± 0.3 | 63:31 |
| ACM b:k 75:25 | 0.8 ± <0.1 | 0.3 ± <0.1 | 17.4 ± 0.6 | 6.7 ± 0.2 | 25.3 ± 0.9 | 69:27 |
| ACM b:k 80:20 | 0.8 ± <0.1 | 0.5 ± <0.1 | 19.3 ± 0.2 | 6.2 ± 0.1 | 26.8 ± 0.3 | 72:23 |
| ACM b:k 85:15 | 0.6 ± <0.1 | 0.2 ± <0.1 | 20.2 ± 0.6 | 4.8 ± 0.1 | 25.8 ± 0.7 | 78:19 |
| ACM b:k 95:5 | 0.2 ± <0.1 | 0.2 ± <0.1 | 21.8 ± 1.0 | 2.6 ± 0.1 | 24.8 ± 1.2 | 88:11 |

Abbreviations:
ACM = artificial casein micelles
CN = casein

The total casein concentration targeted during preparation of the artificial casein micelles (ACMs) was 25.6 g L⁻¹ and the measured total concentrations in the prepared ACMs are close to that, taking into account the presence of minor amounts of αₛ-casein impurities. The β-casein (β-CN) concentration increases from 16.5 to 21.8 g L⁻¹ and the κ-casein (κ-CN) concentration decreases from 8.1 to 2.6 g L⁻¹. Due to trace amounts of αₛ-caseins present, the resulting β:κ-casein ratios are shown in the last column, ranging from 63% β-casein and 31% κ-casein (and thus 6% αₛ-caseins) to 88% β-casein and 11% κ-casein (and thus 2% αₛ-caseins).

The micellar casein content, or sedimentable casein content of the micellar solutions is plotted in FIG. 5.1, and varies from approximately 84% (ACM b:k 70:30) to greater than 90% (ACM b:k 95:5). This data demonstrates that about 10-15% of the casein did not sediment upon ultracentrifugation and can thus be regarded as non-micellar casein that resides in the serum phase. This is in line with the micellar casein levels of bovine casein micelles, that usually range around 90% (Cerbulis, 1969;⁸ Huppertz et al., 2021;⁹ Reiter et al., 2022¹⁰).

### Example 7.1: Determination of Casein Micelle Hydration

Ultracentrifugal pellets were weighed in aluminium crucibles and dried at 105° C. for approximately 48 hours in a hot air oven (Binder model E 28, Binder GmbH, Tuttlingen, Germany). Casein micelle hydration was calculated according to Huppertz et al. (2017)¹¹ by dividing the moisture content of the pellet by the dry matter of the pellet.

Data presented in FIG. 6.1 shows that the micelles obtained are highly hydrated (2.5->4.0 g water/g protein), which is a characteristic of casein micelles (Huppertz et al., 2017).¹¹ The higher the proportion of β-casein present in the micelles, the less hydrated the micelles were.

### Example 8.1: Rheological Characterisation

The rennet coagulation was followed by means of oscillatory rheometry. Samples were adjusted to pH 5.8 or 6.3 by acidification with diluted lactic acid below 10° C. and the pH of part of the sample was left unadjusted at pH 6.7. Subsequently, 0.05% or 0.10% (v/v) of a 40% (w/v) calcium chloride solution was added and the samples were heated to 30° C. while stirring. Samples were then renneted with 0.02% (v/v) rennet added by means of a 10% (v/v) solution, for a period of one hour, and transferred to the rheometer (Physica MCR 302, Anton Paar, Graz, Austria) equipped with a double-gap device (DG26.7). A strain amplitude of 0.001 and a frequency of 1 Hz was applied while the temperature was set to 30° C. Maximum G′ (storage modulus; measure of the curd firmness) measurements were performed in duplicate.

The results are presented in Table 5:

TABLE 5

| Maximum G' (storage modulus; measure | | | |
|---|---|---|---|
| of the firmness) of the produced curds | | | |
| upon rennet-induced coagulation. | | | |
| Sample | pH | CaC1₂ | Max G' (Pa) |
| ACM b:k 70:30 | 5.8 | 0.05 | 36.2 ± 0.1 |
| | | 0.10 | 34.6 ± 1.6 |
| | 6.3 | 0.05 | 45.1 ± 0.9 |
| | | 0.10 | 44.1 ± 3.9 |
| | 6.7 | 0.05 | 29.6 ± 1.8 |
| | | 0.10 | 39.5 ± 1.8 |
| ACM b:k 75:25 | 5.8 | 0.05 | 24.0 ± 0.7 |
| | | 0.10 | 19.3 ± 6.7 |
| | 6.3 | 0.05 | 33.7 ± 0.3 |
| | | 0.10 | 36.1 ± 3.2 |
| | 6.7 | 0.05 | 25.1 ± 1.6 |
| | | 0.10 | 32.3 ± 4.0 |
| ACM b:k 80:20 | 5.8 | 0.05 | 14.3 ± 1.7 |
| | | 0.10 | 10.1 ± 0.5 |
| | 6.3 | 0.05 | 21.7 ± 1.8 |
| | | 0.10 | 18.1 ± 0.1 |
| | 6.7 | 0.05 | 10.7 ± 1.9 |
| | | 0.10 | 21.1 ± 0.7 |
| ACM b:k 85:15 | 5.8 | 0.05 | 4.0 ± 0.1 |
| | | 0.10 | 3.8 ± 0.7 |
| | 6.3 | 0.05 | 2.9 ± 0.6 |
| | | 0.10 | 4.9 ± 3.1 |
| | 6.7 | 0.05 | 3.8 ± 1.0 |
| | | 0.10 | 6.0 ± 1.9 |

FIG. 7.1 shows the data for the produced curds upon rennet-induced coagulation of the samples at pH 6.3 and with 0.10% added CaCl₂), demonstrating that the micelles can be coagulated and form curds. The curd firmness decreased almost linearly with increasing β:κ ratio. The micelles with a β:κ ratio of 63:31 produced the strongest curds with a storage modulus of about 45 Pa. During cheese production, curds are cut when they reach a sufficient firmness and then further processed into cheese by ageing or drying.

The application of the process of the present invention with the aim to prepare artificial casein micelles from β- and κ-casein alone, surprisingly, unexpectedly and advantageously yielded highly hydrated, spherical particles with a similar size as bovine casein micelles that were able to coagulate to a certain extent and appeared as micelle-like particles under the microscope. The micelles and micellar solutions prepared from these two caseins in accordance with the process of the present invention also possess favourable mineral salt content, comparable to bovine casein micelles and amenable to the production of cheeses and other downstream products having favourable flavour profiles, textures and other functional properties.

### Example 0.2A: Production of Phosphorylated κ-Casein (Native KCN)

A β-casein reduced micellar casein (MCN) was obtained according to the protocol of Schaefer et al,¹² with the modification of performing 2 additional cold filtration steps to reduce the β-casein content further.

The β-casein reduced MCN was treated according to the protocol of Schubert et al,¹³ wherein calcium precipitation and subsequent Separation 1 were conducted.

The collected phosphorylated κ-casein containing supernatant was subjected to a filtration using a 1 kDa Membrane and diafiltrated with a diafiltration factor of 6 to remove minerals and residual lactase and then concentrated for spray drying. The collected phosphorylated κ-casein containing concentrate was spray dried.

The total protein concentration of the obtained powder was 80%.

### Example 0.2B: Production of Dephosphorylated κ-Casein (DPKCN) and Dephosphorylated β-Casein (DPBCN)

A 2.5% protein solution of phosphorylated κ-casein was prepared using 10 mM TRIS buffer at pH 8.0. The hydrated protein solution was heated to 37° C. and 10 mg/100 mL of Alkaline phosphatase was added, with mixing. The incubation conditions were 37° C. for a period of 8 hr of incubation with mild mixing. The incubation was further extended to overnight at room temperature. Removal of cleaved phosphate groups was performed via diafiltration using a nano-filtration (10 kDa) membrane. The collected dephosphorylated κ-casein (the retentate from the diafiltration process) was spray dried.

To produce dephosphorylated β-casein, a native β-casein concentrate was first obtained in accordance with the methods described in Schaefer et al.¹² A micellar casein concentrate was obtained from skim milk by means of warm microfiltration (MF) at 50° C. (0.1 μm pore size, ceramic membranes). The concentrate was stored at 2-3° C. for approximately 40 h to induce temperature-dependent dissociation of β-casein from casein micelles. β-casein was separated from the cold-stored concentrate using microfiltration (MF, 0.3 μm pore size, organic membranes) at ≤5° C. β-Casein permeate was warmed up to 50° C. to lead self-association of β-casein micelles before ultrafiltration at 50° C. (10 kDa cut-off, organic membranes). The resultant native β-casein concentrate, obtained at a purity of 92-93%, in yields of up to 18%, was subjected to dephosphorylation via the same protocol described for dephosphorylation of κ-casein described above.

A 2.5% protein solution of phosphorylated β-casein was prepared using 10 mM TRIS buffer at pH 8.0. The hydrated protein solution was heated to 37° C. and 10 mg/100 mL of Alkaline phosphatase was added, with mixing. The incubation conditions were 37° C. for a period of 8 hr of incubation with mild mixing. The incubation was further extended to overnight at room temperature. Removal of cleaved phosphate groups was performed via diafiltration using a nano-filtration (10 kDa) membrane. The collected dephosphorylated β-casein (the retentate from the diafiltration process) was spray dried.

### Example 1.2: Production of Mozzarella Using Phosphorylated κ-Casein (Native KCN)

Phosphorylated κ-casein (native KCN, at a concentration of 5% total protein) was hydrated for 60 min at room temperature. To produce the emulsion about 1:1 fat to protein ratio was used. Once the plant-based fat (rapeseed oil) was added, the mixture was pre-homogenized using an ultraturrax at 10000 rpm for 3 min at room temperature. The mixture was further emulsified using a two-stage homogenizer at 200/50 bar at room temperature. About 10 mM CaCl₂) was added to the emulsion and the emulsion was acidified to pH 5.2 with 1M hydrochloric acid. The acidified mixture was allowed to incubate at 37° C. for 30 min. The resultant gel phase (Curd) was separated from the whey [FIG. 1.2, a), 1.]. The separated curd was texturized at 75-85° C. in hot water at a curd to water ratio of 1:2. The curd was kneaded, stretched [FIG. 1.2, a), 2.], and folded into a ball form, and then cooled in water. The final product was then stored in a 0.1% lactic acid solution. Melt testing showed melt behaviour typical of a mozzarella cheese [FIG. 1.2, a), 3.].

### Example 2.2: Production of Mozzarella Using Dephosphorylated κ-Casein (DPKCN)

Dephosphorylated κ-casein (at a concentration of 5% total protein) was hydrated for 60 min at room temperature. To produce the emulsion about 1:1 fat to protein ratio was used. Once the plant-based (rapeseed oil) fat was added, the mixture was pre-homogenized using an ultraturrax at 10000 rpm for 3 min at room temperature. The mixture was further emulsified using a two-stage homogenizer at 200/50 bar at room temperature. About 10 mM CaCl₂) was added to the emulsion and the emulsion was acidified to pH 5.2 with 1M hydrochloric acid. The acidified mixture was allowed to incubate at 37° C. for 30 min. The resultant gel phase (Curd) was separated from the whey [FIG. 1.2, b), 1.]. The separated curd was texturized at 75-85° C. in hot water at a curd to water ratio of 1:2. The curd was kneaded, stretched [FIG. 1.2, b), 2.], and folded into a ball form, and then cooled in water. The final product was then stored in a 0.1% lactic acid solution. Melt testing showed melt behaviour typical of a mozzarella cheese [FIG. 1.2, b), 3.].

### Example 3.2: Production of Mozzarella Using Phosphorylated κ-Casein (Native KCN), and Dephosphorylated β-Casein (DPBCN)

As a protein source, dephosphorylated β-casein (DPBCN) and phosphorylated κ-casein (native KCN) were mixed in 3:1 ratio to obtain the final protein concentration of 5%. The protein mix was hydrated for 60 min at room temperature. To produce the emulsion a 1:1 fat to protein ratio was used. Once the plant-based fat (rapeseed oil) was added, the mixture was pre-homogenized using an ultraturrax at 10000 rpm for 3 min at room temperature. The mixture was further emulsified using a two-stage homogenizer at 200/50 bar at room temperature. The resultant emulsion was carried forward in the following 5 protocols for curd production and downstream processing.

### Protocol 1: No Heat Treatment, No Transglutaminase Treatment

10 mM CaCl₂) was added to the emulsion, and the emulsion was acidified using 1M HCl to pH 5.2. The acidified mixture was allowed to incubate at 37° C. for 30 min. Then the gel phase (Curd) was separated from the whey [FIG. 2.2, a), 1.], and the curd was texturized at 75-85° C. in hot water at a curd to water ratio of 1:2. The curd was kneaded, stretched [FIG. 2.2, a), 2.], and folded into a ball form and cooled in water. The final product was then stored in 0.1% lactic acid solution. This protocol led to a fine granular non cohesive curd, that holds shape well when slightly pressed. During texturization the curd was very soft and stretchy.

### Protocol 2: Heat Treatment Prior to Calcium Addition

The emulsion was heated at 45-70° C. for 30 min, then was allowed to cool back down to room temperature, then 10 mM CaCl₂) was added to the emulsion, and the emulsion was acidified using 1M HCl to pH 5.2. The acidified mixture was allowed to incubate at 37° C. for 30 min. Then the gel phase (Curd) was separated from the whey [FIG. 2.2, b), 1.], and the curd was texturized at 75-85° C. in hot water at a curd to water ratio of 1:2. The curd was kneaded, stretched [FIG. 2.2, b), 2.], and folded into a ball form and cooled in water. The final product was then stored in 0.1% lactic acid solution. Melt testing showed melt behaviour typical of a mozzarella cheese [FIG. 2.2, b), 3.]. Compared to protocol 1, this protocol led to larger aggregates during the curd formation and better whey separation, as well as increased stretchability during texturization.

Protocol 3: Heat Treatment after Calcium Addition

10 mM CaCl₂) was added to the emulsion, and the emulsion was heated at 45-70° C. for 30 min. The emulsion was then allowed to cool back down to room temperature and acidified using 1M HCl to pH 5.2. The acidified mixture was allowed to incubate at 37° C. for 30 min. Then the gel phase (Curd) was separated from the whey [FIG. 2.2, c), 1.], and the curd was texturized at 75-85° C. in hot water at a curd to water ratio of 1:2. The curd was kneaded, stretched [FIG. 2.2, c), 2.], and folded into a ball form and cooled in water. The final product was then stored in 0.1% lactic acid solution. Melt testing showed melt behaviour typical of a mozzarella cheese [FIG. 2.2, c), 3.]. Compared to protocol 1, this protocol led to a very fine soft and non-cohesive gel. The gel can be pressed slightly to remove whey and then keeps its shape, and exhibits increased stretchability during texturization.

### Protocol 4: Transglutaminase Treatment Followed by Heat Treatment Prior to Calcium Addition

In order to investigate the effect of crosslinking with transglutaminase (TG), the emulsion was incubated with 0.1% (or a 2:100 enzyme/substrate ratio) of TG, at 50° C. for 30 min. The emulsion was then heated at 50-70° C. for 30 min, then allowed to cool back down to room temperature before 10 mM CaCl₂ was added to the emulsion, and the emulsion was acidified using 1M HCl to pH 5.2. The acidified mixture was allowed to incubate at 37° C. for 30 min. Then the gel phase (Curd) was separated from the whey [FIG. 2.2, d), 1.], and the curd was texturized at 75-85° C. in hot water at a curd to water ratio of 1:2. The curd was kneaded, stretched [FIG. 2.2, d), 2.], and folded into a ball form and cooled in water. The final product was then stored in 0.1% lactic acid solution. The resultant curd was very similar to that produced by protocol 2, but with slightly reduced stretchability during texturization.

Protocol 5: Transglutaminase Treatment Followed by Heat Treatment after Calcium Addition

10 mM CaCl₂ was added to the emulsion. In order to investigate the effect of crosslinking with transglutaminase (TG), the emulsion was incubated with 0.1% (or a 2:100 enzyme/substrate ratio) of TG, at 50° C. for 30 min. The emulsion was then heated at 50-70° C. for 30 min, then allowed to cool back down to room temperature before the emulsion was acidified using 1M HCl to pH 5.2. The acidified mixture was allowed to incubate at 37° C. for 30 min. Then the gel phase (Curd) was separated from the whey [FIG. 2.2, e), 1.], and the curd was texturized at 75-85° C. in hot water at a curd to water ratio of 1:2. The curd was kneaded [FIG. 2.2, e), 2.], stretched, and folded into a ball form and cooled in water. The final product was then stored in 0.1% lactic acid solution. The resultant curd was very similar to that produced by protocol 3, but with slightly increased yield, and produced the least stretchability during texturization of any of the 5 protocols of example 3.2.

### Example 4.2: Chymosin Treatment

Protocol I—Production of Mozzarella Using Phosphorylated κ-Casein (Native KCN), and Dephosphorylated β-Casein (DPBCN) with Heat Treatment Prior to Calcium Addition and Chymosin Treatment after Calcium Addition

The 3:1 dephosphorylated β-casein (DPBCN) and phosphorylated κ-casein (native KCN) emulsion prepared in accordance with example 3.2 was utilised in this exemplary embodiment. The emulsion was heated at 45-70° C. for 30 min, then was allowed to cool back down to room temperature, then 10 mM CaCl₂) was added to the emulsion, and the emulsion was acidified using 1M HCl to pH 5.2. Chymosin was added to the acidified mixture was allowed to incubate at 37° C. for 30 min. Then the gel phase (Curd) was separated from the whey [FIG. 3.2, a), 1.], and the curd was texturized at 75-85° C. in hot water at a curd to water ratio of 1:2. The curd was kneaded, stretched [FIG. 3.2, a), 2.], and folded into a ball form and cooled in water. The final product was then stored in 0.1% lactic acid solution. Chymosin treatment led to a decrease in yield compared to example 3.2, protocol 2. The Chymosin treatment gave a soft/mushy curd which exhibited good stretchability during texturization.

Protocol II—Production of Mozzarella Using Phosphorylated κ-Casein (Native KCN), and Dephosphorylated β-Casein (DPBCN) with Heat Treatment after Calcium Addition Followed by Chymosin Treatment.

The 3:1 dephosphorylated β-casein (DPBCN) and phosphorylated κ-casein (native KCN) emulsion prepared in accordance with example 3.2 was utilised in this exemplary embodiment. 10 mM CaCl₂) was added to the emulsion, and the emulsion was heated at 45-70° C. for 30 min. The emulsion was then allowed to cool back down to room temperature and acidified using 1M HCl to pH 5.2. Chymosin was added to the acidified mixture was allowed to incubate at 37° C. for 30 min. Then the gel phase (Curd) was separated from the whey [FIG. 3.2, b), 1.], and the curd was texturized at 75-85° C. in hot water at a curd to water ratio of 1:2. The curd was kneaded, stretched [FIG. 3.2, b), 2.], and folded into a ball form and cooled in water. The final product was then stored in 0.1% lactic acid solution. Chymosin treatment led to a decrease in yield compared to example 3.2, protocol 3. The Chymosin treatment gave a soft/mushy curd which exhibited good stretchability during texturization.

Protocol III—Production of Mozzarella Using Dephosphorylated κ-Casein (DPKCN), with Heat Treatment Prior to Calcium Addition and Chymosin Treatment after Calcium Addition.

The dephosphorylated κ-casein (DPKCN) emulsion prepared in accordance with example 2.2 was utilised in this exemplary embodiment. The emulsion was heated at 45-70° C. for 30 min, then was allowed to cool back down to room temperature, then 10 mM CaCl₂) was added to the emulsion, and the emulsion was acidified using 1M HCl to pH 5.2. Chymosin was added to the acidified mixture was allowed to incubate at 37° C. for 30 min. Then the gel phase (Curd) was separated from the whey [FIG. 3.2, c), 1.], and the curd was texturized at 75-85° C. in hot water at a curd to water ratio of 1:2. The curd was kneaded, stretched [FIG. 3.2, c), 2.], and folded into a ball form and cooled in water. The final product was then stored in 0.1% lactic acid solution. Heat treatment and Chymosin treatment led to a decrease in yield compared to example 2.2. The Chymosin treatment gave a soft/mushy curd which exhibited good stretchability during texturization.

Protocol IV—Production of Mozzarella Using Dephosphorylated κ-Casein (DPKCN), with Heat Treatment after Calcium Addition Followed by Chymosin Treatment

The dephosphorylated κ-casein (DPKCN) emulsion prepared in accordance with example 2.2 was utilised in this exemplary embodiment. 10 mM CaCl₂) was added to the emulsion, and the emulsion was heated at 45-70° C. for 30 min. The emulsion was then allowed to cool back down to room temperature and acidified using 1M HCl to pH 5.2. Chymosin was added to the acidified mixture was allowed to incubate at 37° C. for 30 min. Then the gel phase (Curd) was separated from the whey [FIG. 3.2, d), 1.], and the curd was texturized at 75-85° C. in hot water at a curd to water ratio of 1:2. The curd was kneaded, stretched [FIG. 3.2, d), 2.], and folded into a ball form and cooled in water. The final product was then stored in 0.1% lactic acid solution. Heat treatment and Chymosin treatment led to a decrease in yield compared to example 2.2. The Chymosin treatment gave a soft/mushy curd which exhibited good stretchability during texturization.

### Example 1.3: Emulsions, Curds Compositions and Cheeses Comprising Non-Animal Derived Proteins

Zein protein (Zein F4400C-Food grade Flo corporation: supplier: A. F. Suter & Co Ltd) was used as an exemplary non-animal derived protein in the foregoing examples. The commercially obtained zein was deodorised/decolorised in an adaptation of the procedures described in U.S. Pat. No. 7,939,633 as follows.

100 mL of 8% zein solution with 65% ethanol was prepared and mixed for 30 min at RT. In 50 mL syringes, about an inch thickness of cotton wool was placed, followed by a layer of Whatman filter paper, and 25 g of molecular sieve (MS) was placed on top of the filter paper. 40 mL of 65% ethanol was passed through the packed syringes to wet the MS. 50 mL of 8% zein solution was added to each syringe and allowed to pass through the MS, and the filtrate was collected in a beaker. Heat was observed to be liberated during the filtration. The MS were then washed twice with 50 mL 65% ethanol and the filtrate collected in the same beaker.

In further 50 mL syringes, about an inch thickness of cotton wool was placed, followed by a layer of Whatman filter paper, and 12.25 g of activated carbon was placed on top of the filter paper. The filtrate collected in the previous step was added to each syringe and allowed to pass through the activated carbon, and the filtrate was collected in a beaker coated with oil. The obtained twice-filtered zein solution was then dried at 50° C. to leave a film of zein. The zein film was then scraped out of the beaker, ground, and stored in an airtight container for use in the foregoing examples.

The NMC or single β-CN is used as a protein source. However, the method for the production of mozzarella is almost similar. Therefore, the protein source is mentioned as casein hereon.

For the production of zein: casein-based mozzarella, about 25-40% of casein is replaced with zein protein. The fat to protein ratio and lactose used for the production process are 1.35 and 3.1%. The zein protein exhibits high hydrophobicity which hinders the hydration in distilled water at native pH. Therefore, a different approach was handled to introduce the zein protein into the pre-mix. The methods are described as follows.

The recipe for mozzarella cheese production containing either Na-caseinate and zein or β-casein and zein is shown in Table 1.3. About 25% of the total protein content has been replaced with zein.

TABLE 1.3

| | in 100 g of emulsion |
|---|---|
| Ingredient | 25:75 zein to casein ratio |
| Zein protein | 0.5 |
| Casinate | 1.5 |
| Water | 92.28 |
| Lactose | 3.1 |
| Sunflower seed oil | 2.7 |
| Total | 100.08 |

### Method 1: Hydration at High Alkaline pH

The pH of distilled water is adjusted to 12.5. Based on the recipe, zein protein and alkalized water are mixed at room temperature for 30 min. Then casein is added to the zein mix which is allowed to hydrate at the same pH for 30 min at room temperature. Once the hydration of the protein is performed, the pH is adjusted to 7.0 to which fat and lactose based on the recipe are added. The premix is then subject to high shear at 16000 rpm for 5 min and later homogenized at 200/50 Bar at room temperature.

### Method 2: Enzymatic Hydrolysis of Zein Protein

The pH of distilled water is adjusted to 12.5. Based on the recipe, zein protein and alkalized water are mixed at room temperature for 30 min. Followed by the pH is adjusted to 9.0 and the temperature is increased to 50° C. For the enzymatic hydrolysis, partial to extensive hydrolysis are performed (alcalase 2.4 L FG is used with the enzyme/substrate ratio of 12.5:100 or 25:100). The proteolysis is performed at 50° C. for 1 hr. Then the protein mix pH is reduced to 7.0 and the enzyme is deactivated at 95° C. for 10 min. Further, casein is added to the zein mix which is allowed to hydrate at the same pH for 30 min at room temperature. The premix is then subject to high shear at 16000 rpm for 5 min and later homogenized at 200/50 Bar at room temperature.

### Method 3: Addition of Zein to the Pre-Mix by High Shear

Initially, the casein is hydrated in distilled water for 30 min (NMC) or 180 min (β-CN) at room temperature. Subsequently, lactose and fat are added and mixed for 5 min. The pre-mix is then treated with high shear at 16000 rpm for 10 min while the zein protein is slowly added. This is followed by homogenization at 200/50 Bar at room temperature.

### Mozzarella Production:

The emulsion is chilled down to 5-10° C. Afterwards, 30 mM of CaCl₂) is added and directly acidified to pH 5.2 using 30% lactic acid solution. Further the acidified emulsion temperature is increased to 37° C. to perform chymosin-induced coagulation (100 μL/100 mL) at 37° C. for 30 min. The coagulation with chymosin is not performed when β—CN is used as a casein source. The gel-like solid phase is separated from the liquid phase by passing the coagulum through sieve and cheese cloth layers. The curd is then texturized in a hot water bath (70-85° C.). The curd is stretched and kneaded for 2-3 min as carried out in the conventional mozzarella production process. A ball-like portion is then cooled down and stored in a cold 0.1% lactic acid solution.

The cheese according to this example is shown in FIG. 2.3.

### Example 1.4: Formation of Mozzarella-Like Cheese Using Dephosphorylated Sodium-Caseinate

The dephosphorylated sodium caseinate (DPNaCN) was produced through dephosphorylation of sodium caseinate by alkaline phosphatase. This was used to simulate non-phosphorylated casein produced by recombinant expression using bacterial fermentation.

The treatment by transglutaminase (TG) was done as follows: A 5% (by weight) DPNaCN solution was prepared. Then TG (in an amount of 4 U/g protein) was added the resultant mixture was incubated for 30 minutes at 50° C. to induce protein polymerization. Afterwards the enzyme was inactivated by a high temperature treatment (80° C. for 2 minutes).

In order to test the coagulation and gelling properties of the TG-treated DPNaCN, an emulsion was produced by addition of vegetable oil to the protein solution in a ratio of 1:1 (by weight) fat to protein and a homogenization step. Afterwards the gel formation was either induced by slow acidification or by the combination of acidification and chymosin as described in the following.

### Example 2.4: Gelation Induced by Slow Acidification

Before gelation 4 mmol of CaCl₂) was added to the emulsion. The gel formation was induced by slow acidification of the emulsion using 1% glucono-delta-lactone for 2 hours at 36° C.

The texture of the gels produced was analyzed by a texture analyzer and the curd yield was measured after acidification. The acid gel based on non-treated DPNaCN was softer, more fragile and showed a lower cohesion and higher syneresis than the gels based on TG treated DPNaCN (see FIGS. 1.4 and 2.4). FIG. 3.4 shows the increase in gel firmness with increasing TG concentration during the treatment of the DPNaCN. The curd yield seems to increase slightly as well (FIG. 4.4). The curd is shown in FIG. 5.4.

### Example 3.4: Combined Acid and Chymosin-Induced Gelation

Before gelation 4 mmol of CaCl₂) was added to the emulsion and the pH was adjusted to 5.6 by adding 30% lactic acid to the cold emulsion (5° C.). The acidified emulsion was coagulated by adding chymosin and incubating at 36° C. for 30 min. After incubation the set gel was cut into 1-2 cm cubes to allow the release of whey. The curd was separated from the whey and was allowed to drain for 30 min. During the whey drainage, the curd was gently mixed every 5 min to remove any excess whey. Afterwards the curd was texturized through the addition of 80° C. hot water at a curd to water ratio of 1:1 and manual kneading and stretching. Finally, the texturized curd was moulded into a ball form and cooled in water. The results are shown in FIG. 6.4.

### GENERAL

Each document, reference, patent application or patent cited in this text is expressly incorporated herein in their entirety by reference, which means that it should be read and considered by the reader as part of this text. That the document, reference, patent application or patent cited in this text is not repeated in this text is merely for reasons of conciseness.

It should be appreciated that throughout this specification, any reference to any prior publication, including prior patent publications and non-patent publications, is not an acknowledgment or admission that any of the material contained within the prior publication referred to was part of the common general knowledge as at the priority date of the application.

Any manufacturer's instructions, descriptions, product specifications, and product sheets for any products mentioned herein or in any document incorporated by reference herein, are hereby incorporated herein by reference, and may be employed in the practice of the invention.

The invention described herein may include one or more range of values (e.g. size, displacement and field strength etc). A range of values will be understood to include all values within the range, including the values defining the range, and values adjacent to the range which lead to the same or substantially the same outcome as the values immediately adjacent to that value which defines the boundary to the range.

The present invention is not to be limited in scope by any of the specific embodiments described herein. These embodiments are intended for the purpose of exemplification only. Functionally equivalent products, formulations and methods are clearly within the scope of the invention as described herein.

Those skilled in the art will appreciate that the invention described herein is susceptible to variations and modifications other than those specifically described. The invention includes all such variation and modifications. The invention also includes all of the steps, features, formulations and compounds referred to or indicated in the specification, individually or collectively and any and all combinations or any two or more of the steps or features.

### REFERENCES

1. Schubert, T., Meric, A., Boom, R. M., Hinrichs, J., & Atamer, Z. (2018). Application of a decanter centrifuge for casein fractionation on pilot scale: Effect of operational parameters on total solid, purity and yield in solid discharge. International Dairy Journal, 84, 6-14. https://doi.org/10.1016/j.idairyj.2018.04.002
2. Schmidt, D. G., Koops, J., & Westerbeek, D. (1977). Properties of artificial casein micelles. 1. Preparation, size distribution and composition. Netherlands Milk and Dairy Journal, 31(4), 328-341.
3. Jenness, R., & Koops, J. (1962). Preparation and properties of a salt solution which simulates milk ultrafiltrate. Netherlands Milk and Dairy Journal, 16, 153-164.
4. Dumpler, J., Kieferle, I., Wohlschläger, H., & Kulozik, U. (2017). Milk ultrafiltrate analysis by ion chromatography and calcium activity for SMUF preparation for different scientific purposes and prediction of its supersaturation. International Dairy Journal, 68, 60-69. https://doi.org/10.1016/j.idairyj.2016.12.009
5. Griffin, M. C. A., & Griffin, W. G. (1985). A simple turbidimetric method for the determination of the refractive index of large colloidal particles applied to casein micelles. Journal of Colloid And Interface Science, 104(2), 409-415. https://doi.org/10.1016/0021-9797 (85) 90049-9
6. De Kruif, C. G. (1998). Supra-aggregates of casein micelles as a prelude to coagulation. Journal of Dairy Science, 81(11), 3019-3028. https://doi.org/10.3168/jds.S0022-0302(98) 75866-7
7. Pierre, A., & Brule, G. (1981). Mineral and protein equilibria between the colloidal and soluble phases of milk at low temperature. Journal of Dairy Research, 48(3), 417-428. https://doi.org/10.1017/S0022029900021890
8. Cerbulis, J. (1969). Influence of dispersing agents on micelle content of milk and lipid content of casein fractions. Journal of Agricultural and Food Chemistry, 17(5), 1085-1088. https://doi.org/10.1021/jf60165a024
9. Huppertz, T., Heck, J., Bijl, E., Poulsen, N. A., & Larsen, L. B. (2021). Variation in casein distribution and mineralisation in the milk from Holstein-Friesian cows. International Dairy Journal, 119, 105064. https://doi.org/10.1016/j.idairyj.2021.105064
10. Reiter, M., Reitmaier, M., & Kulozik, U. (2022). Compositional changes of casein micelles induced by calcium or chelatant addition at threefold and natural casein concentration. International Dairy Journal, 130, 105365. https://doi.org/10.1016/j.idairyj.2022.105365
11. Huppertz, T., Gazi, I., Luyten, H., Nieuwenhuijse, H., Alting, A., & Schokker, E. (2017). Hydration of casein micelles and caseinates: Implications for casein micelle structure. International Dairy Journal, 74, 1-11. https://doi.org/10.1016/j.idairyj.2017.03.006
12. Schaefer, J., Schubert, T., & Atamer, Z., “Pilot-scale b-casein depletion from micellar casein via cold microfiltration in diafiltration mode”, International Dairy Journal, 2019, 97, 222e229.
13. Schubert, T., Ergin, I., Panetta, F., Hinrichs, J., Atamer, Z., “Application of a temperature-controlled decanter centrifuge for the fractionation of αₛ-, β- and κ-casein on pilot scale”, International Dairy Journal, 2021, 122, 105148.

1.-91. (canceled)

92. A micellar solution comprising a plurality of artificial casein micelles, wherein the artificial micelles comprise isolated non-human β-casein and isolated non-human κ-casein and less than 7% αₛ-casein as a weight percentage (wt. %) of the total caseins present in the micellar solution.

93. The micellar solution of claim 92, wherein the micellar solution comprises at least one of the following:
a total casein concentration of 10 g/L to 95 g/L;
a micellar calcium content of at least 70% of the total calcium in the micellar solution;
a micellar magnesium content of at least 30% of the total magnesium in the micellar solution;
a micellar inorganic phosphate content of at least 50% (wt. %) of the total inorganic phosphate in the micellar solution;
a micellar citrate content of at least 5% of the total citrate in the micellar solution;
a non-micellar casein content of about 5% to about 20% (wt. %);
a ratio of isolated non-human β-casein to isolated non-human κ-casein of about 10:90 to about 90:10;
non-human β-casein is present at about 1 g/L to about 90 g/L;
non-human κ-casein is present at about 1 g/L to about 90 g/L;
αₛ₁-casein, if present, comprises less than 2 g/L;
αₛ₂-casein, if present, comprises less than 1 g/L.

94. The micellar solution of claim 92, wherein the artificial casein micelles comprise at least one of the following:
a Z-average diameter greater than 30 nm;
a Z-average diameter of about 40 nm to about 500 nm;
a ratio of isolated non-human β-casein to isolated non-human κ-casein of about 10:90 to about 90:10;
the hydration of the artificial casein micelles is about 1 g water/g micellar protein to about 8 g water/g micellar protein; and
the artificial casein micelles are substantially free of αₛ-casein.

95. A curds composition comprising a coagulated form of the micellar solution of claim 92, wherein the curds comprise a renneting agent and, optionally, have a Maximum G′ (storage modulus) falling within the range of 5 to 200 Pa after 1 hour incubation with rennet.

96. An edible composition comprising the micellar solution of claim 92, wherein, optionally, the edible composition is free of animal-derived proteins.

97. The edible composition of claim 96, wherein the edible composition is produced by a method comprising the steps:
combining isolated non-human β-casein, isolated non-human κ-casein, and at least one salt to form a micellar solution comprising β-casein and κ-casein, wherein the micellar solution is substantially free of αₛ-caseins; and
subjecting the micellar solution to a first condition to form coagulates.

98. The edible composition of claim 97, wherein the first condition comprises the addition of acid, or acidification of the micellar solution with a microorganism.

99. The edible composition of claim 97, further comprising the step:
subjecting the coagulates to a renneting agent to form a rennetted curd; and, optionally, aging and/or maturing the rennetted curd to form a cheese composition.

100. A process for preparing a curd composition, comprising the steps of:
(a) preparing an emulsion comprising at least one of the following;
(i) phosphorylated κ-casein;
(ii) dephosphorylated or non-phosphorylated κ-casein;
(iii) phosphorylated κ-casein and dephosphorylated or non-phosphorylated κ casein;
(iv) phosphorylated κ-casein, dephosphorylated or non-phosphorylated κ-casein and dephosphorylated or non-phosphorylated β-casein;
(v) dephosphorylated or non-phosphorylated κ-casein and dephosphorylated or non-phosphorylated β-casein;
(vi) phosphorylated κ-casein and dephosphorylated or non-phosphorylated β casein; and
(vii) optionally, a lipid source;
(b) adding calcium salt to the emulsion; and
(c) coagulating the emulsion.

101. The process of claim 100, further comprising at least one of:
heating the emulsion prior to step (b) and/or step (c);
treating the emulsion with a transglutaminase prior to step (b) and/or step (c).

102. The process of claim 100, further comprising the steps of:
(d) incubating the coagulated emulsion produced in step c) to produce a coagulate comprising a raw curd and a liquid phase;
(e) optionally, removing the raw curd of the coagulate produced in step d) from the liquid phase of the coagulate produced in step d) to provide a curd composition;
(f) optionally, texturizing the curd composition produced in step e) in water, or brine, or water comprising whey, or brine comprising whey, at an elevated temperature, to provide a textured curd composition;
(g) optionally, cooling the textured curd composition produced in step (f).

103. The process of claim 101, wherein the emulsion has been treated with transglutaminase and further comprising at least one of the following steps:
adding chymosin to the emulsion;
adding acid to the emulsion;
adding D-(+)-Glucono-delta-lactone to the emulsion;
adding a bacterial culture to the emulsion;
adding calcium salt to the emulsion.

104. A process of forming an emulsified composition, wherein said process comprises the steps of;
(a) preparing a protein component comprising mixture of at least one casein protein and zein protein;
(b) adding at least one lipid to the mixture; and
(c) emulsifying the mixture to obtain the emulsified composition.

105. The process of claim 104, wherein step (b) further comprises adding at least one sugar to the mixture.

106. The process of claim 104, further comprising the steps of
(d) acidifying the emulsified composition; and/or
(e) adding calcium salt,
to form a treated emulsion.

107. The process of claim 106, further comprising the step of incubating the treated emulsion with an enzyme.

108. The process of claim 106, further comprising the step of texturizing the treated emulsion to provide a cheese product, and, optionally, aging the cheese product.

109. The process of claim 104, wherein the protein component of the emulsified composition comprises at least 80% by weight protein, wherein about 25-40% by weight of the protein content comprises zein protein, the remainder being casein protein.

110. The process of claim 109, wherein said casein protein is non-micellar casein.
